(19) United States
(12) Patent Application Publication
(10) Pub. No.: US 2026/0349223 A1
(43) Pub. Date: Nov. 5, 2026

(54) OPTICAL IMAGING LENS SYSTEM, IMAGE CAPTURING UNIT AND ELECTRONIC DEVICE

(71) Applicant: LARGAN PRECISION CO., LTD., Taichung City (TW)

(72) Inventors: Wei-Xiang FU, Taichung City (TW); Yu-Han SHIH, Taichung City (TW)

(73) Assignee: LARGAN PRECISION CO., LTD., Taichung City (TW)

(21) Appl. No.: 19/274,359

(22) Filed: Jul. 18, 2025

(30) Foreign Application Priority Data
May 5, 2025 (TW) 114116757

(51) Int. Cl. G02B 13/00; G02B 9/64

(52) U.S. Cl. CPC G02B 13/0045; G02B 9/64; G02B 13/0065

(57) ABSTRACT

An optical imaging lens system includes, in order from an object side to an image side along an optical path: a first optical element, a second optical element, a third optical element, a fourth optical element, a fifth optical element, a sixth optical element and a seventh optical element. The first optical element is a reflective element. The second optical element to the seventh optical element are lens elements. The first optical element with positive refractive power has an object-side surface being convex in a paraxial region thereof. The third optical element has negative refractive power. The seventh optical element has an object-side surface being convex in a paraxial region thereof. At least one of an object-side surface and an image-side surface of the seventh lens element has at least one inflection point.

### RELATED APPLICATIONS

This application claims priority to Taiwan Application 114116757, filed on May 5, 2025, which is incorporated by reference herein in its entirety.

### BACKGROUND

### Technical Field

The present disclosure relates to an optical imaging lens system, an image capturing unit and an electronic device, more particularly to an optical imaging lens system and an image capturing unit applicable to an electronic device.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

Furthermore, due to the rapid changes in technology, electronic devices equipped with optical systems are trending towards multi-functionality for various applications, and therefore the functionality requirements for the optical systems have been increasing. However, it is difficult for a conventional optical system to obtain a balance among the requirements such as high image quality, low sensitivity, a proper aperture size, miniaturization and a desirable field of view. Therefore, the present disclosure provides an optical system having optical axis-folding functions and achieving high image quality for both telephoto and macro photography by the means of the design of lens movement so as to meet market demands and increase the flexibility of photography.

Specifically, in recent years, electronic products trend to be light and thin, such that it is difficult for a conventional photographing lens to simultaneously meet the requirements of high-specification and miniaturization, especially a small lens featuring a large aperture, a telephoto function or the like. However, the conventional telephoto lens becomes unable to catch the technology requirements and thus have problems such as an overly long total length, an overly small aperture, insufficient quality and inability in miniaturization. Therefore, it needs to introduce different optical features or a folded optical axis configuration to overcome the abovementioned problems.

### SUMMARY

According to one aspect of the present disclosure, an optical imaging lens system includes seven optical elements. The seven optical elements are, in order from an object side to an image side along an optical path, a first optical element, a second optical element, a third optical element, a fourth optical element, a fifth optical element, a sixth optical element and a seventh optical element. Each of the seven optical elements has an object-side surface facing toward the object side and an image-side surface facing toward the image side.

Preferably, the first optical element is a reflective element. Preferably, the first optical element further has a reflective surface located between the object-side surface and the image-side surface of the first optical element. Preferably, each of the second optical element to the seventh optical element is a lens element. Preferably, the first optical element has positive refractive power. Preferably, the object-side surface of the first optical element is convex in a paraxial region thereof. Preferably, the third optical element has negative refractive power. Preferably, the object-side surface of the seventh optical element is convex in a paraxial region thereof. Preferably, at least one of the object-side surface and the image-side surface of the seventh optical element has at least one inflection point.

When an axial distance between the object-side surface of the first optical element and an image surface is TL, a central thickness of the first optical element is CT1, a central thickness of the second optical element is CT2, a curvature radius of the object-side surface of the seventh optical element is R13, a curvature radius of the image-side surface of the seventh optical element is R14, an axial distance between the first optical element and the second optical element is T12, a focal length of the optical imaging lens system is f, and a focal length of the second optical element is f2, the following conditions are preferably satisfied:

1.30<(TL−CT1)/CT1<3.00;

0.60<|R13/R14|<3.00;

0.05<CT2/T12<3.00; and

−0.80<f/f2<2.80.

According to another aspect of the present disclosure, an optical imaging lens system includes seven optical elements. The seven optical elements are, in order from an object side to an image side along an optical path, a first optical element, a second optical element, a third optical element, a fourth optical element, a fifth optical element, a sixth optical element and a seventh optical element. Each of the seven optical elements has an object-side surface facing toward the object side and an image-side surface facing toward the image side.

Preferably, the first optical element is a reflective element. Preferably, the first optical element further has a reflective surface located between the object-side surface and the image-side surface of the first optical element. Preferably, each of the second optical element to the seventh optical element is a lens element. Preferably, the first optical element has positive refractive power. Preferably, the object-side surface of the first optical element is convex in a paraxial region thereof. Preferably, the third optical element has negative refractive power. Preferably, the object-side surface of the seventh optical element is convex in a paraxial region thereof. Preferably, the image-side surface of the seventh optical element is concave in a paraxial region thereof. Preferably, the image-side surface of the seventh optical element has at least one critical point in an off-axis region thereof.

When an axial distance between the object-side surface of the first optical element and an image surface is TL, a central thickness of the first optical element is CT1, a central thickness of the fourth optical element is CT4, a curvature radius of the object-side surface of the fourth optical element is R7, a curvature radius of the image-side surface of the fourth optical element is R8, an Abbe number of the sixth optical element is V6, an Abbe number of the seventh optical element is V7, and an axial distance between the third optical element and the fourth optical element is T34, the following conditions are preferably satisfied:

1.30<(TL−CT1)/CT1<3.00;

−0.60<(R7+R8)/(R7−R8)<2.50;

0.10<V6/V7<1.40; and

0<T34/CT4<0.90.

According to another aspect of the present disclosure, an image capturing unit includes one of the aforementioned optical imaging lens systems and an image sensor, wherein the image sensor is disposed on the image surface of the optical imaging lens system.

According to another aspect of the present disclosure, an electronic device includes an image capturing unit, wherein the image capturing unit includes one of the aforementioned optical imaging lens systems and an image sensor, and the image sensor is disposed on the image surface of the optical imaging lens system.

### BRIEF DESCRIPTION OF THE DRAWINGS

The disclosure can be better understood by reading the following detailed description of the embodiments, with reference made to the accompanying drawings as follows:

FIG. 1 is a schematic view of an image capturing unit corresponding to a long distance and a short distance according to the 1st embodiment of the present disclosure;

FIG. 2 shows spherical aberration curves, astigmatic field curves and a distortion curve of the image capturing unit corresponding to the long distance according to the 1st embodiment;

FIG. 3 shows spherical aberration curves, astigmatic field curves and a distortion curve of the image capturing unit corresponding to the short distance according to the 1st embodiment;

FIG. 4 is a schematic view of an image capturing unit corresponding to a long distance and a short distance according to the 2nd embodiment of the present disclosure;

FIG. 5 shows spherical aberration curves, astigmatic field curves and a distortion curve of the image capturing unit corresponding to the long distance according to the 2nd embodiment;

FIG. 6 shows spherical aberration curves, astigmatic field curves and a distortion curve of the image capturing unit corresponding to the short distance according to the 2nd embodiment;

FIG. 7 is a schematic view of an image capturing unit corresponding to a long distance and a short distance according to the 3rd embodiment of the present disclosure;

FIG. 8 shows spherical aberration curves, astigmatic field curves and a distortion curve of the image capturing unit corresponding to the long distance according to the 3rd embodiment;

FIG. 9 shows spherical aberration curves, astigmatic field curves and a distortion curve of the image capturing unit corresponding to the short distance according to the 3rd embodiment;

FIG. 10 is a schematic view of an image capturing unit corresponding to a long distance and a short distance according to the 4th embodiment of the present disclosure;

FIG. 11 shows spherical aberration curves, astigmatic field curves and a distortion curve of the image capturing unit corresponding to the long distance according to the 4th embodiment;

FIG. 12 shows spherical aberration curves, astigmatic field curves and a distortion curve of the image capturing unit corresponding to the short distance according to the 4th embodiment;

FIG. 13 is a schematic view of an image capturing unit corresponding to a long distance and a short distance according to the 5th embodiment of the present disclosure;

FIG. 14 shows spherical aberration curves, astigmatic field curves and a distortion curve of the image capturing unit corresponding to the long distance according to the 5th embodiment;

FIG. 15 shows spherical aberration curves, astigmatic field curves and a distortion curve of the image capturing unit corresponding to the short distance according to the 5th embodiment;

FIG. 16 is a schematic view of an image capturing unit corresponding to a long distance and a short distance according to the 6th embodiment of the present disclosure;

FIG. 17 shows spherical aberration curves, astigmatic field curves and a distortion curve of the image capturing unit corresponding to the long distance according to the 6th embodiment;

FIG. 18 shows spherical aberration curves, astigmatic field curves and a distortion curve of the image capturing unit corresponding to the short distance according to the 6th embodiment;

FIG. 19 is a schematic view of an image capturing unit corresponding to a long distance and a short distance according to the 7th embodiment of the present disclosure;

FIG. 20 shows spherical aberration curves, astigmatic field curves and a distortion curve of the image capturing unit corresponding to the long distance according to the 7th embodiment;

FIG. 21 shows spherical aberration curves, astigmatic field curves and a distortion curve of the image capturing unit corresponding to the short distance according to the 7th embodiment;

FIG. 22 is a schematic view of an image capturing unit corresponding to a long distance and a short distance according to the 8th embodiment of the present disclosure;

FIG. 23 shows spherical aberration curves, astigmatic field curves and a distortion curve of the image capturing unit corresponding to the long distance according to the 8th embodiment;

FIG. 24 shows spherical aberration curves, astigmatic field curves and a distortion curve of the image capturing unit corresponding to the short distance according to the 8th embodiment;

FIG. 25 is a perspective view of an image capturing unit according to the 9th embodiment of the present disclosure;

FIG. 26 is one perspective view of an electronic device according to the 10th embodiment of the present disclosure;

FIG. 27 is another perspective view of the electronic device in FIG. 26;

FIG. 28 is one perspective view of an electronic device according to the 11th embodiment of the present disclosure;

FIG. 29 is another perspective view of the electronic device in FIG. 28;

FIG. 30 is a block diagram of the electronic device in FIG. 28;

FIG. 31 is one perspective view of an electronic device according to the 12th embodiment of the present disclosure;

FIG. 32 shows a schematic view of inflection points on lens surfaces, critical points on lens surfaces and Yc71 according to the 1st embodiment of the present disclosure;

FIG. 33 shows a schematic view of CT1, T12, TL, SAG2R1, SAG3R2, SAG6R1, Y1R1 and Y7R1 according to the 1st embodiment of the present disclosure;

FIG. 34 shows a schematic view of a shape of an aperture stop according to one embodiment of the present disclosure;

FIG. 35 shows a schematic view of another shape of an aperture stop according to one embodiment of the present disclosure;

FIG. 36 shows a schematic view of a configuration of a reflective element in an optical imaging lens system according to one embodiment of the present disclosure; and

FIG. 37 shows a schematic view of one combination of the reflective element according to one embodiment of the present disclosure.

### DETAILED DESCRIPTION

An optical imaging lens system includes seven optical elements. The seven optical elements are, in order from an object side to an image side along an optical path, a first optical element, a second optical element, a third optical element, a fourth optical element, a fifth optical element, a sixth optical element and a seventh optical element. Each of the seven optical elements has an object-side surface facing toward the object side and an image-side surface facing toward the image side.

The first optical element is a reflective element. Each of the second optical element to the seventh optical element is a lens element.

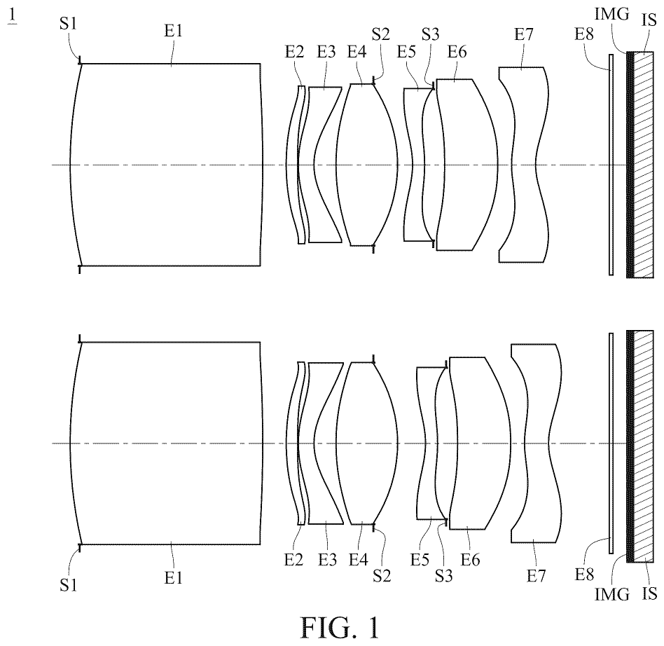

The optical imaging lens system has a first state and a second state, wherein the first state refers to a state of the optical imaging lens system with an imaged object at a long distance, and the second state refers to a state of the optical imaging lens system with an imaged object at a short distance. In the optical imaging lens system disclosed in the present disclosure, an object distance refers to an axial distance between the imaged object and the object-side surface of the first optical element. The long distance refers to a state of the optical imaging lens system with the object distance of 5000 millimeters or more, which is exemplary infinity in the embodiments. However, the present disclosure is not limited thereto. The short distance refers to a state of the optical imaging lens system with the object distance of 1000 millimeters or less, but the short distance is not limited to the object distance disclosed in the embodiments. The object distance may be adjusted as needed. Moreover, the long distance may refer to a state of the optical imaging lens system with the object distance more than 10000 millimeters, and the short distance may refer to a state of the optical imaging lens system with the object distance of 800 millimeters or less. When the imaged object at the long distance moves to be at the short distance, at least two lens elements of the optical imaging lens system move along an optical axis direction with respect to other lens elements of the optical imaging lens system to perform a focus tuning process so as to correspond to different object distances, so that the optical imaging lens system is changed from the first state to the second state. The optical imaging lens system can perform the focus tuning process to capture an image of an object with any object distance ranging from the long distance to the short distance. Please refer to FIG. 1, which is a schematic view of an optical imaging lens system of an image capturing unit at the first state (focusing on the long distance) and the second state (focusing on the short distance) according to the 1st embodiment of the present disclosure. The upper part of FIG. 1 shows the optical imaging lens system at the first state, and the lower part of FIG. 1 shows the optical imaging lens of the optical imaging lens system at the second state. Moreover, at least two lens elements move along an optical axis direction with respect to other lens elements of the optical imaging lens system during the focus tuning process. Therefore, it is favorable for enabling a certain range of telephoto photography and macro photography of the optical imaging lens system so as to enhance functional performance and extend application range of the optical imaging lens system. Moreover, one of the at least two lens elements which move during the focus tuning process is the seventh optical element. Therefore, it is favorable for ensuring an excellent flexible space arrangement of the mechanism and other assemblies during the focus tuning process, and for simplifying the mechanism design and assembly difficulty.

The first optical element has positive refractive power. Therefore, it is favorable for reducing the overall size and controlling the angle of view. The object-side surface of the first optical element is convex in a paraxial region thereof. Therefore, it is favorable for collaborating with different object distances, ensuring that light can be received by the object-side surface of the reflective element and increasing the light incident amount. The first optical element has a reflective surface located between the object-side surface and the image-side surface thereof. The optical path can be reflected at least once through the reflective surface of the reflective element, such that the optical imaging lens system can be more flexible in space arrangement, thereby reducing mechanical limitation and miniaturizing the optical imaging lens system.

The third optical element has negative refractive power. Therefore, it is favorable for assisting in light divergence capability, thereby facilitating the formation of a structure having long focal length in the optical imaging lens system. The object-side surface of the third optical element is convex in a paraxial region thereof. Therefore, it is favorable for adjusting the refractive power of the third optical element so as to correct spherical aberration. The image-side surface of the third optical element is concave in a paraxial region thereof. Therefore, it is favorable for adjusting the light emitting direction from the third optical element, thereby balancing the optical path direction and correcting aberration.

The object-side surface of the fourth optical element is convex in a paraxial region thereof. Therefore, it is favorable for providing a proper convergence ability on the object-side surface of the fourth optical element so as to reduce the size of the optical imaging lens system.

The sixth optical element has positive refractive power. Therefore, it is favorable for balancing the overall refractive power configuration and reducing the size at the image end of the optical imaging lens system.

The object-side surface of the seventh optical element is convex in a paraxial region thereof. Therefore, it is favorable for balancing convergence of light from different object distances, thereby improving image quality. The image-side surface of the seventh optical element is concave in a paraxial region thereof. Therefore, it is favorable for adjusting the light emitting direction from the seventh optical element, which is favorable for enlarging the image surface and maintaining a proper back focal length.

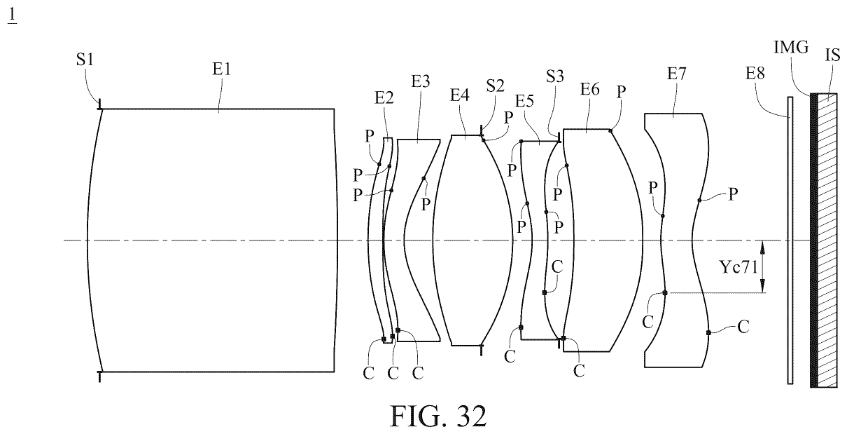

According to the present disclosure, at least one of the object-side surface and the image-side surface of the seventh optical element has at least one inflection point. Therefore, it is favorable for increasing the flexibility of optical design, which is favorable for correcting off-axis aberrations. Please refer to FIG. 32, which shows a schematic view of inflection points P on the object-side surface of the seventh optical element E7 and the image-side surface of the seventh optical element E7, as well as inflection points P on the object-side surface of the second optical element E2, the image-side surface of the second optical element E2, the object-side surface of the third optical element E3, the image-side surface of the third optical element E3, the image-side surface of the fourth optical element E4, the object-side surface of the fifth optical element E5, the image-side surface of the fifth optical element E5, the object-side surface of the sixth optical element E6 and the image-side surface of the sixth optical element E6 with the optical imaging lens system focusing on the long distance according to the 1st embodiment of the present disclosure. The abovementioned one or more inflection points P on any lens surface of the second through seventh optical elements in FIG. 32 are only exemplary. Each of lens surfaces in various embodiments of the present disclosure can also have one or more inflection points.

According to the present disclosure, at least one of the object-side surface and the image-side surface of the seventh optical element has at least one critical point in an off-axis region thereof. Moreover, the image-side surface of the seventh optical element can have at least one critical point in an off-axis region thereof.

Therefore, it is favorable for controlling the optical path at the periphery of the seventh optical element, thereby correcting distortion and field curvature. Please refer to FIG. 32, which shows a schematic view of critical points C on the object-side surface of the seventh optical element E7, the image-side surface of the seventh optical element E7, as well as critical points C on the object-side surface of the second optical element E2, the image-side surface of the second optical element E2, the object-side surface of the third optical element E3, the object-side surface of the fifth optical element E5, the image-side surface of the fifth optical element E5 and the object-side surface of the sixth optical element E6 with the optical imaging lens system focusing on the long distance according to the 1st embodiment of the present disclosure. The abovementioned one or more critical points C on any lens surface of the second through seventh optical elements in FIG. 32 are only exemplary. Each of lens surfaces in various embodiments of the present disclosure can also have one or more critical points in an off-axis region thereof.

According to the present disclosure, the inflection points and the critical points are calculated only within the optical effective region of an optical element (reflective element and lens element).

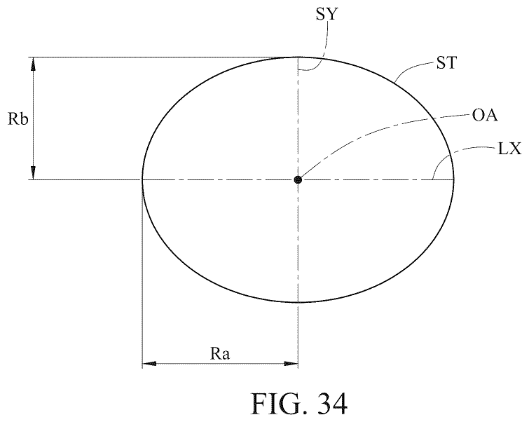

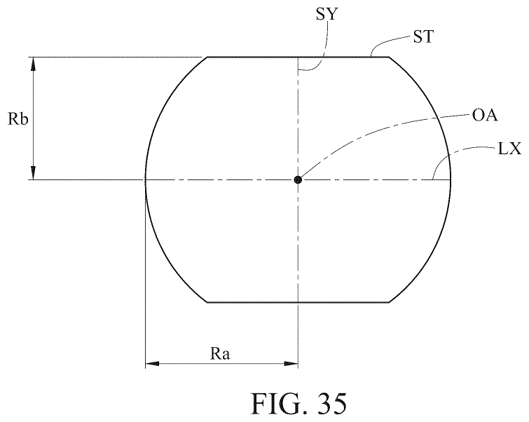

According to the present disclosure, the optical imaging lens system can further include an aperture stop. Moreover, the aperture stop can have a major axis direction and a minor axis direction which are perpendicular to the optical axis and are different from each other, and an effective radius of the aperture stop in the major axis direction is different from an effective radius of the aperture stop in the minor axis direction. Therefore, it is favorable for adjusting the shape of the aperture stop so as to reduce stray light. For example, please refer to FIG. 34 and FIG. 35, which show schematic views of non-circular aperture stops according to the present disclosure, wherein FIG. 34 shows a schematic view of a shape of an aperture stop according to one embodiment of the present disclosure, and FIG. 35 shows a schematic view of another shape of an aperture stop according to one embodiment of the present disclosure. As shown in FIG. 34, in some configurations of the present disclosure, a shape of an aperture stop ST is elliptical, and the aperture stop ST has a major axis direction LX and a minor axis direction SY that are perpendicular to an optical axis OA. The major axis direction LX and the minor axis direction SY are two different directions, and an effective radius Ra of the aperture stop ST in the major axis direction LX is greater than an effective radius Rb of the aperture stop ST in the minor axis direction SY As shown in FIG. 35, in some other configurations of the present disclosure, an aperture stop ST is shaped to have trimmed edges at an outer periphery thereof, and the aperture stop ST has a major axis direction LX and a minor axis direction SY that are perpendicular to an optical axis OA. The major axis direction LX and the minor axis direction SY are two different directions, and an effective radius Ra of the aperture stop ST in the major axis direction LX is greater than an effective radius Rb of the aperture stop ST in the minor axis direction SY.

According to the present disclosure, in addition to the aforementioned aperture stop, at least one element can have non-circular optical effective region. Specifically, the lens barrel or the optical elements can be trimmed to reduce the length along single axis. Therefore, it is favorable for reducing the size of the lens, thereby achieving the miniaturization of the module. The trimmed element can have, for example, the trimmed edges, as shown in FIG. 35, which will not be repeated again.

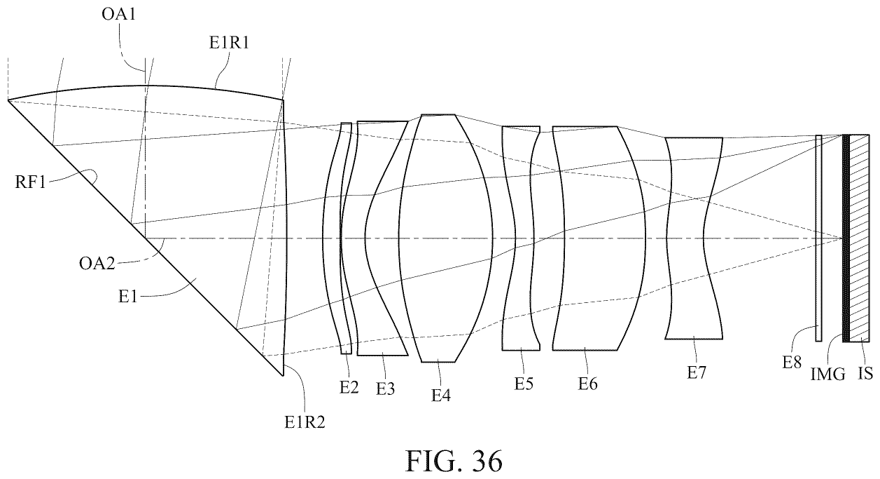

According to the present disclosure, the first optical element is a prism. Therefore, it is favorable for supporting optical image stabilization function of the optical imaging lens system and effectively improving the durability and structural strength of the product. Please refer to FIG. 36, which shows a schematic view of one configuration of the first optical element in an image capturing unit according to the 1st embodiment of the present disclosure. As shown in FIG. 36, in order from an imaged object (not shown in the figure) to an image surface IMG of the optical imaging lens system, an optical path can enter a first optical element E1 through an object-side surface E1R1 of the first optical element E1, be reflected off a reflective surface RF1 of the first optical element E1, pass through an image-side surface E1 R2 of the first optical element E1, a second optical element E2, a third optical element E3, a fourth optical element E4, a fifth optical element E5, a sixth optical element E6, a seventh optical element E7 and a filter E8 along a second optical axis OA2, and then extend onto the image surface IMG.

According to the present disclosure, the angle between the normal direction of the reflective surface and the optical axis is not limited to 45 degrees shown in FIG. 36. Other angles can be arranged according to actual requirements such as space arrangement.

According to the present disclosure, the optical surface of the reflective element can be a planar surface, a spherical surface, an aspheric surface or a freeform surface according to the optical design requirements, but the present disclosure is not limited thereto.

In addition, in order to reduce the size of the optical imaging lens system, the length, the width and the height of the reflective element may be different from one another. Moreover, an angle between a vector of the optical axis at the object end and that at the image end can be any angle, not limited to 0 degrees, 90 degrees or 180 degrees.

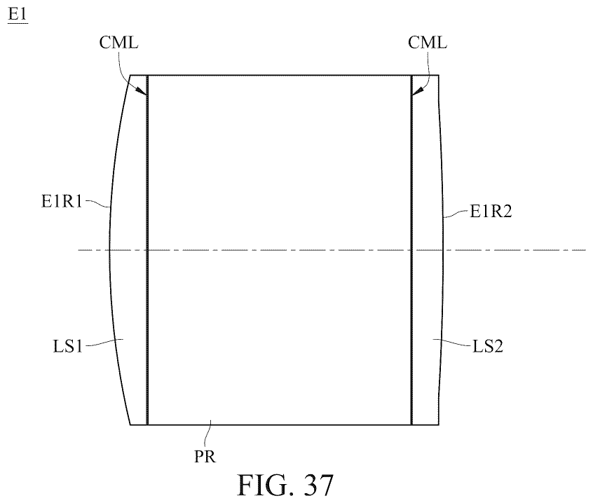

According to the present disclosure, the reflective element can be formed as a single piece or consist of more than one prism depending on the design requirements. Moreover, the prism can be made of glass material or plastic material depending on the design requirements. Please be noted that the first optical element mentioned above can be a single prism having refractive power, but the present disclosure is not limited thereto. The first optical element can also be a reflective element assembly consisting of a lens element and a prism which are cemented with each other, or can be a reflective element assembly consisting of two lens elements and a prism which are cemented with one another, but the present disclosure is not limited to such combination. Also, the lens element and the prism in the said reflective element assembly can be made of the same or different materials. Please refer to FIG. 37, which shows a schematic view of one combination of the reflective element according to the present disclosure. As shown in FIG. 37, the first optical element E1 is a reflective element assembly consisting of two lens elements LS1 and LS2 and one prism PR which are cemented with one another through cemented layer CML.

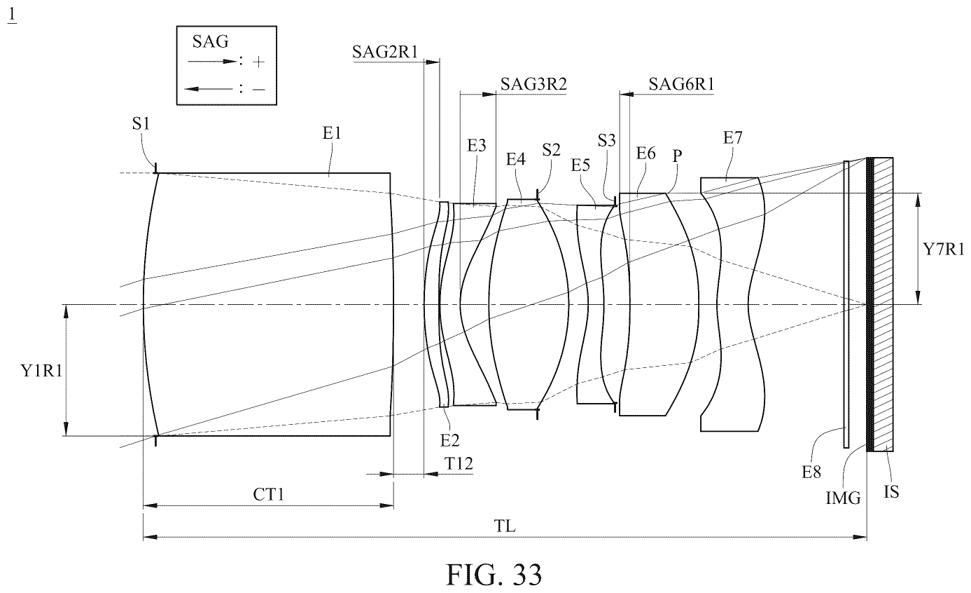

When an axial distance between the object-side surface of the first optical element and an image surface is TL, and a central thickness of the first optical element is CT1, the following condition can be satisfied: 1.30<(TL−CT1)/CT1<3.00. Therefore, it is favorable for controlling the total track length of the optical imaging lens system and facilitating the space arrangement of the mechanism and other assemblies. Moreover, the following condition can also be satisfied: 1.40<(TL−CT1)/CT1<2.60. Moreover, the following condition can also be satisfied: 1.50<(TL−CT1)/CT1<2.40. Moreover, the following condition can also be satisfied: 1.70≤(TL−CT1)/CT1≤2.08. Please refer to FIG. 33, which shows a schematic view of CT1 and TL according to the 1st embodiment of the present disclosure.

When a curvature radius of the object-side surface of the seventh optical element is R13, and a curvature radius of the image-side surface of the seventh optical element is R14, the following condition can be satisfied: 0.60<|R13/R14|<3.00. Therefore, it is favorable for assisting in balancing the back focal length by adjusting the lens shape and the refractive power of the seventh optical element, thereby correcting astigmatism and field curvature. Moreover, the following condition can also be satisfied: 0.75<|R13/R14|<2.80. Moreover, the following condition can also be satisfied: 0.90<R13/R14|<2.50. Moreover, the following condition can also be satisfied: 1.04≤|R13/R14|≤1.83.

When a central thickness of the second optical element is CT2, and an axial distance between the first optical element and the second optical element is T12, the following condition can be satisfied: 0.05<CT2/T12<3.00. Therefore, the adjustment to the central thickness of the second optical element is favorable for effectively controlling the distance between the first optical element and the second optical element, thereby preventing impact therebetween and effectively increasing yield rate of assembly. Moreover, the following condition can also be satisfied: 0.10<CT2/T12<2.80. Moreover, the following condition can also be satisfied: 0.15<CT2/T12<2.50. Moreover, the following condition can also be satisfied: 0.25<CT2/T12<1.80. Moreover, the following condition can also be satisfied: 0.37<CT2/T12≤1.17. Please refer to FIG. 33, which shows a schematic view of T12 according to the 1st embodiment of the present disclosure.

When a focal length of the optical imaging lens system is f, and a focal length of the second optical element is f2, the following condition can be satisfied: −0.80<f/f2<2.80. Therefore, it is favorable for correcting spherical aberrations of the optical imaging lens system by adjusting the refractive power of the second optical element. Moreover, the following condition can also be satisfied: −0.30<f/f2<2.50. Moreover, the following condition can also be satisfied: −0.20<f/f2<2.20. Moreover, the following condition can also be satisfied: −0.07≤f/f2≤1.85.

When a curvature radius of the object-side surface of the fourth optical element is R7, and a curvature radius of the image-side surface of the fourth optical element is R8, the following condition can be satisfied: −0.60<(R7+R8)/(R7−R8)<2.50. Therefore, it is favorable for optimizing the light propagation path within the fourth optical element, thereby enhancing image quality and preserving the spatial perception of the scene as viewed by the photographer. Moreover, the following condition can also be satisfied: −0.50<(R7+R8)/(R7−R8)<2.00. Moreover, the following condition can also be satisfied: −0.30<(R7+R8)/(R7−R8)<1.70. Moreover, the following condition can also be satisfied: −0.20<(R7+R8)/(R7−R8)<0.60. Moreover, the following condition can also be satisfied: 0.12≤(R7+R8)/(R7−R8)≤1.37.

When an Abbe number of the sixth optical element is V6, and an Abbe number of the seventh optical element is V7, the following condition can be satisfied: 0.10<V6/V7<1.40. Therefore, it is favorable for adjusting material distribution of lens elements and correcting chromatic aberration generated by the optical imaging lens system, thereby preventing overlapped images and thus improving image quality. Moreover, the following condition can also be satisfied: 0.15<V6/V7<0.90. Moreover, the following condition can also be satisfied: 0.20<V6/V7<0.80. Moreover, the following condition can also be satisfied: 0.25<V6/V7<0.75. Moreover, the following condition can also be satisfied: 0.36≤V6/V7≤0.57.

When an axial distance between the third optical element and the fourth optical element is T34, and a central thickness of the fourth optical element is CT4, the following condition can be satisfied: 0<T34/CT4<0.90. Therefore, it is favorable for adjusting the distance between the third optical element and the fourth optical element and the central thickness of the fourth optical element, thereby reducing the overall size and correcting aberrations. Moreover, the following condition can also be satisfied: 0.05<T34/CT4<0.80. Moreover, the following condition can also be satisfied: 0.10<T34/CT4<0.65. Moreover, the following condition can also be satisfied: 0.15<T34/CT4<0.50. Moreover, the following condition can also be satisfied: 0.22≤T34/CT4≤0.36.

When an f-number of the optical imaging lens system is Fno, the following condition can be satisfied: 1.30<Fno<2.80. Therefore, it is favorable for balancing 15 the depth of field and illuminance, and enhancing the light incident amount to improve image quality. Moreover, the following condition can also be satisfied: 1.40<Fno<2.70. Moreover, the following condition can also be satisfied: 1.50<Fno<2.60. Moreover, the following condition can also be satisfied: 1.68≤Fno≤2.36.

When the focal length of the optical imaging lens system is f, and a composite focal length of the second optical element, the third optical element and the fourth optical element is f234, the following condition can be satisfied: −0.30<f/f234<2.50. Therefore, it is favorable for controlling light convergence capability and light divergence capability of the optical imaging lens system at front end thereof, which is favorable for harmonizing the optical path and controlling the total track length. Moreover, the following condition can also be satisfied: 0<f/f234<2.30. Moreover, the following condition can also be satisfied: 0.60<f/f234<2.10.

When the central thickness of the second optical element is CT2, and a central thickness of the third optical element is CT3, the following condition can be satisfied: 0.15<CT2/CT3<1.80. Therefore, it is favorable for controlling the ratio of the central thicknesses of the second optical element to the third optical element, which is favorable for taking the manufacturing limitations of the lens elements into account while reducing manufacturing tolerances. Moreover, the following condition can also be satisfied: 0.25<CT2/CT3<1.60. Moreover, the following condition can also be satisfied: 0.35<CT2/CT3<1.20.

When an axial distance between the object-side surface of the first optical element and the image-side surface of the seventh optical element is TD, and a maximum image height of the optical imaging lens system is ImgH, the following condition can be satisfied: 3.00<TD/ImgH<4.50. Therefore, it is favorable for reducing the overall size and enlarging the image surface while maintaining the structure having a long focal length, so that the product achieves a superior specification. Moreover, the following condition can also be satisfied: 3.30<TD/ImgH<4.40. Moreover, the following condition can also be satisfied: 3.63≤TD/ImgH≤4.13.

When a maximum field of view of the optical imaging lens system is FOV, the following condition can be satisfied: 18.0 degrees<FOV<50.0 degrees. Therefore, it is favorable for having a proper viewing angle of the optical imaging lens system so as to meet the requirements of the product application. Moreover, the following condition can also be satisfied: 24.0 degrees<FOV<45.0 degrees. Moreover, the following condition can also be satisfied: 30.0 degrees s FOV s 39.80 degrees.

When an axial distance between the object-side surface of the first optical element and the image surface of the optical imaging lens system focusing on the long distance is TLi, and an axial distance between the object-side surface of the first optical element and the image surface of the optical imaging lens system focusing on the short distance is TLm, the following condition can be satisfied: 0<|TLi−TLm|/TLi<2.0E−3. Therefore, it is favorable for achieving the effects of saving the space and simplifying the mechanism design while enabling telephoto photography and macro photography of the optical imaging lens system. Moreover, the following condition can also be satisfied: 0≤|TLi−TLm|/TLi<1.0E−3.

When the focal length of the optical imaging lens system is f, and a focal length of the fourth optical element is f4, the following condition can be satisfied: 0.70<f/f4<3.10. Therefore, it is favorable for adjusting the refractive power of the fourth optical element, which is favorable for reducing the size and sensitivity of the optical imaging lens system. Moreover, the following condition can also be satisfied: 0.90<f/f4<2.90. Moreover, the following condition can also be satisfied: 1.20<f/f4<2.60.

When the central thickness of the first optical element is CT1, the central thickness of the second optical element is CT2, the central thickness of the third optical element is CT3, the central thickness of the fourth optical element is CT4, a central thickness of the fifth optical element is CT5, a central thickness of the sixth optical element is CT6, and a central thickness of the seventh optical element is CT7, the following condition can be satisfied: 0.50<(CT2+CT3+CT4+CT5+CT6+CT7)/CT1<1.40. Therefore, it is favorable for balancing the space arrangement of the optical imaging lens system and maintaining high light convergence quality across a large range of object distances. Moreover, the following condition can also be satisfied: 0.55<(CT2+CT3+CT4+CT5+CT6+CT7)/CT1<1.30. Moreover, the following condition can also be satisfied: 0.60<(CT2+CT3+CT4+CT5+CT6+CT7)/CT1<1.20.

When an Abbe number of the first optical element is V1, and an Abbe number of the second optical element is V2, the following condition can be satisfied: 0.20<V2/V1<1.60. Therefore, it is favorable for correcting chromatic aberration across a large range of object distances, thereby effectively balancing convergence of light with different wavelengths. Moreover, the following condition can also be satisfied: 0.30<V2/V1<1.50.

When a curvature radius of the object-side surface of the second optical element is R3, and a curvature radius of the object-side surface of the fifth optical element is R9, the following condition can be satisfied: 0.05<|R9/R3|<2.00. Therefore, it is favorable for balancing refraction angle of light between the second optical element and the fifth optical element so as to reduce stray light, so that the optical imaging lens system can have high pixels photography across different object distances. Moreover, the following condition can also be satisfied: 0.07<|R9/R3|<1.50. Moreover, the following condition can also be satisfied: 0.10<|R9/R3|<1.00.

When a displacement in parallel with the optical axis from an axial vertex of the image-side surface of the third optical element to a maximum effective radius position of the image-side surface of the third optical element is SAG3R2, and a displacement in parallel with the optical axis from an axial vertex of the object-side surface of the sixth optical element to a maximum effective radius position of the object-side surface of the sixth optical element is SAG6R1, the following condition can be satisfied: −2.00<SAG6R1/SAG3R2<0.60. Therefore, it is favorable for balancing the optical path direction at the periphery so as to improve convergence quality of light from all fields of view. Moreover, the following condition can also be satisfied: −1.70<SAG6R1/SAG3R2<0.50. Please refer to FIG. 33, which shows a schematic view of SAG3R2 and SAG6R1 according to the 1st embodiment of the present disclosure.

When a maximum effective radius of the object-side surface of the first optical element is Y1R1, and the maximum image height of the optical imaging lens system is ImgH, the following condition can be satisfied: 0.45<Y1R1/ImgH<1.60. Therefore, it is favorable for assisting in the formation of a structure having a long focal length while obtaining a proper balance between the illuminance and the size of the image surface. Moreover, the following condition can also be satisfied: 0.55<Y1R1/ImgH<1.50. Please refer to FIG. 33, which shows a schematic view of Y1R1 according to the 1st embodiment of the present disclosure.

When the curvature radius of the object-side surface of the second optical element is R3, and a curvature radius of the object-side surface of the third optical element is R5, the following condition can be satisfied: −0.55<R5/R3<0.95. Therefore, it is favorable for collaborating the second optical element and the third optical element in correcting spherical aberration at the center, thereby enabling the optical imaging lens system to capture clear images across different object distances. Moreover, the following condition can also be satisfied: −0.40<R5/R3<0.90.

When the axial distance between the object-side surface of the first optical element and the image surface is TL, and the maximum image height of the optical imaging lens system is ImgH, the following condition can be satisfied: 4.30<TL/ImgH<5.10. Therefore, it is favorable for forming a telephoto structure and obtaining a proper balance between the total track length and image height. Moreover, the following condition can also be satisfied: 4.50<TL/ImgH<5.00. Moreover, the following condition can also be satisfied: 4.73≤TL/ImgH≤4.98.

When the curvature radius of the image-side surface of the seventh optical element is R14, and the focal length of the optical imaging lens system is f, the following condition can be satisfied: 0.08<R14/f<0.48. Therefore, it is favorable for controlling the lens curvature of the image-side surface of the seventh optical element, thereby optimizing image qualities across different object distances. Moreover, the following condition can also be satisfied: 0.13<R14/f<0.43.

When the central thickness of the second optical element is CT2, and a displacement in parallel with the optical axis from an axial vertex of the object-side surface of the second optical element to a maximum effective radius position of the object-side surface of the second optical element is SAG2R1, the following condition can be satisfied: −3.50<CT2/SAG2R1<1.80. Therefore, it is favorable for receiving light exiting the first optical element and assisting in increasing manufacturability. Moreover, the following condition can also be satisfied: −3.30<CT2/SAG2R1<1.70. Please refer to FIG. 33, which shows a schematic view of SAG2R1 according to the 1st embodiment of the present disclosure.

When a vertical distance between a critical point on the object-side surface of the seventh optical element and an optical axis is Yc71, and a maximum effective radius of the object-side surface of the seventh optical element is Y7R1, the following condition can be satisfied: 0.30<Yc71/Y7R1<0.90. Therefore, it is favorable for increasing shape variation of the object-side surface of the seventh optical element so as to effectively correct off-axis aberration. Moreover, the following condition can also be satisfied: 0.35<Yc71/Y7R1<0.85. Please refer to FIG. 32, which shows a schematic view of Yc71 according to the 1st embodiment of the present disclosure.

Please refer to FIG. 33, which shows a schematic view of Y7R1 according to the 1st embodiment of the present disclosure.

According to the present disclosure, unless otherwise stated, the parameters in the conditional expressions correspond to the state in which the optical imaging lens system focuses on a long distance.

According to the present disclosure, the aforementioned features and conditions can be utilized in numerous combinations so as to achieve corresponding effects.

According to the present disclosure, the optical elements of the optical imaging lens system can be made of either glass or plastic material. When the optical elements are made of glass material, the refractive power distribution of the optical imaging lens system may be more flexible, and the influence on imaging caused by external environment temperature change may be reduced. The glass optical element can either be made by grinding or molding. When the optical elements are made of plastic material, the manufacturing costs can be effectively reduced. Furthermore, surfaces of each optical element can be arranged to be spherical or aspheric. Spherical optical elements are simple in manufacture. Aspheric optical element design allows more control variables for eliminating aberrations thereof and reducing the required number of optical elements, and the total track length of the optical imaging lens system can therefore be effectively shortened. Additionally, the aspheric surfaces may be formed by plastic injection molding or glass molding.

According to the present disclosure, when a lens surface is aspheric, it means that the lens surface has an aspheric shape throughout its optically effective area, or a portion(s) thereof.

According to the present disclosure, one or more of the optical elements' material may optionally include an additive which generates light absorption and interference effects and alters the optical elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material optical element by injection molding. Moreover, the additive may be coated on the lens surfaces to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the optical element has a convex surface, it indicates that the surface is convex in the paraxial region thereof; when the optical element has a concave surface, it indicates that the surface is concave in the paraxial region thereof. Moreover, when a region of refractive power, curvature radius or focus of an optical element is not defined, it indicates that the region of refractive power, curvature radius or focus of the optical element is in the paraxial region thereof. The focal length of a single optical element is calculated based on the lensmaker's formula, assuming air as the medium on both of the object side and the image side of the optical element (reflective element and lens element); the composite focal length of multiple optical elements (reflective element and lens element) is calculated by assuming air as the medium on both of the object side and the image side of the optical assembly (reflective element and lens element).

According to the present disclosure, an inflection point is a point on the surface of the optical element at which the surface changes from concave to convex, or vice versa. A critical point is a non-axial point of the lens surface where its tangent is perpendicular to the optical axis.

According to the present disclosure, the image surface of the optical imaging lens system, based on the corresponding image sensor, can be flat or curved, especially a curved surface being concave facing towards the object side of the optical imaging lens system.

According to the present disclosure, an image correction unit, such as a field flattener, can be optionally disposed between the optical element closest to the image side of the optical imaging lens system along the optical path and the image surface for correction of aberrations such as field curvature. The optical characteristics of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

According to the present disclosure, the optical imaging lens system can include at least one stop, such as an aperture stop, a glare stop or a field stop. Said glare stop or said field stop can be disposed between an imaged object and the first optical element, between adjacent optical elements, or between the last optical element and the image surface, and is set for eliminating the stray light and thereby improving image quality thereof.

According to the present disclosure, the position of the aperture stop can be adjusted based on the object distance, the configuration of the first optical element, or the trimming of the lens element. The position of the aperture stop is not limited in the embodiments.

According to the present disclosure, an aperture stop can be configured as a front stop or a middle stop. Afront stop disposed between an imaged object and the first optical element can provide a longer distance between an exit pupil of the optical imaging lens system and the image surface to produce a telecentric effect, and thereby improves the image-sensing efficiency of an image sensor (for example, CCD or CMOS). A middle stop disposed between the first optical element and the image surface is favorable for enlarging the viewing angle of the optical imaging lens system and thereby provides a wider field of view for the same.

According to the present disclosure, the optical imaging lens system can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the present disclosure, the optical imaging lens system can include one or more optical elements for limiting the form of light passing through the optical imaging lens system. Each optical element can be, but not limited to, a filter, a polarizer, etc., and each optical element can be, but not limited to, a single-piece element, a composite component, a thin film, etc. The optical element can be located at the object side or the image side of the optical imaging lens system or between any two adjacent optical elements so as to allow light in a specific form to pass through, thereby meeting application requirements.

According to the present disclosure, the optical imaging lens system can include at least one optical element, an optical element, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical element, or a connection surface between the object-side surface and the image-side surface. The said optical element can be a light-blocking element, an annular spacer, a barrel element, a cover glass, a blue glass, a filter, a color filter, an optical path folding element, a prism, a mirror, etc. The said carrier can be a base for supporting a lens assembly, a micro lens disposed on an image sensor, a substrate surrounding the image sensor, a glass plate for protecting the image sensor, etc.

According to the present disclosure, the optical imaging lens system can further include a light-blocking element. The light-blocking element can have a non-circular opening, and the non-circular opening can have different effective radii in different directions which are perpendicular to the optical axis. Therefore, it is favorable for coordinating with the shape of non-circular optical elements or aperture stop so as to effectively save the space and make full use of the light passing through said non-circular optical elements or aperture stop, thereby reducing stray light. Moreover, the light-blocking element can be provided with a wavy structure or a jagged structure at a periphery of an inner hole portion thereof.

The optical imaging lens system provided by the present disclosure can also be applied to 3D (three-dimensional) image capturing applications, in products such as digital cameras, mobile devices, digital tablets, smart televisions, network surveillance devices, motion sensing input devices, dashboard cameras, vehicle backup cameras, multi-camera devices, image recognition systems, robots, laptops, 3D video cameras, action cameras, wearable devices, drones and other electronic imaging devices.

According to the present disclosure, the axial distance between two adjacent optical elements is a distance in a paraxial region between two adjacent surfaces of the two adjacent optical elements.

According to the present disclosure, the maximum image height (ImgH) can be half of a diagonal length of an effective photosensitive area of an image sensor.

According to the above description of the present disclosure, the following specific embodiments are provided for further explanation.

### 1st Embodiment

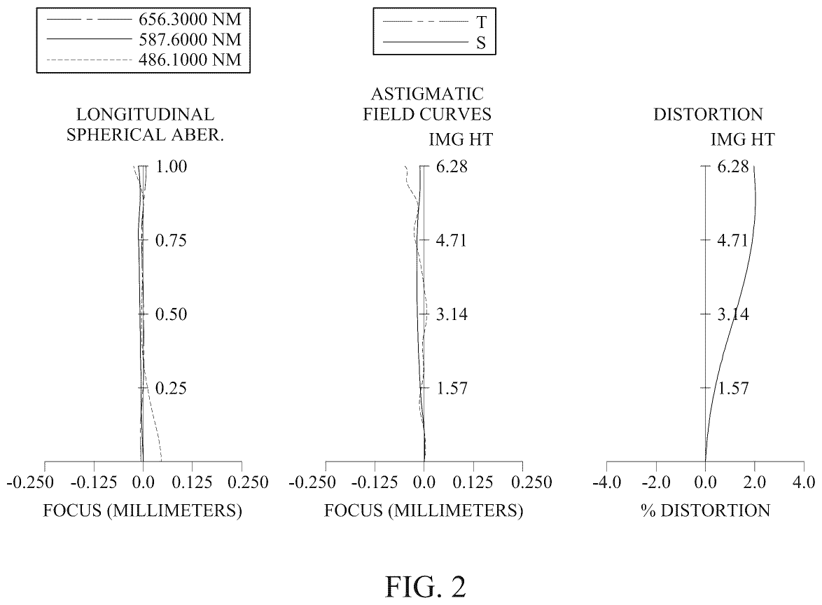

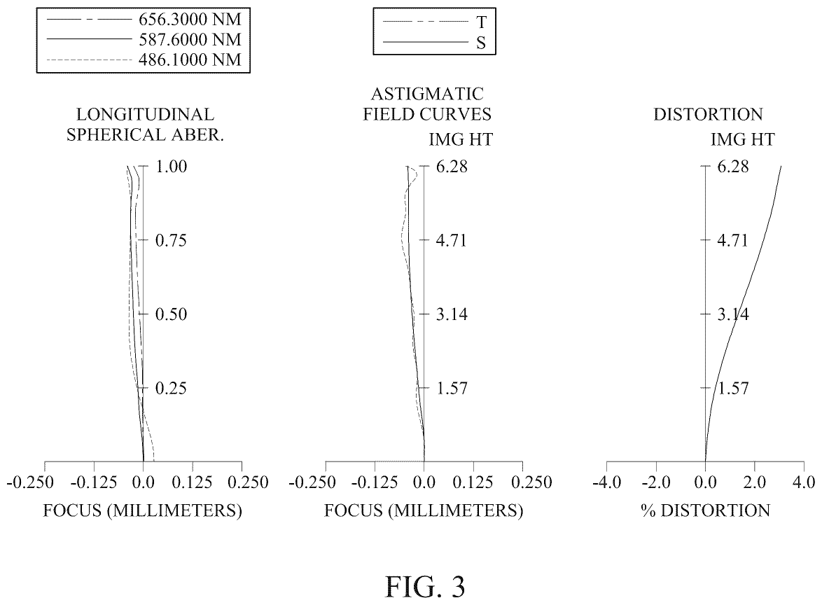

FIG. 1 is a schematic view of an image capturing unit at the first state (focusing on a long distance) and the second state (focusing on a short distance) according to the 1st embodiment of the present disclosure. FIG. 2 shows, in order from left to right, spherical aberration curves, astigmatic field curves and a distortion curve of the image capturing unit at the first state according to the 1st embodiment. FIG. 3 shows, in order from left to right, spherical aberration curves, astigmatic field curves and a distortion curve of the image capturing unit at the second state according to the 1st embodiment. The upper part of FIG. 1 shows the optical imaging lens system at the first state, and the lower part of FIG. 1 shows the optical imaging lens system at the second state. In FIG. 1, the image capturing unit 1 includes the optical imaging lens system (its reference numeral is omitted) of the present disclosure and an image sensor IS. The optical imaging lens system includes, in order from an object side to an image side along an optical path, a stop S1, a first optical element E1, a second optical element E2, a third optical element E3, a fourth optical element E4, a stop S2, a fifth optical element E5, a stop S3, a sixth optical element E6, a seventh optical element E7, a filter E8 and an image surface IMG. The optical imaging lens system includes seven optical elements (E1, E2, E3, E4, E5, E6 and E7) with no additional optical element disposed between each of the adjacent seven optical elements, wherein the first optical element E1 is a reflective element and each of the second optical element E2 to seventh optical element E7 is a lens element.

When an imaged object moves from the long distance to the short distance, the optical imaging lens system performs a focus tuning process and changes from the first state to the second state. In this embodiment, the long object distance corresponding to the optical imaging lens system at the first state is ∞ (infinity), and the short object distance corresponding to the optical imaging lens system at the second state is 349.470 millimeters. During the focus tuning process, the optical imaging lens system adjusts its focal length by moving the fifth optical element E5, the sixth optical element E6, and the seventh optical element E7 along the optical axis relative to the second optical element E2, the third optical element E3, and the fourth optical element E4. Furthermore, through the focus tuning process, the optical imaging lens system can have the first state as shown in the upper part of FIG. 1 and the second state as shown in the lower part of FIG. 1.

The first optical element E1 with positive refractive power has an object-side surface being convex in a paraxial region thereof and an image-side surface being convex in a paraxial region thereof. The first optical element E1 is made of glass material and has the object-side surface and the image-side surface being both spherical.

The second optical element E2 with positive refractive power has an object-side surface being convex in a paraxial region thereof and an image-side surface being concave in a paraxial region thereof. The second optical element E2 is made of plastic material and has the object-side surface and the image-side surface being both aspheric. The object-side surface of the second optical element E2 has one inflection point. The image-side surface of the second optical element E2 has one inflection point. The object-side surface of the second optical element E2 has one critical point in an off-axis region thereof. The image-side surface of the second optical element E2 has one critical point in an off-axis region thereof.

The third optical element E3 with negative refractive power has an object-side surface being convex in a paraxial region thereof and an image-side surface being concave in a paraxial region thereof. The third optical element E3 is made of plastic material and has the object-side surface and the image-side surface being both aspheric. The object-side surface of the third optical element E3 has one inflection point. The image-side surface of the third optical element E3 has one inflection point. The object-side surface of the third optical element E3 has one critical point in an off-axis region thereof.

The fourth optical element E4 with positive refractive power has an object-side surface being convex in a paraxial region thereof and an image-side surface being convex in a paraxial region thereof. The fourth optical element E4 is made of plastic material and has the object-side surface and the image-side surface being both aspheric. The image-side surface of the fourth optical element E4 has one inflection point.

The fifth optical element E5 with negative refractive power has an object-side surface being concave in a paraxial region thereof and an image-side surface being convex in a paraxial region thereof. The fifth optical element E5 is made of plastic material and has the object-side surface and the image-side surface being both aspheric. The object-side surface of the fifth optical element E5 has two inflection points. The image-side surface of the fifth optical element E5 has one inflection point. The object-side surface of the fifth optical element E5 has one critical point in an off-axis region thereof. The image-side surface of the fifth optical element E5 has one critical point in an off-axis region thereof.

The sixth optical element E6 with positive refractive power has an object-side surface being concave in a paraxial region thereof and an image-side surface being convex in a paraxial region thereof. The sixth optical element E6 is made of plastic material and has the object-side surface and the image-side surface being both aspheric. The object-side surface of the sixth optical element E6 has one inflection point. The image-side surface of the sixth optical element E6 has one inflection point. The object-side surface of the sixth optical element E6 has one critical point in an off-axis region thereof.

The seventh optical element E7 with negative refractive power has an object-side surface being convex in a paraxial region thereof and an image-side surface being concave in a paraxial region thereof. The seventh optical element E7 is made of plastic material and has the object-side surface and the image-side surface being both aspheric. The object-side surface of the seventh optical element E7 has one inflection point. The image-side surface of the seventh optical element E7 has one inflection point. The object-side surface of the seventh optical element E7 has one critical point in an off-axis region thereof. The image-side surface of the seventh optical element E7 has one critical point in an off-axis region thereof.

The filter E8 is made of glass material and located between the seventh optical element E7 and the image surface IMG, and will not affect the focal length of the optical imaging lens system. The image sensor IS is disposed on or near the image surface IMG.

The equation of the aspheric surface profiles of the aforementioned optical elements of the 1st embodiment is expressed as follows:

$$X ( Y ) = ( {Y}^{2} / R ) / ( 1 + s q r t ( 1 - ( 1 + k ) \times {( Y / R )}^{2} ) ) + {\sum }_{i} ( Ai ) \times ( {Y}^{i} ) ,$$

where,
X is the displacement in parallel with the optical axis from an axial vertex on the aspheric surface to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient, and in the embodiments, i may be, but is not limited to, 4, 6, 8, 10, 12, 14, 16, 18, 20, 22, 24 and 26.

In the optical imaging lens system of the image capturing unit 1 according to the 1st embodiment, when a focal length of the optical imaging lens system focusing on a long distance is fi, an f-number of the optical imaging lens system focusing on the long distance is Fnoi, half of a maximum field of view of the optical imaging lens system focusing on the long distance is HFOVi, and a maximum field of view of the optical imaging lens system focusing on the long distance is FOVi, the following conditions are satisfied: fi=18.90 millimeters (mm); Fnoi=1.68; HFOVi=18.1 degrees (deg.) and FOVi=36.2 degrees (deg.).

In the optical imaging lens system of the image capturing unit 1 according to the 1st embodiment, when a focal length of the optical imaging lens system focusing on the short distance is fm, an f-number of the optical imaging lens system focusing on the short distance is Fnom, half of a maximum field of view of the optical imaging lens system focusing on the short distance is HFOVm, and a maximum field of view of the optical imaging lens system focusing on the short distance is FOVm, the following conditions are satisfied: fm=17.46 millimeters (mm); Fnom=1.63; HFOVm=18.4 degrees (deg.) and FOVm=36.8 degrees (deg.).

An axial distance between an imaged object and the stop S1 is defined as D0. An axial distance between the stop S2 and the object-side surface of the fifth optical element E5 is defined as D1. An axial distance between the image-side surface of the seventh optical element E7 and the filter E8 is defined as D2. When the optical imaging lens system is changed between the first state (focusing on the long distance) and the second state (focusing on the short distance) through the focus tuning process, the values of D0, D1 and D2 vary accordingly. When the optical imaging lens system is at the first state, the aforementioned parameters have the following values: D0=∞ (infinity), D1=2.180 mm and D2=4.100 mm. When the optical imaging lens system is at the second state, the aforementioned parameters have the following values: D0=350.000 mm, D1=2.900 mm and D2=3.379 mm.

When an axial distance between the object-side surface of the first optical element E1 and the image surface IMG is TL, and the maximum image height of the optical imaging lens system is ImgH, the following condition is satisfied: TL/ImgH=4.94.

When an axial distance between the object-side surface of the first optical element E1 and the image-side surface of the seventh optical element E7 is TD, and the maximum image height of the optical imaging lens system is ImgH, the following condition is satisfied: TD/ImgH=4.13.

When a focal length of the optical imaging lens system is f, and a focal length of the second optical element E2 is f2, the following condition is satisfied: f/f2=0.84.

When the focal length of the optical imaging lens system is f, and a focal length of the fourth optical element E4 is f4, the following condition is satisfied: f/f4=2.02.

When the focal length of the optical imaging lens system is f, and a composite focal length of the second optical element E2, the third optical element E3 and the fourth optical element E4 is f234, the following condition is satisfied: f/f234=1.45.

When an axial distance between the object-side surface of the first optical element E1 and the image surface IMG of the optical imaging lens system focusing on the long distance is TLi, and an axial distance between the object-side surface of the first optical element E1 and the image surface IMG of the optical imaging lens system focusing on the short distance is TLm, the following condition is satisfied: |TLi−TLm|/TLi=4.8E−05.

When a curvature radius of the object-side surface of the second optical element E2 is R3, and a curvature radius of the object-side surface of the third optical element E3 is R5, the following condition is satisfied: R5/R3=0.58.

When the curvature radius of the object-side surface of the second optical element E2 is R3, and a curvature radius of the object-side surface of the fifth optical element E5 is R9, the following condition is satisfied: |R9/R31=0.40.

When a curvature radius of the object-side surface of the fourth optical element E4 is R7, and a curvature radius of the image-side surface of the fourth optical element E4 is R8, the following condition is satisfied: (R7+R8)/(R7−R8)=0.23.

When a curvature radius of the object-side surface of the seventh optical element E7 is R13, and a curvature radius of the image-side surface of the seventh optical element E7 is R14, the following condition is satisfied: |R13/R14|=1.46.

When the curvature radius of the image-side surface of the seventh optical element E7 is R14, and the focal length of the optical imaging lens system is f, the following condition is satisfied: R14/f=0.19.

When the axial distance between the object-side surface of the first optical element E1 and the image surface IMG is TL, and a central thickness of the first optical element E1 is CT1, the following condition is satisfied: (TL−CT1)/CT1=1.89.

When a central thickness of the second optical element E2 is CT2, and an axial distance between the first optical element E1 and the second optical element E2 is T12, the following condition is satisfied: CT2/T12=0.49.

When the central thickness of the second optical element E2 is CT2, and a central thickness of the third optical element E3 is CT3, the following condition is satisfied: CT2/CT3=0.74.

When an axial distance between the third optical element E3 and the fourth optical element E4 is T34, and a central thickness of the fourth optical element E4 is CT4, the following condition is satisfied: T34/CT4=0.36.

When the central thickness of the first optical element E1 is CT1, the central thickness of the second optical element E2 is CT2, the central thickness of the third optical element E3 is CT3, the central thickness of the fourth optical element E4 is CT4, a central thickness of the fifth optical element E5 is CT5, a central thickness of the sixth optical element E6 is CT6, and a central thickness of the seventh optical element E7 is CT7, the following condition is satisfied: (CT2+CT3+CT4+CT5+CT6+CT7)/CT1=0.92.

When an Abbe number of the first optical element E1 is V1, and an Abbe number of the second optical element E2 is V2, the following condition is satisfied: V2/V1=1.04.

When an Abbe number of the sixth optical element E6 is V6, and an Abbe number of the seventh optical element E7 is V7, the following condition is satisfied: V6/V7=0.57.

When the central thickness of the second optical element E2 is CT2, and a displacement in parallel with the optical axis from an axial vertex of the object-side surface of the second optical element E2 to a maximum effective radius position of the object-side surface of the second optical element E2 is SAG2R1, the following condition is satisfied: CT2/SAG2R1=1.00. In this embodiment, the direction of SAG2R1 faces the image side, and thus the value of SAG2R1 is positive.

When a displacement in parallel with the optical axis from an axial vertex of the image-side surface of the third optical element E3 to a maximum effective radius position of the image-side surface of the third optical element E3 is SAG3R2, and a displacement in parallel with the optical axis from an axial vertex of the object-side surface of the sixth optical element E6 to a maximum effective radius position of the object-side surface of the sixth optical element E6 is SAG6R1, the following condition is satisfied: SAG6R1/SAG3R2=−0.27. In this embodiment, the direction of SAG3R2 faces the image side, and thus the value of SAG3R2 is positive; the direction of SAG6R1 faces the object side, and thus the value of SAG6R1 is negative.

When a maximum effective radius of the object-side surface of the first optical element E1 is Y1R1, and the maximum image height of the optical imaging lens system is ImgH, the following condition is satisfied: Y1R1/ImgH=0.90.

When a vertical distance between the critical point on the object-side surface of the seventh optical element E7 and the optical axis is Yc71, and a maximum effective radius of the object-side surface of the seventh optical element E7 is Y7R1, the following condition is satisfied: Yc71/Y7R1=0.47.

The detailed optical data of the 1st embodiment are shown in Table 1A and Table 1B, and the aspheric surface data are shown in Table 1C below.

TABLE 1A
1st Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Stop | Plano | | −0.530 | | | | |
| 2 | Optical element 1 | 24.1908 | (SPH) | 10.724 | Glass | 1.580 | 53.7 | 33.20 |
| 3 | | −78.7402 | (SPH) | 1.308 | | | | |
| 4 | Optical element 2 | 11.7371 | (ASP) | 0.638 | Plastic | 1.544 | 56.0 | 22.58 |
| 5 | | 257.6459 | (ASP) | 0.039 | | | | |
| 6 | Optical element 3 | 6.8562 | (ASP) | 0.868 | Plastic | 1.587 | 28.3 | −12.60 |
| 7 | | 3.3925 | (ASP) | 1.229 | | | | |
| 8 | Optical element 4 | 12.4367 | (ASP) | 3.425 | Plastic | 1.544 | 56.0 | 9.34 |
| 9 | | −7.7550 | (ASP) | −1.346 | | | | |
| 10 | Stop | Plano | | D1 | | | | |
| 11 | Optical element 5 | 24.1908 | (ASP) | 0.674 | Plastic | 1.614 | 26.0 | −17.75 |
| 12 | | −78.7402 | (ASP) | 0.475 | | | | |
| 13 | Stop | Plano | | 0.639 | | | | |
| 14 | Optical element 6 | −28.2738 | (ASP) | 2.953 | Plastic | 1.656 | 21.3 | 41.48 |
| 15 | | −14.4400 | (ASP) | 0.773 | | | | |
| 16 | Optical element 7 | 5.1661 | (ASP) | 1.339 | Plastic | 1.566 | 37.4 | −28.19 |
| 17 | | 3.5371 | (ASP) | D2 | | | | |

| | | | | | | | |
|---|---|---|---|---|---|---|---|
| 18 | Filter | Plano | 0.210 | Glass | 1.517 | 64.2 | — |
| 19 | | Plano | 0.774 | | | | |
| 20 | Image | Plano | — | | | | |

Note:
Reference wavelength is 587.6 nm (d-line).
An effective radius of the stop S1 (Surface 1) is 5.625 mm.
An effective radius of the stop S2 (Surface 10) is 4.497 mm.
An effective radius of the stop S3 (Surface 13) is 4.210 mm.

In Table 1A, the curvature radius, the thickness and the focal length are shown in millimeters (mm). Surface numbers 0-20 represent the surfaces sequentially arranged from the object side to the image side along the optical axis.

TABLE 1B
Optical data for optical imaging lens system focusing
on the long distance and the short distance

| | Focusing on the | | Focusing on the |
|---|---|---|---|
| | long distance | | short distance |
| | (First state) | | (Second state) |
| fi [mm] | 18.90 | fm [mm] | 17.46 |
| Fnoi | 1.68 | Fnom | 1.63 |
| HFOVi [deg.] | 18.1 | HFOVm [deg.] | 18.4 |
| FOVi [deg.] | 36.2 | FOVm [deg.] | 36.8 |
| object | ∞ | object | 349.470 |
| distance [mm] | | distance [mm] | |
| D0 [mm] | ∞ | D0 [mm] | 350.000 |
| D1 [mm] | 2.180 | D1 [mm] | 2.900 |
| D2 [mm] | 4.100 | D2 [mm] | 3.379 |

Table 1B shows optical data of the first state and the second state of the optical imaging lens system in different focusing conditions. It should be understood that only two focus tuning conditions (i.e., the first state and the second state) are disclosed in this embodiment, but the present disclosure is not limited thereto. Besides the first state and the second state, the optical imaging lens system of this embodiment can further have other focal lengths corresponding to the intermediate range of the first state and the second state in other focus tuning conditions for different object distances.

It can be known from Table 1B, when the object distance D0 varies to 350.000 millimeters from infinity, the optical imaging lens system changes to the second state from the first state, the axial distance between the stop S2 and the object-side surface of the fifth optical element E5 increases to 2.900 millimeters of the second state from 2.180 millimeters of the first state, and the axial distance between the image-side surface of the seventh optical element E7 and the filter E8 decreases to 3.379 millimeters of the second state from 4.100 millimeters of the first state.

TABLE 1C
Aspheric Coefficients

| Surface # | 4 | 5 | 6 | 7 |
|---|---|---|---|---|
| k= | 1.64324E+00 | 9.00000E+01 | 9.15537E−01 | −2.02636E+00 |
| A4= | −1.5796278E−03 | 6.4660528E−03 | 2.1368598E−03 | −7.6777998E−04 |
| A6= | 7.0050097E−04 | −8.6549082E−04 | −1.4226116E−03 | −1.8732275E−04 |
| A8= | −1.3425118E−04 | 1.1464637E−04 | 2.2523713E−04 | 1.3851120E−05 |
| A10= | 1.5044940E−05 | −1.6803313E−05 | −2.8420671E−05 | 4.2520631E−07 |
| A12= | −1.0256891E−06 | 2.1309385E−06 | 2.8052797E−06 | −1.5317015E−07 |
| A14= | 4.0012575E−08 | −1.8085513E−07 | −1.9631008E−07 | 1.1545612E−08 |
| A16= | −8.2227361E−10 | 8.9722247E−09 | 8.7026025E−09 | −3.7536536E−10 |
| A18= | 6.9139971E−12 | −2.3432047E−10 | −2.1405172E−10 | 4.5083335E−12 |
| A20= | — | 2.4898452E−12 | 2.1972184E−12 | — |
| Surface # | 8 | 9 | 11 | 12 |
| k= | 4.41224E+00 | 0.00000E+00 | 0.00000E+00 | −1.31045E+01 |
| A4= | 5.2815070E−04 | 2.3852972E−04 | 9.1470391E−03 | 6.2754083E−01 |
| A6= | −1.2466894E−04 | −2.5138034E−05 | 5.3161832E−04 | 9.4942780E+00 |
| A8= | 9.4712741E−06 | 8.1609024E−07 | −2.8700009E−04 | −4.6452182E+01 |
| A10= | −2.6034470E−07 | 3.2135358E−07 | 5.5510505E−05 | 1.2978614E+02 |
| A12= | −4.4353331E−08 | −5.4360924E−08 | −6.7813354E−06 | −2.4152973E+02 |
| A14= | 4.3002863E−09 | 3.8034931E−09 | 5.6242596E−07 | 3.0221579E+02 |
| A16= | −1.3913112E−10 | −1.2872646E−10 | −3.1387021E−08 | −2.4112610E+02 |
| A18= | 1.5652881E−12 | 1.7811668E−12 | 1.1262809E−09 | 1.0966300E+02 |
| A20= | — | — | −2.3472010E−11 | −2.1493264E+01 |
| A22= | — | — | 2.1670523E−13 | — |

| Surface # | 14 | 15 | 16 | 17 |
|---|---|---|---|---|
| k= | −9.90000E+01 | −3.96201E+00 | −7.90533E−02 | −9.62593E−01 |
| A4= | −5.5131112E−03 | −1.1234979E−02 | −2.2714344E−02 | −1.7645615E+01 |
| A6= | 1.2893573E−03 | 3.1201958E−03 | 3.6258196E−03 | 6.9978713E+01 |
| A8= | −2.3648667E−04 | −6.8925546E−04 | −5.8279139E−04 | −2.7399199E+02 |
| A10= | 3.0689455E−05 | 1.1877109E−04 | 7.7210428E−05 | 8.4292764E+02 |
| A12= | −2.7840496E−06 | −1.5729086E−05 | −8.3926401E−06 | −1.9040905E+03 |
| A14= | 1.7327595E−07 | 1.5682496E−06 | 7.3904465E−07 | 3.0647888E+03 |
| A16= | −6.9099196E−09 | −1.1534542E−07 | −5.1061006E−08 | −3.4223676E+03 |
| A18= | 1.5641808E−10 | 6.1188010E−09 | 2.6497108E−09 | 2.5446109E+03 |
| A20= | −1.5082701E−12 | −2.2660526E−10 | −9.8162536E−11 | −1.1700337E+03 |
| A22= | — | 5.5420581E−12 | 2.4254579E−12 | 2.8627627E+02 |
| A24= | — | −8.0267903E−14 | −3.5568959E−14 | −2.4982575E+01 |
| A26= | — | 5.2069849E−16 | 2.3306488E−16 | — |

In Table 1C, k represents the conic coefficient of the equation of the aspheric surface profiles. A4-A26 represent the aspheric coefficients ranging from the 4th order to the 26th order. The tables presented below for each embodiment are the corresponding schematic parameter and aberration curves, and the definitions of the tables are the same as Table 1A to Table 1C of the 1st embodiment. Therefore, an explanation in this regard will not be provided again.

### 2nd Embodiment

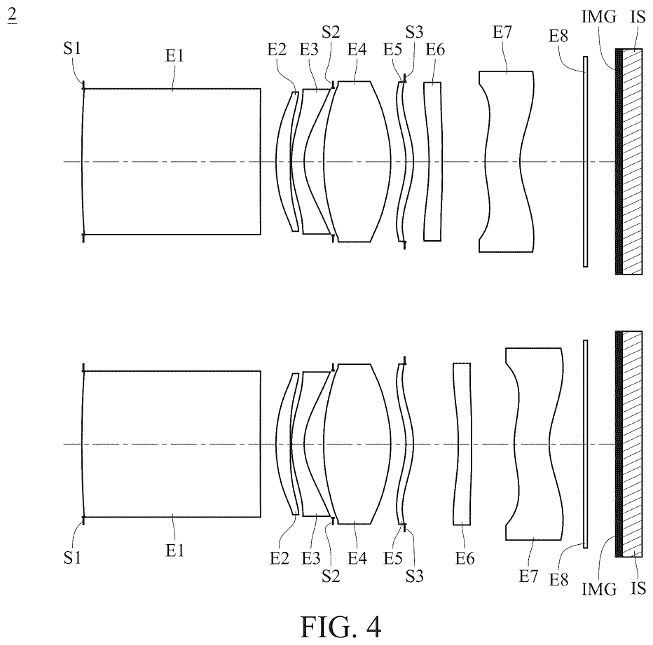

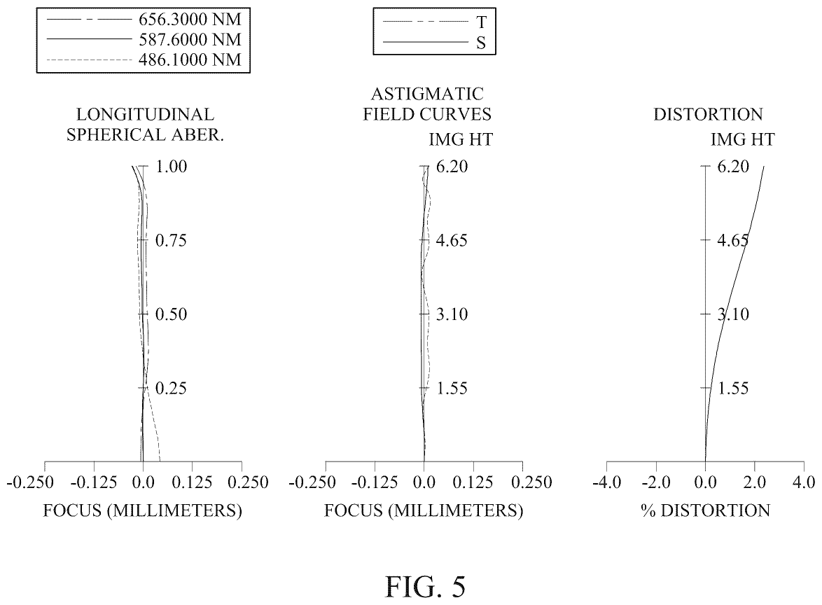

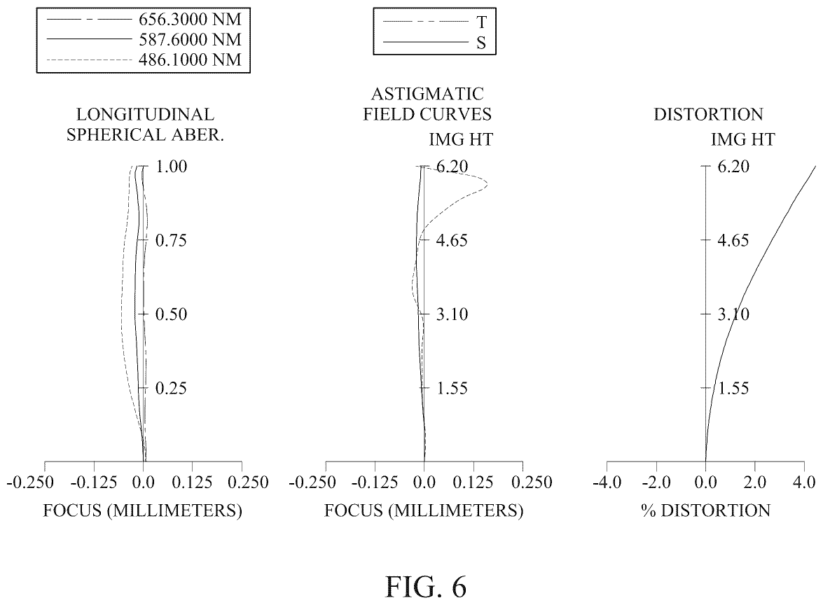

FIG. 4 is a schematic view of an image capturing unit at the first state (focusing on a long distance) and the second state (focusing on a short distance) according to the 2nd embodiment of the present disclosure. FIG. 5 shows, in order from left to right, spherical aberration curves, astigmatic field curves and a distortion curve of the image capturing unit at the first state according to the 2nd embodiment. FIG. 6 shows, in order from left to right, spherical aberration curves, astigmatic field curves and a distortion curve of the image capturing unit at the second state according to the 2nd embodiment. The upper part of FIG. 4 shows the optical imaging lens system at the first state, and the lower part of FIG. 4 shows the optical imaging lens system at the second state. In FIG. 4, the image capturing unit 2 includes the optical imaging lens system (its reference numeral is omitted) of the present disclosure and an image sensor IS. The optical imaging lens system includes, in order from an object side to an image side along an optical path, a stop S1, a first optical element E1, a second optical element E2, a third optical element E3, a stop S2, a fourth optical element E4, a fifth optical element E5, a stop S3, a sixth optical element E6, a seventh optical element E7, a filter E8 and an image surface IMG. The optical imaging lens system includes seven optical elements (E1, E2, E3, E4, E5, E6 and E7) with no additional optical element disposed between each of the adjacent seven optical elements, wherein the first optical element E1 is a reflective element and each of the second optical element E2 to seventh optical element E7 is a lens element.

When an imaged object moves from the long distance to the short distance, the optical imaging lens system performs a focus tuning process and changes from the first state to the second state. In this embodiment, the long object distance corresponding to the optical imaging lens system at the first state is ∞ (infinity), and the short object distance corresponding to the optical imaging lens system at the second state is 199.906 millimeters. During the focus tuning process, the optical imaging lens system adjusts its focal length by moving the sixth optical element E6 and the seventh optical element E7 along the optical axis relative to the second optical element E2, the third optical element E3, the fourth optical element E4 and the fifth optical element E5. Furthermore, through the focus tuning process, the optical imaging lens system can have the first state as shown in the upper part of FIG. 4 and the second state as shown in the lower part of FIG. 4.

The first optical element E1 with positive refractive power has an object-side surface being convex in a paraxial region thereof and an image-side surface being concave in a paraxial region thereof. The first optical element E1 is made of plastic material and has the object-side surface and the image-side surface being both spherical.

The second optical element E2 with positive refractive power has an object-side surface being convex in a paraxial region thereof and an image-side surface being concave in a paraxial region thereof. The second optical element E2 is made of plastic material and has the object-side surface and the image-side surface being both aspheric. The object-side surface of the second optical element E2 has one inflection point. The image-side surface of the second optical element E2 has one inflection point.

The third optical element E3 with negative refractive power has an object-side surface being convex in a paraxial region thereof and an image-side surface being concave in a paraxial region thereof. The third optical element E3 is made of plastic material and has the object-side surface and the image-side surface being both aspheric. The object-side surface of the third optical element E3 has one inflection point. The image-side surface of the third optical element E3 has one inflection point.

The fourth optical element E4 with positive refractive power has an object-side surface being convex in a paraxial region thereof and an image-side surface being convex in a paraxial region thereof. The fourth optical element E4 is made of plastic material and has the object-side surface and the image-side surface being both aspheric. The image-side surface of the fourth optical element E4 has one inflection point.

The fifth optical element E5 with positive refractive power has an object-side surface being concave in a paraxial region thereof and an image-side surface being convex in a paraxial region thereof. The fifth optical element E5 is made of plastic material and has the object-side surface and the image-side surface being both aspheric. The object-side surface of the fifth optical element E5 has two inflection points. The image-side surface of the fifth optical element E5 has two inflection points. The object-side surface of the fifth optical element E5 has one critical point in an off-axis region thereof. The image-side surface of the fifth optical element E5 has one critical point in an off-axis region thereof.

The sixth optical element E6 with negative refractive power has an object-side surface being concave in a paraxial region thereof and an image-side surface being concave in a paraxial region thereof. The sixth optical element E6 is made of plastic material and has the object-side surface and the image-side surface being both aspheric. The object-side surface of the sixth optical element E6 has one inflection point. The image-side surface of the sixth optical element E6 has two inflection points. The object-side surface of the sixth optical element E6 has one critical point in an off-axis region thereof. The image-side surface of the sixth optical element E6 has two critical points in an off-axis region thereof.

The seventh optical element E7 with negative refractive power has an object-side surface being convex in a paraxial region thereof and an image-side surface being concave in a paraxial region thereof. The seventh optical element E7 is made of plastic material and has the object-side surface and the image-side surface being both aspheric. The object-side surface of the seventh optical element E7 has one inflection point. The image-side surface of the seventh optical element E7 has one inflection point. The object-side surface of the seventh optical element E7 has one critical point in an off-axis region thereof. The image-side surface of the seventh optical element E7 has one critical point in an off-axis region thereof.

The filter E8 is made of glass material and located between the seventh optical element E7 and the image surface IMG, and will not affect the focal length of the optical imaging lens system. The image sensor IS is disposed on or near the image surface IMG.

In this embodiment, an axial distance between the stop S3 and the object-side surface of the sixth optical element E6 is defined as D1.

The detailed optical data of the 2nd embodiment are shown in Table 2A and Table 2B, and the aspheric surface data are shown in Table 2C below.

TABLE 2A
2nd Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Stop | Plano | | −0.094 | | | | |
| 2 | Optical element 1 | 60.0648 | (SPH) | 9.812 | Plastic | 1.544 | 56.0 | 121.10 |
| 3 | | 641.0256 | (SPH) | 0.862 | | | | |
| 4 | Optical element 2 | 8.0073 | (ASP) | 0.787 | Plastic | 1.511 | 56.8 | 16.61 |
| 5 | | 137.2777 | (ASP) | 0.071 | | | | |
| 6 | Optical element 3 | 6.6583 | (ASP) | 0.689 | Plastic | 1.587 | 28.3 | −12.67 |
| 7 | | 3.3786 | (ASP) | 1.586 | | | | |
| 8 | Stop | Plano | | −0.514 | | | | |
| 9 | Optical element 4 | 12.6925 | (ASP) | 3.689 | Plastic | 1.515 | 56.4 | 9.66 |
| 10 | | −7.3801 | (ASP) | 0.834 | | | | |
| 11 | Optical element 5 | −4.6302 | (ASP) | 0.412 | Plastic | 1.530 | 55.8 | 804.19 |
| 12 | | −4.7217 | (ASP) | −0.485 | | | | |
| 13 | Stop | Plano | | D1 | | | | |
| 14 | Optical element 6 | −22.5467 | (ASP) | 0.724 | Plastic | 1.587 | 28.3 | −24.91 |
| 15 | | 42.1227 | (ASP) | 2.353 | | | | |
| 16 | Optical element 7 | 5.5119 | (ASP) | 1.917 | Plastic | 1.515 | 56.4 | −45.68 |
| 17 | | 3.9379 | (ASP) | D2 | | | | |

| | | | | | | | |
|---|---|---|---|---|---|---|---|
| 18 | Filter | Plano | 0.210 | Glass | 1.517 | 64.2 | — |
| 19 | | Plano | 1.556 | | | | |
| 20 | Image | Plano | — | | | | |

Note:
Reference wavelength is 587.6 nm (d-line).
An effective radius of the stop S1 (Surface 1) is 4.011 mm.
An effective radius of the stop S2 (Surface 8) is 4.050 mm.
An effective radius of the stop S3 (Surface 13) is 4.406 mm.

TABLE 2B
Optical data for optical imaging lens system focusing
on the long distance and the short distance

| | Focusing on the | | Focusing on the |
|---|---|---|---|
| | long distance | | short distance |
| | (First state) | | (Second state) |
| fi [mm] | 16.69 | fm [mm] | 14.39 |
| Fnoi | 2.08 | Fnom | 1.92 |
| HFOVi [deg.] | 19.9 | HFOVm [deg.] | 21.1 |
| FOVi [deg.] | 39.8 | FOVm [deg.] | 42.2 |
| object | ∞ | object | 199.906 |
| distance [mm] | | distance [mm] | |
| D0 [mm] | ∞ | D0 [mm] | 200.000 |
| D1 [mm] | 1.343 | D1 [mm] | 2.952 |
| D2 [mm] | 3.500 | D2 [mm] | 1.891 |

Except for D1, in Table 2B, the optical data is the same as the data of the 1st embodiment. Besides the first state and the second state, the optical imaging lens system of this embodiment can further have other focal lengths corresponding to the intermediate range of the first state and the second state in other focus tuning conditions for different object distances.

TABLE 2C
Aspheric Coefficients

| Surface # | 4 | 5 | 6 | 7 |
|---|---|---|---|---|
| k= | −5.96844E−02 | −5.44275E+00 | 1.04027E+00 | −2.13322E+00 |
| A4= | −1.5685568E−03 | 9.1915894E−03 | 4.6306892E−03 | 1.0676232E−03 |
| A6= | 6.9522797E−04 | −1.9576877E−03 | −2.6110026E−03 | −7.0856631E−04 |
| A8= | −1.5067732E−04 | 3.4035695E−04 | 4.5612824E−04 | 6.3423999E−05 |
| A10= | 2.3673851E−05 | −3.8304084E−05 | −5.5509460E−05 | 2.5695034E−08 |
| A12= | −2.5218502E−06 | 2.8962967E−06 | 5.1870674E−06 | −4.5389688E−07 |
| A14= | 1.5989570E−07 | −1.8132195E−07 | −3.7782123E−07 | 3.8565560E−08 |
| A16= | −5.4183514E−09 | 9.6963426E−09 | 1.9259371E−08 | −1.3870029E−09 |
| A18= | 7.4744533E−11 | −3.3650783E−10 | −5.7446270E−10 | 1.8858457E−11 |
| A20= | — | 4.9910844E−12 | 7.2947915E−12 | — |

| Surface # | 9 | 10 | 11 | 12 |
|---|---|---|---|---|
| k= | 5.43537E+00 | 0.00000E+00 | 0.00000E+00 | −1.90077E+00 |
| A4= | 9.3029445E−04 | 1.8010076E−03 | 1.2966279E−02 | 3.4492317E+00 |
| A6= | −1.6427568E−04 | −3.9134429E−04 | −3.9360984E−03 | −2.5953373E+01 |
| A8= | 3.2793574E−05 | 1.4549594E−04 | 1.4291537E−03 | 1.7912721E+02 |
| A10= | −6.9153040E−06 | −2.5070527E−05 | −3.1274771E−04 | −7.5133927E+02 |
| A12= | 7.0257179E−07 | 2.1923442E−06 | 4.5629135E−05 | 2.1137724E+03 |
| A14= | −3.5642158E−08 | −1.0421774E−07 | −4.6777761E−06 | −4.1610844E+03 |
| A16= | 9.0050067E−10 | 2.5970783E−09 | 3.3802140E−07 | 5.7031422E+03 |
| A18= | −9.2156265E−12 | −2.6716543E−11 | −1.6731966E−08 | −5.2601478E+03 |
| A20= | — | — | 5.3672206E−10 | 3.0723624E+03 |
| A22= | — | — | −1.0022569E−11 | −1.0140059E+03 |
| A24= | — | — | 8.2704180E−14 | 1.4197682E+02 |

| Surface # | 14 | 15 | 16 | 17 |
|---|---|---|---|---|
| k= | −7.83741E+01 | 8.49365E+01 | 9.81527E−02 | −8.31222E−01 |
| A4= | −7.9528202E−03 | −1.1508476E−02 | −1.1893510E−02 | −8.6151630E+00 |
| A6= | 2.6309200E−03 | 3.4392970E−03 | 7.3226325E−04 | 1.8667833E+01 |
| A8= | −5.4379552E−04 | −7.4504207E−04 | −5.4161695E−05 | −4.0907107E+01 |
| A10= | 8.1676166E−05 | 1.2274080E−04 | 4.8504263E−06 | 5.7577608E+01 |
| A12= | −8.5910056E−06 | −1.4888147E−05 | −1.7424150E−06 | 9.3161735E+00 |
| A14= | 5.7102578E−07 | 1.2779078E−06 | 5.3252986E−07 | −2.6872925E+02 |
| A16= | −1.5736633E−08 | −7.3647489E−08 | −9.6463080E−08 | 6.6843327E+02 |
| A18= | −9.0117450E−10 | 2.5412785E−09 | 1.1054810E−08 | −8.9068703E+02 |
| A20= | 1.1357187E−10 | −3.1978964E−11 | −8.3256152E−10 | 6.9942905E+02 |
| A22= | −5.2219243E−12 | −1.0500832E−12 | 4.1263569E−11 | −3.0465036E+02 |
| A24= | 1.1955858E−13 | 4.6706375E−14 | −1.2985424E−12 | 5.6915946E+01 |
| A26= | −1.1262042E−15 | −5.4152331E−16 | 2.3548803E−14 | — |
| A28= | — | — | −1.8748204E−16 | — |

In the 2nd embodiment, the equation of the aspheric surface profiles of the aforementioned optical elements is the same as the equation of the 1st embodiment. Also, the definitions of these parameters shown in Table 2D are the same as those stated in the 1st embodiment with corresponding values for the 2nd embodiment, so an explanation in this regard will not be provided again.

TABLE 2D
Schematic Parameters

| | | | |
|---|---|---|---|
| TL/ImgH | 4.73 | (TL − CT1)/CT1 | 1.99 |
| TD/ImgH | 3.88 | CT2/T12 | 0.91 |
| f/f2 | 1.00 | CT2/CT3 | 1.14 |
| f/f4 | 1.73 | T34/CT4 | 0.29 |
| f/f234 | 1.42 | (CT2 + CT3 + CT4 + | 0.84 |
| | | CT5 + CT6 + CT7)/CT1 | |
| \|TLi − TLm\|/TLi | 0.00 | V2/V1 | 1.01 |
| R5/R3 | 0.83 | V6/V7 | 0.50 |
| \|R9/R3\| | 0.58 | CT2/SAG2R1 | 0.84 |
| (R7 + R8)/(R7 − R8) | 0.26 | SAG6R1/SAG3R2 | −0.19 |
| \|R13/R14\| | 1.40 | Y1R1/ImgH | 0.65 |
| R14/f | 0.24 | Yc71/Y7R1 | 0.60 |

### 3rd Embodiment

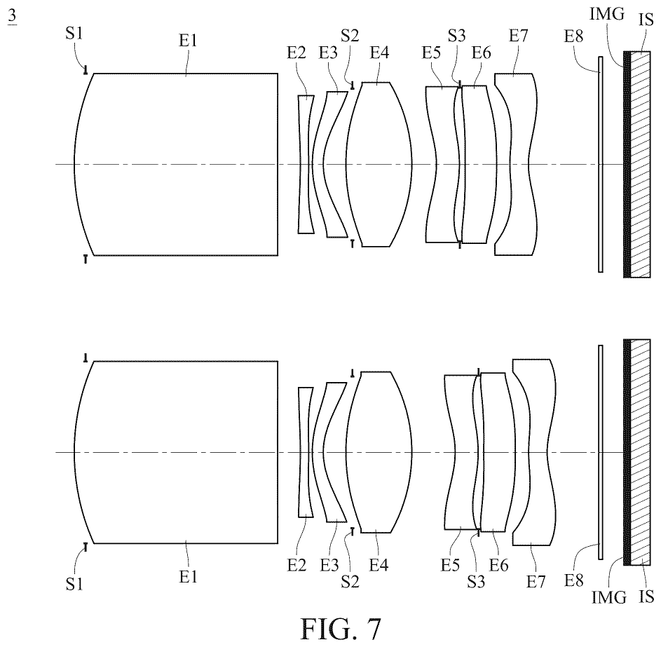

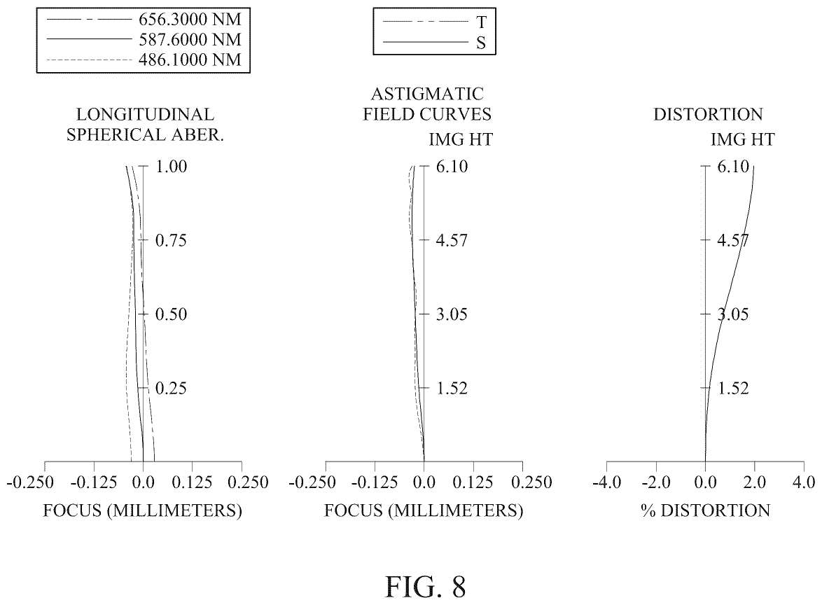

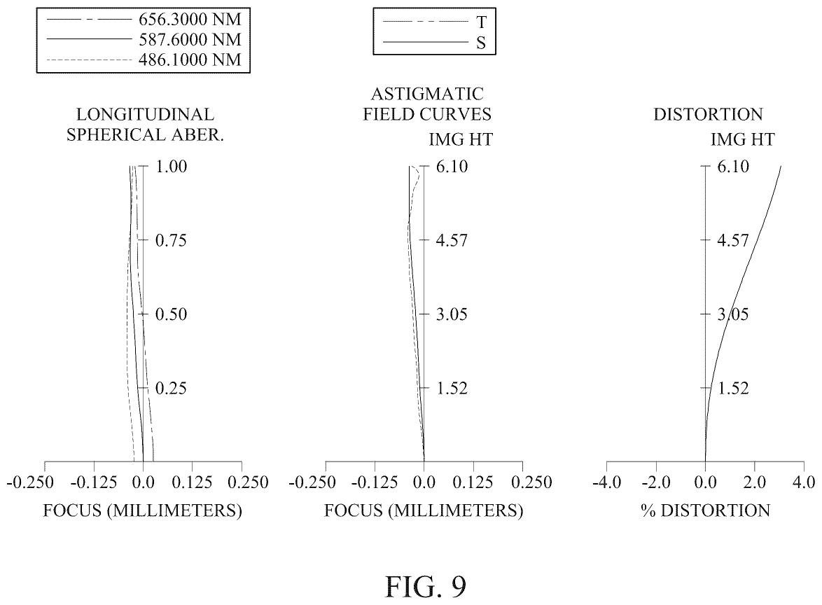

FIG. 7 is a schematic view of an image capturing unit at the first state (focusing on a long distance) and the second state (focusing on a short distance) according to the 3rd embodiment of the present disclosure. FIG. 8 shows, in order from left to right, spherical aberration curves, astigmatic field curves and a distortion curve of the image capturing unit at the first state according to the 3rd embodiment. FIG. 9 shows, in order from left to right, spherical aberration curves, astigmatic field curves and a distortion curve of the image capturing unit at the second state according to the 3rd embodiment. The upper part of FIG. 7 shows the optical imaging lens system at the first state, and the lower part of FIG. 7 shows the optical imaging lens system at the second state. In FIG. 7, the image capturing unit 3 includes the optical imaging lens system (its reference numeral is omitted) of the present disclosure and an image sensor IS. The optical imaging lens system includes, in order from an object side to an image side along an optical path, a stop S1, a first optical element E1, a second optical element E2, a third optical element E3, a stop S2, a fourth optical element E4, a fifth optical element E5, a stop S3, a sixth optical element E6, a seventh optical element E7, a filter E8 and an image surface IMG. The optical imaging lens system includes seven optical elements (E1, E2, E3, E4, E5, E6 and E7) with no additional optical element disposed between each of the adjacent seven optical elements, wherein the first optical element E1 is a reflective element and each of the second optical element E2 to seventh optical element E7 is a lens element.

When an imaged object moves from the long distance to the short distance, the optical imaging lens system performs a focus tuning process and changes from the first state to the second state. In this embodiment, the long object distance corresponding to the optical imaging lens system at the first state is ∞ (infinity), and the short object distance corresponding to the optical imaging lens system at the second state is 499.388 millimeters. During the focus tuning process, the optical imaging lens system adjusts its focal length by moving the fifth optical element E5, the sixth optical element E6, and the seventh optical element E7 along the optical axis relative to the second optical element E2, the third optical element E3, and the fourth optical element E4. Furthermore, through the focus tuning process, the optical imaging lens system can have the first state as shown in the upper part of FIG. 7 and the second state as shown in the lower part of FIG. 7.

The first optical element E1 with positive refractive power has an object-side surface being convex in a paraxial region thereof and an image-side surface being concave in a paraxial region thereof. The first optical element E1 is made of glass material and has the object-side surface and the image-side surface being both spherical.

The second optical element E2 with negative refractive power has an object-side surface being concave in a paraxial region thereof and an image-side surface being convex in a paraxial region thereof. The second optical element E2 is made of plastic material and has the object-side surface and the image-side surface being both aspheric. The object-side surface of the second optical element E2 has two inflection points. The image-side surface of the second optical element E2 has two inflection points. The image-side surface of the second optical element E2 has one critical point in an off-axis region thereof.

The third optical element E3 with negative refractive power has an object-side surface being convex in a paraxial region thereof and an image-side surface being concave in a paraxial region thereof. The third optical element E3 is made of plastic material and has the object-side surface and the image-side surface being both aspheric. The object-side surface of the third optical element E3 has one inflection point. The image-side surface of the third optical element E3 has one inflection point.

The fourth optical element E4 with positive refractive power has an object-side surface being convex in a paraxial region thereof and an image-side surface being convex in a paraxial region thereof. The fourth optical element E4 is made of glass material and has the object-side surface and the image-side surface being both aspheric.

The fifth optical element E5 with negative refractive power has an object-side surface being concave in a paraxial region thereof and an image-side surface being convex in a paraxial region thereof. The fifth optical element E5 is made of plastic material and has the object-side surface and the image-side surface being both aspheric. The object-side surface of the fifth optical element E5 has one inflection point. The image-side surface of the fifth optical element E5 has one inflection point. The object-side surface of the fifth optical element E5 has one critical point in an off-axis region thereof. The image-side surface of the fifth optical element E5 has one critical point in an off-axis region thereof.

The sixth optical element E6 with positive refractive power has an object-side surface being convex in a paraxial region thereof and an image-side surface being convex in a paraxial region thereof. The sixth optical element E6 is made of plastic material and has the object-side surface and the image-side surface being both aspheric. The object-side surface of the sixth optical element E6 has two inflection points. The image-side surface of the sixth optical element E6 has one inflection point. The object-side surface of the sixth optical element E6 has two critical points in an off-axis region thereof.

The seventh optical element E7 with negative refractive power has an object-side surface being convex in a paraxial region thereof and an image-side surface being concave in a paraxial region thereof. The seventh optical element E7 is made of plastic material and has the object-side surface and the image-side surface being both aspheric. The object-side surface of the seventh optical element E7 has two inflection points. The image-side surface of the seventh optical element E7 has one inflection point. The object-side surface of the seventh optical element E7 has one critical point in an off-axis region thereof. The image-side surface of the seventh optical element E7 has one critical point in an off-axis region thereof.

The filter E8 is made of glass material and located between the seventh optical element E7 and the image surface IMG, and will not affect the focal length of the optical imaging lens system. The image sensor IS is disposed on or near the image surface IMG.

In this embodiment, an axial distance between the image-side surface of the fourth optical element E4 and the object-side surface of the fifth optical element E5 is defined as D1.

The detailed optical data of the 3rd embodiment are shown in Table 3A and Table 3B, and the aspheric surface data are shown in Table 3C below.

TABLE 3A
3rd Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Stop | Plano | | −0.612 | | | | |
| 2 | Optical element 1 | 11.9197 | (SPH) | 10.997 | Glass | 1.526 | 60.2 | 22.91 |
| 3 | | 689.6552 | (SPH) | 1.230 | | | | |
| 4 | Optical element 2 | −27.6156 | (ASP) | 0.451 | Plastic | 1.582 | 30.2 | −321.82 |
| 5 | | −32.5818 | (ASP) | 0.198 | | | | |
| 6 | Optical element 3 | 5.7969 | (ASP) | 0.592 | Plastic | 1.661 | 20.3 | −16.41 |
| 7 | | 3.6233 | (ASP) | 1.575 | | | | |
| 8 | Stop | Plano | | −0.349 | | | | |
| 9 | Optical element 4 | 11.0476 | (ASP) | 3.562 | Glass | 1.534 | 55.5 | 9.73 |
| 10 | | −8.6964 | (ASP) | D1 | | | | |
| 11 | Optical element 5 | −4.7770 | (ASP) | 1.242 | Plastic | 1.511 | 56.8 | −29.82 |
| 12 | | −7.5705 | (ASP) | 0.022 | | | | |
| 13 | Stop | Plano | | 0.285 | | | | |
| 14 | Optical element 6 | 58.3361 | (ASP) | 1.703 | Plastic | 1.705 | 14.0 | 41.80 |
| 15 | | −58.7859 | (ASP) | 0.721 | | | | |
| 16 | Optical element 7 | 7.5526 | (ASP) | 1.003 | Plastic | 1.566 | 37.4 | −18.01 |
| 17 | | 4.1298 | (ASP) | D2 | | | | |

| | | | | | | | |
|---|---|---|---|---|---|---|---|
| 18 | Filter | Plano | 0.210 | Glass | 1.517 | 64.2 | — |
| 19 | | Plano | 1.149 | | | | |
| 20 | Image | Plano | — | | | | |

Note:
Reference wavelength is 587.6 nm (d-line).
An effective radius of the stop S1 (Surface 1) is 4.918 mm.
An effective radius of the stop S2 (Surface 8) is 4.100 mm.
An effective radius of the stop S3 (Surface 13) is 4.150 mm.

TABLE 3B
Optical data for optical imaging lens system focusing
on the long distance and the short distance

| | Focusing on the | | Focusing on the |
|---|---|---|---|
| | long distance | | short distance |
| | (First state) | | (Second state) |
| fi [mm] | 22.42 | fm [mm] | 20.36 |
| Fnoi | 2.28 | Fnom | 2.19 |
| HFOVi [deg.] | 15.0 | HFOVm [deg.] | 15.4 |
| FOVi [deg.] | 30.0 | FOVm [deg.] | 30.8 |
| object | ∞ | object | 499.388 |
| distance [mm] | | distance [mm] | |
| D0 [mm] | ∞ | D0 [mm] | 500.000 |
| D1 [mm] | 1.330 | D1 [mm] | 2.343 |
| D2 [mm] | 3.800 | D2 [mm] | 2.787 |

Except for D1, in Table 3B, the optical data is the same as the data of the 1 st embodiment. Besides the first state and the second state, the optical imaging lens system of this embodiment can further have other focal lengths corresponding to the intermediate range of the first state and the second state in other focus tuning conditions for different object distances.

TABLE 3C
Aspheric Coefficients

| Surface # | 4 | 5 | 6 | 7 |
|---|---|---|---|---|
| k= | −5.06137E+01 | −7.63558E+01 | 7.43507E−01 | −2.09128E+00 |
| A4= | −1.0464788E−04 | 4.9278443E−03 | −1.4715209E−03 | −1.4674690E−03 |
| A6= | 4.8857821E−04 | −3.0044132E−04 | −4.9040355E−04 | 1.4305045E−04 |
| A8= | −1.2972151E−04 | −2.1981827E−05 | 3.4773842E−05 | −7.2762689E−05 |
| A10= | 2.2193036E−05 | 1.2625979E−05 | 2.4304060E−06 | 1.5177035E−05 |
| A12= | −2.4618988E−06 | −1.6850283E−06 | −5.7429251E−07 | −1.6638643E−06 |
| A14= | 1.6195366E−07 | 8.4696291E−08 | 3.2856674E−08 | 1.0037046E−07 |
| A16= | −5.7083424E−09 | 2.4332303E−10 | −6.1469918E−10 | −3.1675533E−09 |
| A18= | 8.2829236E−11 | −1.6381058E−10 | −6.0647130E−13 | 4.0914505E−11 |
| A20= | — | 4.0370475E−12 | −1.0729887E−13 | — |

| Surface # | 9 | 10 | 11 | 12 |
|---|---|---|---|---|
| k= | 4.24151E+00 | 0.00000E+00 | 0.00000E+00 | −2.56874E+00 |
| A4= | 2.6127596E−04 | 1.2643019E−04 | 8.8440958E−03 | −2.5042728E−03 |
| A6= | −7.8025584E−05 | −3.3668530E−05 | −1.8279433E−04 | 2.7617971E−03 |
| A8= | 8.5651007E−06 | 5.8853579E−06 | −5.0772314E−05 | −6.0513657E−04 |
| A10= | −1.5451866E−06 | −6.2662957E−07 | 1.4130494E−05 | 8.1469313E−05 |
| A12= | 1.6554308E−07 | 4.0797584E−08 | −2.0216014E−06 | −7.4046768E−06 |
| A14= | −1.0422165E−08 | −1.5719722E−09 | 1.8982331E−07 | 4.6796412E−07 |
| A16= | 3.5075464E−10 | 3.1943498E−11 | −1.1914511E−08 | −2.0358202E−08 |
| A18= | −4.9100498E−12 | −2.3173583E−13 | 4.8128489E−10 | 5.7432989E−10 |
| A20= | — | — | −1.1279534E−11 | −9.1499088E−12 |
| A22= | — | — | 1.1659453E−13 | 5.8601297E−14 |

| Surface # | 14 | 15 | 16 | 17 |
|---|---|---|---|---|
| k= | 5.63232E+01 | 8.43427E+01 | 6.30970E−01 | −8.97658E−01 |
| A4= | −8.5403457E−03 | −6.2795283E−03 | −1.8092142E−02 | −1.6786763E−02 |
| A6= | 1.7130444E−03 | 2.8969662E−04 | 1.2989087E−03 | 1.7248093E−03 |
| A8= | −1.3306921E−04 | 2.3279171E−04 | 8.0191450E−05 | −7.8245585E−05 |
| A10= | −1.9892970E−05 | −6.7690887E−05 | −1.2112165E−05 | −1.2756591E−05 |
| A12= | 6.4239634E−06 | 8.8690522E−06 | −6.8838420E−06 | 2.9131421E−06 |
| A14= | −7.9477386E−07 | −6.0416335E−07 | 2.2040242E−06 | −2.8886173E−07 |
| A16= | 5.7667830E−08 | 1.3073763E−08 | −3.1991806E−07 | 1.7343329E−08 |
| A18= | −2.6238672E−09 | 1.2442415E−09 | 2.8582805E−08 | −6.6624543E−10 |
| A20= | 7.3021217E−11 | −1.2374650E−10 | −1.6991179E−09 | 1.6063687E−11 |
| A22= | −1.1117176E−12 | 5.0838518E−12 | 6.8083139E−11 | −2.2208824E−13 |
| A24= | 6.7444452E−15 | −1.0726720E−13 | −1.7817619E−12 | 1.3459319E−15 |
| A26= | — | 9.5903145E−16 | 2.7667526E−14 | — |
| A28= | — | — | −1.9392412E−16 | — |

In the 3rd embodiment, the equation of the aspheric surface profiles of the aforementioned optical elements is the same as the equation of the 1st embodiment. Also, the definitions of these parameters shown in Table 3D are the same as those stated in the 1st embodiment with corresponding values for the 3rd embodiment, so an explanation in this regard will not be provided again.

TABLE 3D
Schematic Parameters

| | | | |
|---|---|---|---|
| TL/ImgH | 4.87 | (TL − CT1)/CT1 | 1.70 |
| TD/ImgH | 4.03 | CT2/T12 | 0.37 |
| f/f2 | −0.07 | CT2/CT3 | 0.76 |
| f/f4 | 2.30 | T34/CT4 | 0.34 |
| f/f234 | 1.17 | (CT2 + CT3 + CT4 + | 0.78 |
| | | CT5 + CT6 + CT7)/CT1 | |
| \|TLi − TLm\|/TLi | 0.00 | V2/V1 | 0.50 |
| R5/R3 | −0.21 | V6/V7 | 0.37 |
| \|R9/R3\| | 0.17 | CT2/SAG2R1 | −3.07 |
| (R7 + R8)/(R7 − R8) | 0.12 | SAG6R1/SAG3R2 | −0.12 |
| \|R13/R14\| | 1.83 | Y1R1/ImgH | 0.81 |
| R14/f | 0.18 | Yc71/Y7R1 | 0.39 |

### 4th Embodiment

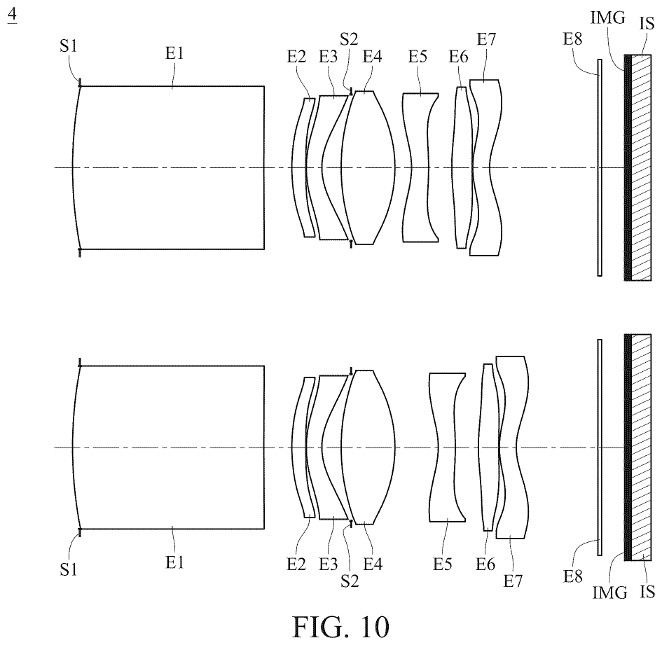

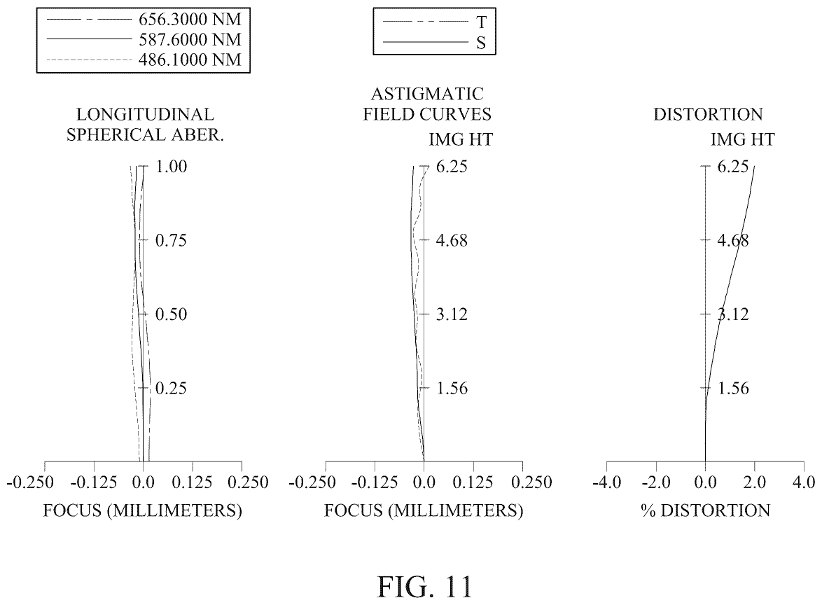

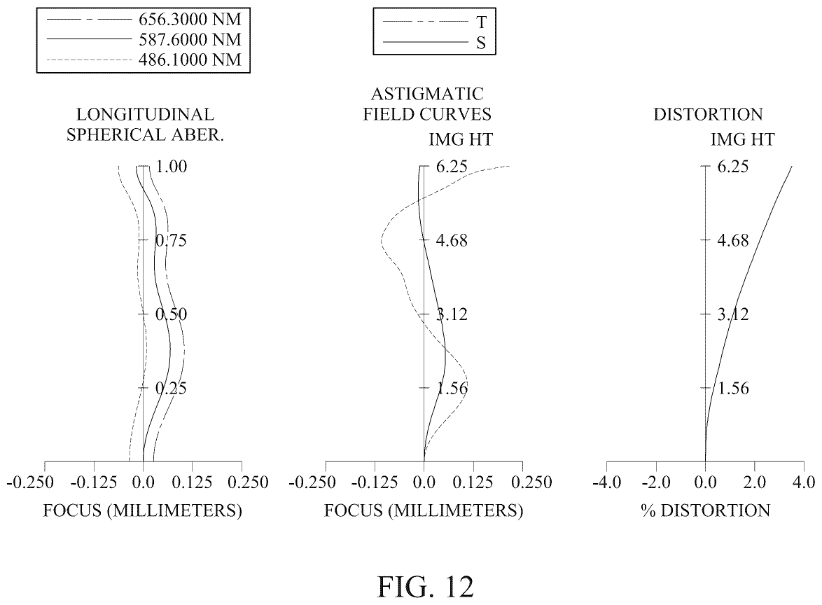

FIG. 10 is a schematic view of an image capturing unit at the first state (focusing on a long distance) and the second state (focusing on a short distance) according to the 4th embodiment of the present disclosure. FIG. 11 shows, in order from left to right, spherical aberration curves, astigmatic field curves and a distortion curve of the image capturing unit at the first state according to the 4th embodiment. FIG. 12 shows, in order from left to right, spherical aberration curves, astigmatic field curves and a distortion curve of the image capturing unit at the second state according to the 4th embodiment. The upper part of FIG. 10 shows the optical imaging lens system at the first state, and the lower part of FIG. 10 shows the optical imaging lens system at the second state. In FIG. 10, the image capturing unit 4 includes the optical imaging lens system (its reference numeral is omitted) of the present disclosure and an image sensor IS. The optical imaging lens system includes, in order from an object side to an image side along an optical path, a stop S1, a first optical element E1, a second optical element E2, a third optical element E3, a stop S2, a fourth optical element E4, a fifth optical element E5, a sixth optical element E6, a seventh optical element E7, a filter E8 and an image surface IMG. The optical imaging lens system includes seven optical elements (E1, E2, E3, E4, E5, E6 and E7) with no additional optical element disposed between each of the adjacent seven optical elements, wherein the first optical element E1 is a reflective element and each of the second optical element E2 to seventh optical element E7 is a lens element.

When an imaged object moves from the long distance to the short distance, the optical imaging lens system performs a focus tuning process and changes from the first state to the second state. In this embodiment, the long object distance corresponding to the optical imaging lens system at the first state is ∞ (infinity), and the short object distance corresponding to the optical imaging lens system at the second state is 149.595 millimeters. During the focus tuning process, the optical imaging lens system adjusts its focal length by moving the fifth optical element E5, the sixth optical element E6, and the seventh optical element E7 along the optical axis relative to the second optical element E2, the third optical element E3, and the fourth optical element E4. Furthermore, through the focus tuning process, the optical imaging lens system can have the first state as shown in the upper part of FIG. 10 and the second state as shown in the lower part of FIG. 10.

The first optical element E1 with positive refractive power has an object-side surface being convex in a paraxial region thereof and an image-side surface being concave in a paraxial region thereof. The first optical element E1 is made of glass material and has the object-side surface and the image-side surface being both spherical.

The second optical element E2 with positive refractive power has an object-side surface being convex in a paraxial region thereof and an image-side surface being concave in a paraxial region thereof. The second optical element E2 is made of plastic material and has the object-side surface and the image-side surface being both aspheric. The object-side surface of the second optical element E2 has one inflection point. The image-side surface of the second optical element E2 has one inflection point.

The third optical element E3 with negative refractive power has an object-side surface being convex in a paraxial region thereof and an image-side surface being concave in a paraxial region thereof. The third optical element E3 is made of plastic material and has the object-side surface and the image-side surface being both aspheric. The object-side surface of the third optical element E3 has one inflection point. The image-side surface of the third optical element E3 has one inflection point.

The fourth optical element E4 with positive refractive power has an object-side surface being convex in a paraxial region thereof and an image-side surface being convex in a paraxial region thereof. The fourth optical element E4 is made of plastic material and has the object-side surface and the image-side surface being both aspheric. The image-side surface of the fourth optical element E4 has one inflection point.

The fifth optical element E5 with negative refractive power has an object-side surface being concave in a paraxial region thereof and an image-side surface being convex in a paraxial region thereof. The fifth optical element E5 is made of plastic material and has the object-side surface and the image-side surface being both aspheric. The object-side surface of the fifth optical element E5 has one inflection point. The image-side surface of the fifth optical element E5 has one inflection point. The object-side surface of the fifth optical element E5 has one critical point in an off-axis region thereof. The image-side surface of the fifth optical element E5 has one critical point in an off-axis region thereof.

The sixth optical element E6 with positive refractive power has an object-side surface being convex in a paraxial region thereof and an image-side surface being concave in a paraxial region thereof. The sixth optical element E6 is made of plastic material and has the object-side surface and the image-side surface being both aspheric. The object-side surface of the sixth optical element E6 has three inflection points. The image-side surface of the sixth optical element E6 has three inflection points. The image-side surface of the sixth optical element E6 has one critical point in an off-axis region thereof.

The seventh optical element E7 with negative refractive power has an object-side surface being convex in a paraxial region thereof and an image-side surface being concave in a paraxial region thereof. The seventh optical element E7 is made of plastic material and has the object-side surface and the image-side surface being both aspheric. The object-side surface of the seventh optical element E7 has two inflection points. The image-side surface of the seventh optical element E7 has two inflection points. The object-side surface of the seventh optical element E7 has one critical point in an off-axis region thereof. The image-side surface of the seventh optical element E7 has one critical point in an off-axis region thereof.

The filter E8 is made of glass material and located between the seventh optical element E7 and the image surface IMG, and will not affect the focal length of the optical imaging lens system. The image sensor IS is disposed on or near the image surface IMG.

In this embodiment, an axial distance between the image-side surface of the fourth optical element E4 and the object-side surface of the fifth optical element E5 is defined as D1.

The detailed optical data of the 4th embodiment are shown in Table 4A and Table 4B, and the aspheric surface data are shown in Table 4C below.

TABLE 4A
4th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Stop | Plano | | −0.405 | | | | |
| 2 | Optical element 1 | 23.4039 | (SPH) | 10.612 | Glass | 1.516 | 64.0 | 46.24 |
| 3 | | 1057.9841 | (SPH) | 1.550 | | | | |
| 4 | Optical element 2 | 9.9928 | (ASP) | 0.772 | Plastic | 1.545 | 56.1 | 20.38 |
| 5 | | 97.0463 | (ASP) | 0.030 | | | | |
| 6 | Optical element 3 | 6.5175 | (ASP) | 0.859 | Plastic | 1.587 | 28.3 | −13.23 |
| 7 | | 3.3713 | (ASP) | 1.617 | | | | |
| 8 | Stop | Plano | | −0.544 | | | | |
| 9 | Optical element 4 | 12.7412 | (ASP) | 2.980 | Plastic | 1.545 | 56.1 | 8.93 |
| 10 | | −7.2264 | (ASP) | D1 | | | | |
| 11 | Optical element 5 | −4.5150 | (ASP) | 0.947 | Plastic | 1.587 | 28.3 | −11.03 |
| 12 | | −16.0659 | (ASP) | 1.282 | | | | |
| 13 | Optical element 6 | 9.8236 | (ASP) | 1.130 | Plastic | 1.661 | 20.4 | 17.82 |
| 14 | | 56.5588 | (ASP) | 0.035 | | | | |
| 15 | Optical element 7 | 4.9317 | (ASP) | 0.933 | Plastic | 1.545 | 56.1 | −25.65 |
| 16 | | 3.4023 | (ASP) | D2 | | | | |

| | | | | | | | |
|---|---|---|---|---|---|---|---|
| 17 | Filter | Plano | 0.210 | Glass | 1.517 | 64.2 | — |
| 18 | | Plano | 1.280 | | | | |
| 19 | Image | Plano | — | | | | |

Note:
Reference wavelength is 587.6 nm (d-line).
An effective radius of the stop S1 (Surface 1) is 4.519 mm.
An effective radius of the stop S2 (Surface 8) is 4.060 mm.

TABLE 4B
Optical data for optical imaging lens system focusing
on the long distance and the short distance

| | Focusing on the long | | Focusing on the short |
|---|---|---|---|
| | distance (First state) | | distance (Second state) |
| fi [mm] | 19.72 | fm [mm] | 16.67 |
| Fnoi | 2.18 | Fnom | 2.04 |
| HFOVi [deg.] | 17.3 | HFOVm [deg.] | 18.1 |
| FOVi [deg.] | 34.6 | FOVm [deg.] | 36.2 |
| object distance [mm] | ∞ | object distance [mm] | 149.595 |
| D0 [mm] | ∞ | D0 [mm] | 150.000 |
| D1 [mm] | 0.920 | D1 [mm] | 2.399 |
| D2 [mm] | 6.000 | D2 [mm] | 4.521 |

Except for D1, in Table 4B, the optical data is the same as the data of the 1st embodiment. Besides the first state and the second state, the optical imaging lens system of this embodiment can further have other focal lengths corresponding to the intermediate range of the first state and the second state in other focus tuning conditions for different object distances.

TABLE 4C
Aspheric Coefficients

| Surface # | 4 | 5 | 6 | 7 |
|---|---|---|---|---|
| k = | −2.70326E−01 | −9.43741E−01 | 1.05891E+00 | −2.01253E+00 |
| A4 = | −1.1281094E−03 | 7.7875165E−03 | 3.2855197E−03 | 4.7745618E−04 |
| A6 = | 5.9411502E−04 | −1.2591622E−03 | −1.6807869E−03 | −3.0350838E−04 |
| A8 = | −1.1890109E−04 | 1.9322608E−04 | 2.3513470E−04 | −2.7388104E−05 |
| A10 = | 1.5143146E−05 | −2.7105451E−05 | −2.7662819E−05 | 1.0954720E−05 |
| A12 = | −1.1985676E−06 | 3.5769437E−06 | 3.0874144E−06 | −1.2891970E−06 |
| A14 = | 5.1353707E−08 | −3.5222237E−07 | −2.6961863E−07 | 7.9023754E−08 |
| A16 = | −1.0627321E−09 | 2.0864621E−08 | 1.4889269E−08 | −2.5024042E−09 |
| A18 = | 7.4976688E−12 | −6.5254439E−10 | −4.4608843E−10 | 3.1931665E−11 |
| A20 = | — | 8.2909316E−12 | 5.4599214E−12 | — |
| Surface # | 9 | 10 | 11 | 12 |
| k = | 5.74156E+00 | 0.00000E+00 | 0.00000E+00 | −1.44674E+01 |
| A4 = | 1.2186499E−03 | 1.2687671E−03 | 1.0631179E−02 | −2.8409425E−04 |
| A6 = | −2.4744994E−04 | −3.1902631E−04 | 7.0560472E−05 | 2.2859980E−03 |
| A8 = | 3.0049321E−05 | 5.3489021E−05 | −2.2712660E−04 | −6.4793349E−04 |
| A10 = | −3.3054733E−06 | −5.3513753E−06 | 6.0894574E−05 | 1.1610252E−04 |
| A12 = | 1.9043308E−07 | 2.9821550E−07 | −9.3584302E−06 | −1.3575499E−05 |
| A14 = | −3.6846742E−09 | −7.3526064E−09 | 9.2372937E−07 | 1.0158368E−06 |
| A16 = | −5.5238916E−11 | −1.2184416E−11 | −5.9131499E−08 | −4.5650888E−08 |
| A18 = | 2.1079950E−12 | 3.0575004E−12 | 2.3805693E−09 | 1.0353520E−09 |
| A20 = | — | — | −5.4959766E−11 | −4.0848083E−12 |
| A22 = | — | — | 5.5821042E−13 | −1.7483125E−13 |
| Surface # | 13 | 14 | 15 | 16 |
| k = | −6.74378E−01 | −6.07173E−02 | −6.65399E−02 | −1.00000E+00 |
| A4 = | −1.0111323E−02 | 9.8053344E−04 | −1.4745315E−03 | −1.1228521E−02 |
| A6 = | 2.9303675E−03 | −2.0651277E−03 | −5.3824582E−03 | −4.2950256E−04 |
| A8 = | −7.3652857E−04 | 7.1755352E−04 | 1.7313377E−03 | 2.6267320E−04 |
| A10 = | 1.1944674E−04 | −1.8501167E−04 | −3.7377555E−04 | −3.9993215E−05 |
| A12 = | −1.1832493E−05 | 3.5803552E−05 | 6.1272499E−05 | 3.4606882E−06 |
| A14 = | 6.5030953E−07 | −4.8891530E−06 | −7.4972476E−06 | −1.8747030E−07 |
| A16 = | −1.0711448E−08 | 4.5763825E−07 | 6.5841403E−07 | 6.3541332E−09 |
| A18 = | −9.1810506E−10 | −2.9009987E−08 | −4.0226276E−08 | −1.2439016E−10 |
| A20 = | 6.4568871E−11 | 1.2228588E−09 | 1.6555539E−09 | 1.0018653E−12 |
| A22 = | −1.6839063E−12 | −3.2824543E−11 | −4.3553556E−11 | 6.3236273E−15 |
| A24 = | 1.6680345E−14 | 5.0772983E−13 | 6.5725710E−13 | −1.3241579E−16 |
| A26 = | — | −3.4445102E−15 | −4.2256560E−15 | — |
| A28 = | — | — | −2.2822797E−18 | — |

In the 4th embodiment, the equation of the aspheric surface profiles of the aforementioned optical elements is the same as the equation of the 1st embodiment. Also, the definitions of these parameters shown in Table 4D are the same as those stated in the 1 st embodiment with corresponding values for the 4th embodiment, so an explanation in this regard will not be provided again.

TABLE 4D
Schematic Parameters

| | | | |
|---|---|---|---|
| TL/ImgH | 4.90 | (TL − CT1)/CT1 | 1.88 |
| TD/ImgH | 3.70 | CT2/T12 | 0.50 |
| f/f2 | 0.97 | CT2/CT3 | 0.90 |
| f/f4 | 2.21 | T34/CT4 | 0.36 |
| f/f234 | 1.70 | (CT2 + CT3 + CT4 + | 0.72 |
| | | CT5 + CT6 + CT7)/CT1 | |
| \|TLi − TLm\|/TLi | 0.00 | V2/V1 | 0.88 |
| R5/R3 | 0.65 | V6/V7 | 0.36 |
| \|R9/R3\| | 0.45 | CT2/SAG2R1 | 1.14 |
| (R7 + R8)/(R7 − R8) | 0.28 | SAG6R1/SAG3R2 | 0.20 |
| IR13/R14\| | 1.45 | Y1R1/ImgH | 0.72 |
| R14/f | 0.17 | Yc71/Y7R1 | 0.58 |

### 5th Embodiment

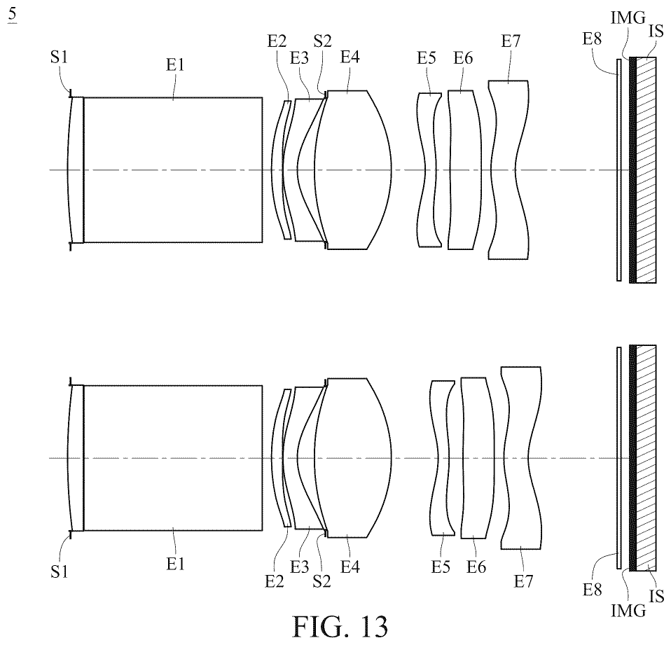

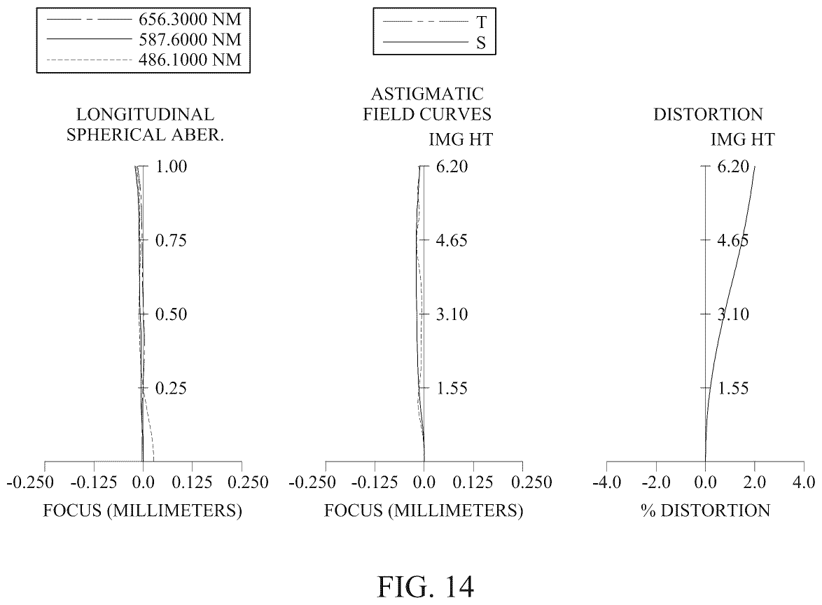

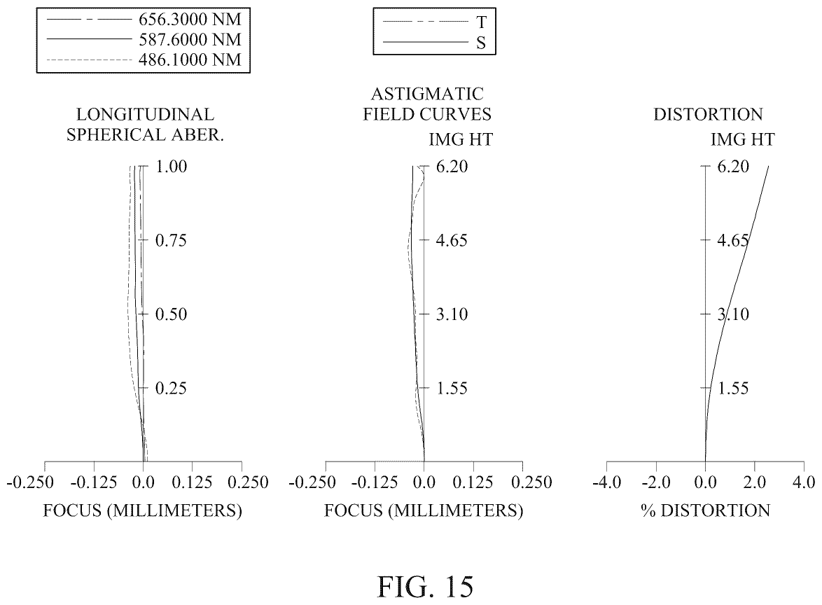

FIG. 13 is a schematic view of an image capturing unit at the first state (focusing on a long distance) and the second state (focusing on a short distance) according to the 5th embodiment of the present disclosure. FIG. 14 shows, in order from left to right, spherical aberration curves, astigmatic field curves and a distortion curve of the image capturing unit at the first state according to the 5th embodiment. FIG. 15 shows, in order from left to right, spherical aberration curves, astigmatic field curves and a distortion curve of the image capturing unit at the second state according to the 5th embodiment. The upper part of FIG. 13 shows the optical imaging lens system at the first state, and the lower part of FIG. 13 shows the optical imaging lens system at the second state. In FIG. 13, the image capturing unit 5 includes the optical imaging lens system (its reference numeral is omitted) of the present disclosure and an image sensor IS. The optical imaging lens system includes, in order from an object side to an image side along an optical path, a stop S1, a first optical element E1, a second optical element E2, a third optical element E3, a stop S2, a fourth optical element E4, a fifth optical element E5, a sixth optical element E6, a seventh optical element E7, a filter E8 and an image surface IMG. The optical imaging lens system includes seven optical elements (E1, E2, E3, E4, E5, E6 and E7) with no additional optical element disposed between each of the adjacent seven optical elements, wherein the first optical element E1 is a reflective element and each of the second optical element E2 to seventh optical element E7 is a lens element.

When an imaged object moves from the long distance to the short distance, the optical imaging lens system performs a focus tuning process and changes from the first state to the second state. In this embodiment, the long object distance corresponding to the optical imaging lens system at the first state is ∞ (infinity), and the short object distance corresponding to the optical imaging lens system at the second state is 379.843 millimeters. During the focus tuning process, the optical imaging lens system adjusts its focal length by moving the fifth optical element E5, the sixth optical element E6, and the seventh optical element E7 along the optical axis relative to the second optical element E2, the third optical element E3, and the fourth optical element E4. Furthermore, through the focus tuning process, the optical 10 imaging lens system can have the first state as shown in the upper part of FIG. 13 and the second state as shown in the lower part of FIG. 13.

The first optical element E1 with positive refractive power has an object-side surface being convex in a paraxial region thereof and an image-side surface being planar in a paraxial region thereof. The first optical element E1 has the object-side surface and the image-side surface being both spherical. In this embodiment, the first optical element E1 is a reflective element assembly including a lens element LS1, a cemented layer CML and a prism PR. The lens element LS1 has an object-side surface being convex in a paraxial region thereof and an image-side surface being planar in a paraxial region thereof. The lens element LS1 is made of plastic material. The prism PR has an object-side surface being planar in a paraxial region thereof and an image-side surface being planar in a paraxial region thereof. The prism PR is made of glass material. The prism PR is cemented with the image side of the lens element LS1 through the cemented layer CML.

The second optical element E2 with positive refractive power has an object-side surface being convex in a paraxial region thereof and an image-side surface being concave in a paraxial region thereof. The second optical element E2 is made of plastic material and has the object-side surface and the image-side surface being both aspheric. The object-side surface of the second optical element E2 has one inflection point. The image-side surface of the second optical element E2 has one inflection point.

The third optical element E3 with negative refractive power has an object-side surface being convex in a paraxial region thereof and an image-side surface being concave in a paraxial region thereof. The third optical element E3 is made of plastic material and has the object-side surface and the image-side surface being both aspheric. The object-side surface of the third optical element E3 has one inflection point. The image-side surface of the third optical element E3 has one inflection point.

The fourth optical element E4 with positive refractive power has an object-side surface being convex in a paraxial region thereof and an image-side surface being convex in a paraxial region thereof. The fourth optical element E4 is made of plastic material and has the object-side surface and the image-side surface being both aspheric. The image-side surface of the fourth optical element E4 has one inflection point.

The fifth optical element E5 with negative refractive power has an object-side surface being concave in a paraxial region thereof and an image-side surface being convex in a paraxial region thereof. The fifth optical element E5 is made of plastic material and has the object-side surface and the image-side surface being both aspheric. The object-side surface of the fifth optical element E5 has one inflection point. The image-side surface of the fifth optical element E5 has one inflection point. The object-side surface of the fifth optical element E5 has one critical point in an off-axis region thereof. The image-side surface of the fifth optical element E5 has one critical point in an off-axis region thereof.

The sixth optical element E6 with positive refractive power has an object-side surface being convex in a paraxial region thereof and an image-side surface being concave in a paraxial region thereof. The sixth optical element E6 is made of plastic material and has the object-side surface and the image-side surface being both aspheric. The object-side surface of the sixth optical element E6 has two inflection points. The image-side surface of the sixth optical element E6 has two inflection points. The object-side surface of the sixth optical element E6 has two critical points in an off-axis region thereof. The image-side surface of the sixth optical element E6 has one critical point in an off-axis region thereof.

The seventh optical element E7 with negative refractive power has an object-side surface being convex in a paraxial region thereof and an image-side surface being concave in a paraxial region thereof. The seventh optical element E7 is made of plastic material and has the object-side surface and the image-side surface being both aspheric. The object-side surface of the seventh optical element E7 has two inflection points. The image-side surface of the seventh optical element E7 has two inflection points. The object-side surface of the seventh optical element E7 has one critical point in an off-axis region thereof. The image-side surface of the seventh optical element E7 has one critical point in an off-axis region thereof.

The filter E8 is made of glass material and located between the seventh optical element E7 and the image surface IMG, and will not affect the focal length of the optical imaging lens system. The image sensor IS is disposed on or near the image surface IMG.

In this embodiment, an axial distance between the image-side surface of the fourth optical element E4 and the object-side surface of the fifth optical element E5 is defined as DD.

The detailed optical data of the 5th embodiment are shown in Table A and Table 5B, and the aspheric surface data are shown in Table 5C below.

TABLE 5A
5th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Stop | Plano | | −0.157 | | | | |
| 2 | Optical element 1 | 31.0038 | (SPH) | 0.865 | Plastic | 1.551 | 44.5 | 56.22 |
| 3 | | Plano | (SPH) | 0.030 | Cemented | 1.485 | 53.2 | |
| 4 | | Plano | (SPH) | 9.800 | Glass | 1.626 | 39.1 | |
| 5 | | Plano | (SPH) | 0.511 | | | | |
| 6 | Optical element 2 | 9.8926 | (ASP) | 0.600 | Plastic | 1.544 | 56.0 | 19.67 |
| 7 | | 127.7636 | (ASP) | 0.030 | | | | |
| 8 | Optical element 3 | 6.5957 | (ASP) | 0.786 | Plastic | 1.587 | 28.3 | −12.62 |
| 9 | | 3.3357 | (ASP) | 1.543 | | | | |
| 10 | Stop | Plano | | −0.601 | | | | |
| 11 | Optical element 4 | 12.4595 | (ASP) | 4.228 | Plastic | 1.511 | 56.8 | 9.67 |
| 12 | | −7.2472 | (ASP) | D1 | | | | |
| 13 | Optical element 5 | −4.5758 | (ASP) | 0.602 | Plastic | 1.639 | 23.5 | −14.10 |
| 14 | | −9.7801 | (ASP) | 0.764 | | | | |
| 15 | Optical element 6 | 21.9405 | (ASP) | 1.717 | Plastic | 1.705 | 14.0 | 39.85 |
| 16 | | 97.0494 | (ASP) | 0.527 | | | | |
| 17 | Optical element 7 | 4.8497 | (ASP) | 1.339 | Plastic | 1.566 | 37.4 | −52.99 |
| 18 | | 3.7581 | (ASP) | D2 | | | | |

| | | | | | | | |
|---|---|---|---|---|---|---|---|
| 19 | Filter | Plano | 0.210 | Glass | 1.517 | 64.2 | — |
| 20 | | Plano | 0.475 | | | | |
| 21 | Image | Plano | — | | | | |

Note:
Reference wavelength is 587.6 nm (d-line).
An effective radius of the stop S1 (Surface 1) is 4.007 mm.
An effective radius of the stop S2 (Surface 10) is 3.950 mm.

TABLE 5B
Optical data for optical imaging lens system focusing
on the long distance and the short distance

| | Focusing | | Focusing |
|---|---|---|---|
| | on the long | | on the short |
| | distance | | distance |
| | (First state) | | (Second state) |
| fi [mm] | 18.91 | fm [mm] | 17.55 |
| Fnoi | 2.36 | Fnom | 2.30 |
| HFOVi [deg.] | 17.8 | HFOVm [deg.] | 18.2 |
| FOVi [deg.] | 35.6 | FOVm [deg.] | 36.4 |
| object | ∞ | object | 379.843 |
| distance [mm] | | distance [mm] | |
| D0 [mm] | ∞ | D0 [mm] | 380.000 |
| D1 [mm] | 1.862 | D1 [mm] | 2.572 |
| D2 [mm] | 5.600 | D2 [mm] | 4.890 |

Except for D1, in Table 5B, the optical data is the same as the data of the 1 st embodiment. Besides the first state and the second state, the optical imaging lens system of this embodiment can further have other focal lengths corresponding to the intermediate range of the first state and the second state in other focus tuning conditions for different object distances.

TABLE 5C
Aspheric Coefficients

| Surface # | 6 | 7 | 8 | 9 |
|---|---|---|---|---|
| k = | 5.79873E−04 | −9.90000E+01 | 1.05700E+00 | −2.04340E+00 |
| A4 = | −2.5191495E−03 | 6.3517313E−03 | 3.5678241E−03 | 1.3121942E−03 |
| A6 = | 1.2066354E−03 | −6.4884351E−04 | −2.2135069E−03 | −1.1210542E−03 |
| A8 = | −2.6971622E−04 | 2.1913589E−05 | 3.7413382E−04 | 2.1235842E−04 |
| A10 = | 3.9328120E−05 | 8.9534242E−06 | −4.0521552E−05 | −2.4563094E−05 |
| A12 = | −3.6704377E−06 | −1.4468427E−06 | 3.0131420E−06 | 1.7867059E−06 |
| A14 = | 2.0288130E−07 | 7.0001028E−08 | −1.6900645E−07 | −7.9006137E−08 |
| A16 = | −6.0566023E−09 | 5.5273309E−10 | 7.2995274E−09 | 1.9538101E−09 |
| A18 = | 7.5072970E−11 | −1.4003328E−10 | −2.0771049E−10 | −2.0910238E−11 |
| A20 = | — | 3.0614869E−12 | 2.6671275E−12 | — |
| Surface # | 11 | 12 | 13 | 14 |
| k = | 5.41566E+00 | 0.00000E+00 | 0.00000E+00 | −6.51707E+00 |
| A4 = | 1.3546800E−03 | 2.1891371E−04 | 7.2927491E−03 | −2.9177225E−03 |
| A6 = | −3.0057451E−04 | 9.9514695E−07 | 2.2355517E−03 | 4.0642441E−03 |
| A8 = | 3.4497242E−05 | −2.0582042E−06 | −8.2172803E−04 | −1.0578096E−03 |
| A10 = | −2.9993813E−06 | 3.8931947E−07 | 1.5768830E−04 | 1.6218715E−04 |
| A12 = | 1.4448616E−07 | −3.8997607E−08 | −1.9880537E−05 | −1.6256126E−05 |
| A14 = | −3.0046811E−09 | 2.3894523E−09 | v1.7216012E−06 | 1.0551741E−06 |
| A16 = | 1.4041468E−11 | −7.9734404E−11 | −1.0107178E−07 | −3.9938361E−08 |
| A18 = | — | 1.1633203E−12 | 3.8343471E−09 | 5.9360833E−10 |
| A20 = | — | — | −8.4669940E−11 | 9.3800868E−12 |
| A22 = | — | — | 8.2713032E−13 | −3.2973647E−13 |
| Surface # | 15 | 16 | 17 | 18 |
| k = | 7.03801E+00 | −9.90000E+01 | −7.81926E−02 | −8.59324E−01 |
| A4 = | −7.9237117E−03 | −6.0516347E−03 | −1.3678524E−02 | −1.0849677E−02 |
| A6 = | 2.0344636E−03 | 9.7886403E−04 | 6.8561967E−04 | 2.7655993E−04 |
| A8 = | −3.7195081E−04 | −1.0854484E−04 | −1.3844574E−05 | 8.9925546E−05 |
| A10 = | 4.1148182E−05 | 7.7121130E−06 | 1.3729781E−06 | −2.0143292E−05 |
| A12 = | −2.4654730E−06 | −6.8077791E−07 | −9.8335011E−07 | 2.2864346E−06 |
| A14 = | −1.1396076E−08 | 8.8853431E−08 | 1.5947203E−07 | −1.6776828E−07 |
| A16 = | 1.5488122E−08 | −9.0799433E−09 | −1.2714684E−08 | 8.4045379E−09 |
| A18 = | −1.2299290E−09 | 6.1436813E−10 | 5.8475053E−10 | −2.8831365E−10 |
| A20 = | 4.2691575E−11 | −2.6484527E−11 | −1.6033511E−11 | 6.5291300E−12 |
| A22 = | −5.7352717E−13 | 6.5643925E−13 | 2.5049823E−13 | −8.8398290E−14 |
| A24 = | — | −7.0336818E−15 | −1.7899301E−15 | 5.4359749E−16 |

In the 5th embodiment, the equation of the aspheric surface profiles of the aforementioned optical elements is the same as the equation of the 1st embodiment. Also, the definitions of these parameters shown in Table 5D are the same as those stated in the 1st embodiment with corresponding values for the 5th embodiment, so an explanation in this regard will not be provided again.

TABLE 5D
Schematic Parameters

| | | | |
|---|---|---|---|
| TL/ImgH | 4.98 | (TL − CT1)/CT1 | 1.89 |
| TD/ImgH | 3.97 | CT2/T12 | 1.17 |
| f/f2 | 0.96 | CT2/CT3 | 0.76 |
| f/f4 | 1.96 | T34/CT4 | 0.22 |
| f/f234 | 1.48 | (CT2 + CT3 + CT4 + | 0.87 |
| | | CT5 + CT6 + CT7)/CT1 | |
| \|TLi − TLm\|/TLi | 0.00 | V2/V1 | 1.26 |
| R5/R3 | 0.67 | V6/V7 | 0.37 |
| \|R9/R3\| | 0.46 | CT2/SAG2R1 | 0.82 |
| (R7 + R8)/(R7 − R8) | 0.26 | SAG6R1/SAG3R2 | −0.07 |
| IR13/R14\| | 1.29 | Y1R1/ImgH | 0.65 |
| R14/f | 0.20 | Yc71/Y7R1 | 0.59 |

### 6th Embodiment

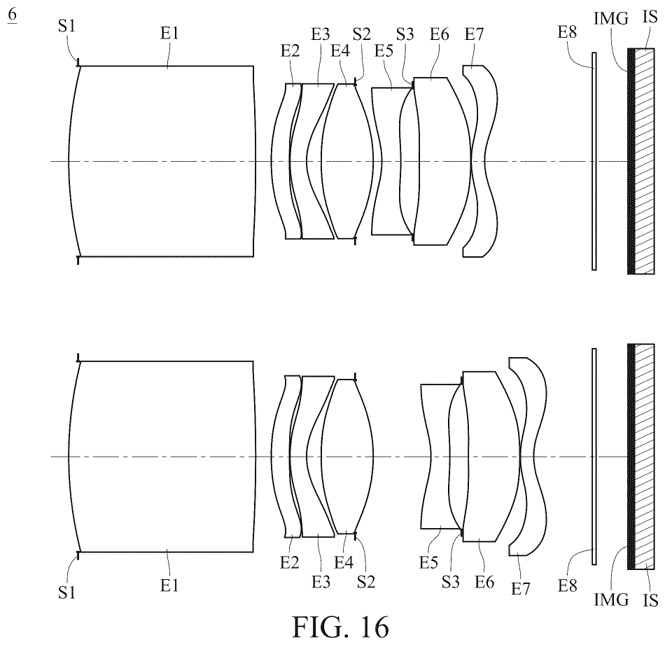

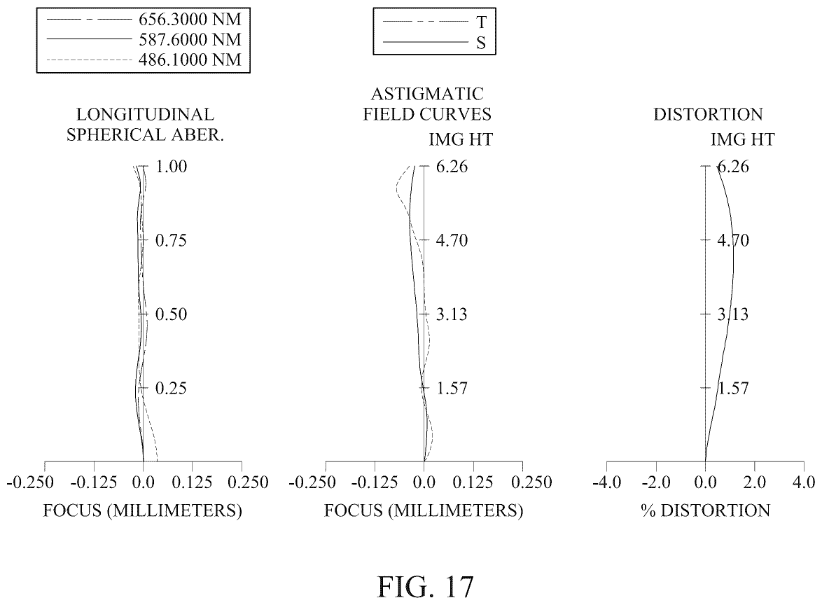

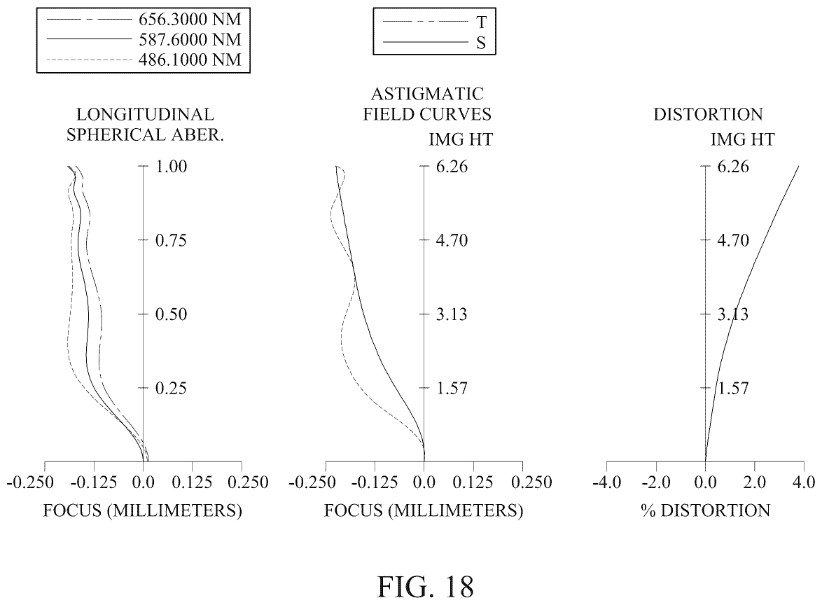

FIG. 16 is a schematic view of an image capturing unit at the first state (focusing on a long distance) and the second state (focusing on a short distance) according to the 6th embodiment of the present disclosure. FIG. 17 shows, in order from left to right, spherical aberration curves, astigmatic field curves and a distortion curve of the image capturing unit at the first state according to the 6th embodiment. FIG. 18 shows, in order from left to right, spherical aberration curves, astigmatic field curves and a distortion curve of the image capturing unit at the second state according to the 6th embodiment. The upper part of FIG. 16 shows the optical imaging lens system at the first state, and the lower part of FIG. 16 shows the optical imaging lens system at the second state. In FIG. 16, the image capturing unit 6 includes the optical imaging lens system (its reference numeral is omitted) of the present disclosure and an image sensor IS. The optical imaging lens system includes, in order from an object side to an image side along an optical path, a stop S1, a first optical element E1, a second optical element E2, a third optical element E3, a fourth optical element E4, a stop S2, a fifth optical element E5, a stop S3, a sixth optical element E6, a seventh optical element E7, a filter E8 and an image surface IMG. The optical imaging lens system includes seven optical elements (E1, E2, E3, E4, E5, E6 and E7) with no additional optical element disposed between each of the adjacent seven optical elements, wherein the first optical element E1 is a reflective element and each of the second optical element E2 to seventh optical element E7 is a lens element.

When an imaged object moves from the long distance to the short distance, the optical imaging lens system performs a focus tuning process and changes from the first state to the second state. In this embodiment, the long object distance corresponding to the optical imaging lens system at the first state is ∞ (infinity), and the short object distance corresponding to the optical imaging lens system at the second state is 99.480 millimeters. During the focus tuning process, the optical imaging lens system adjusts its focal length by moving the fifth optical element E5, the sixth optical element E6, and the seventh optical element E7 along the optical axis relative to the second optical element E2, the third optical element E3, and the fourth optical element E4. Furthermore, through the focus tuning process, the optical imaging lens system can have the first state as shown in the upper part of FIG. 16 and the second state as shown in the lower part of FIG. 16.

The first optical element E1 with positive refractive power has an object-side surface being convex in a paraxial region thereof and an image-side surface being convex in a paraxial region thereof. The first optical element E1 is made of glass material and has the object-side surface and the image-side surface being both spherical.

The second optical element E2 with positive refractive power has an object-side surface being convex in a paraxial region thereof and an image-side surface being concave in a paraxial region thereof. The second optical element E2 is made of glass material and has the object-side surface and the image-side surface being both aspheric. The object-side surface of the second optical element E2 has one inflection point. The image-side surface of the second optical element E2 has one inflection point. The object-side surface of the second optical element E2 has one critical point in an off-axis region thereof. The image-side surface of the second optical element E2 has one critical point in an off-axis region thereof.

The third optical element E3 with negative refractive power has an object-side surface being convex in a paraxial region thereof and an image-side surface being concave in a paraxial region thereof. The third optical element E3 is made of plastic material and has the object-side surface and the image-side surface being both aspheric. The object-side surface of the third optical element E3 has one inflection point. The image-side surface of the third optical element E3 has three inflection points.

The fourth optical element E4 with positive refractive power has an object-side surface being convex in a paraxial region thereof and an image-side surface being convex in a paraxial region thereof. The fourth optical element E4 is made of plastic material and has the object-side surface and the image-side surface being both aspheric. The image-side surface of the fourth optical element E4 has one inflection point.

The fifth optical element E5 with negative refractive power has an object-side surface being concave in a paraxial region thereof and an image-side surface being convex in a paraxial region thereof. The fifth optical element E5 is made of plastic material and has the object-side surface and the image-side surface being both aspheric. The object-side surface of the fifth optical element E5 has one inflection point. The image-side surface of the fifth optical element E5 has one inflection point. The image-side surface of the fifth optical element E5 has one critical point in an off-axis region thereof.

The sixth optical element E6 with positive refractive power has an object-side surface being convex in a paraxial region thereof and an image-side surface being convex in a paraxial region thereof. The sixth optical element E6 is made of plastic material and has the object-side surface and the image-side surface being both aspheric. The object-side surface of the sixth optical element E6 has two inflection points. The image-side surface of the sixth optical element E6 has one inflection point. The object-side surface of the sixth optical element E6 has one critical point in an off-axis region thereof.

The seventh optical element E7 with negative refractive power has an object-side surface being convex in a paraxial region thereof and an image-side surface being concave in a paraxial region thereof. The seventh optical element E7 is made of plastic material and has the object-side surface and the image-side surface being both aspheric. The object-side surface of the seventh optical element E7 has one inflection point. The image-side surface of the seventh optical element E has one inflection point. The object-side surface of the seventh optical element E7 has one critical point in an off-axis region thereof. The image-side surface of the seventh optical element E1 has one critical point in an off-axis region thereof.

The filter E8 is made of glass material and located between the seventh optical element E2 and the image surface MG, and will not affect the focal length of the optical imaging lens system. The image sensor IS is disposed on or near the image surface DMG.

The detailed optical data of the 6th embodiment are shown in Table 6A and Table 61B, and the aspheric surface data are shown in Table 60 below.

TABLE 6A
6th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Stop | Plano | | −0.520 | | | | |
| 2 | Optical element 1 | 21.2068 | (SPH) | 10.417 | Glass | 1.589 | 61.3 | 29.46 |
| 3 | | −78.1250 | (SPH) | 0.867 | | | | |
| 4 | Optical element 2 | 10.3352 | (ASP) | 1.014 | Glass | 1.547 | 62.7 | 23.99 |
| 5 | | 47.0068 | (ASP) | 0.030 | | | | |
| 6 | Optical element 3 | 6.7592 | (ASP) | 0.924 | Plastic | 1.614 | 26.0 | −12.37 |
| 7 | | 3.3893 | (ASP) | 0.815 | | | | |
| 8 | Optical element 4 | 12.1552 | (ASP) | 2.899 | Plastic | 1.515 | 56.4 | 9.93 |
| 9 | | −8.1258 | (ASP) | −1.014 | | | | |
| 10 | Stop | Plano | | D1 | | | | |
| 11 | Optical element 5 | −4.5628 | (ASP) | 1.054 | Plastic | 1.566 | 37.4 | −11.56 |
| 12 | | −16.3194 | (ASP) | 0.652 | | | | |
| 13 | Stop | Plano | | 0.382 | | | | |
| 14 | Optical element 6 | 36.4107 | (ASP) | 2.860 | Plastic | 1.614 | 26.0 | 18.78 |
| 15 | | −16.3566 | (ASP) | 0.033 | | | | |
| 16 | Optical element 7 | 4.9740 | (ASP) | 0.745 | Plastic | 1.529 | 45.4 | −38.36 |
| 17 | | 3.7881 | (ASP) | D2 | | | | |

| | | | | | | | |
|---|---|---|---|---|---|---|---|
| 18 | Filter | Plano | 0.210 | Glass | 1.517 | 64.2 | — |
| 19 | | Plano | 1.771 | | | | |
| 20 | Image | Plano | — | | | | |

Note:
Reference wavelength is 587.6 nm (d-line).
An effective radius of the stop S1 (Surface 1) is 5.306 mm.
An effective radius of the stop S2 (Surface 10) is 4.252 mm.
An effective radius of the stop S3 (Surface 13) is 4.060 mm.

TABLE 6B
Optical data for optical imaging lens system focusing on
the long distance and the short distance

| | Focusing | | Focusing |
|---|---|---|---|
| | on the long | | on the short |
| | distance | | distance |
| | (First state) | | (Second state) |
| fi [mm] | 21.23 | fm [mm] | 17.11 |
| Fnoi | 2.00 | Fnom | 1.92 |
| HFOVi [deg.] | 16.4 | HFOVm [deg.] | 16.6 |
| FOVi [deg.] | 32.8 | FOVm [deg.] | 33.2 |
| object | ∞ | object | 99.480 |
| distance [mm] | | distance [mm] | |
| D0 [mm] | ∞ | D0 [mm] | 100.000 |
| D1 [mm] | 1.494 | D1 [mm] | 4.230 |
| D2 [mm] | 6.000 | D2 [mm] | 3.264 |

In Table 6B, the optical data is the same as the data of the 1st embodiment. Besides the first state and the second state, the optical imaging lens system of this embodiment can further have other focal lengths corresponding to the intermediate range of the first state and the second state in other focus tuning conditions for different object distances.

TABLE 6C
Aspheric Coefficients

| Surface # | 4 | 5 | 6 | 7 |
|---|---|---|---|---|
| k = | 1.96621E+00 | 9.00000E+01 | 9.20532E−01 | −2.08002E+00 |
| A4 = | 3.7869973E−04 | 7.0162311E−03 | −8.2113858E−04 | −2.1827566E−03 |
| A6 = | −3.6118228E−05 | −6.1683952E−04 | 1.2082455E−04 | 8.2148251E−04 |
| A8 = | 2.9073864E−05 | 7.0319011E−05 | −1.0762902E−04 | −2.1584657E−04 |
| A10 = | −6.0188114E−06 | −9.8865062E−06 | 1.4967840E−05 | 2.7159177E−05 |
| A12 = | 5.7322118E−07 | 1.0298859E−06 | −1.1754443E−06 | −2.0573153E−06 |
| A14 = | −3.1430135E−08 | −7.5725188E−08 | 6.3870044E−08 | 9.7560169E−08 |
| A16 = | 9.1384193E−10 | 3.5045962E−09 | −2.4305800E−09 | −2.6222985E−09 |
| A18 = | −1.0777063E−11 | −8.8577852E−11 | 5.7220407E−11 | 2.9806047E−11 |
| A20 = | — | 9.2179380E−13 | −6.1933837E−13 | — |
| Surface # | 8 | 9 | 11 | 12 |
| k = | 5.12156E+00 | 0.00000E+00 | 0.00000E+00 | −1.23619E+01 |
| A4 = | 9.8643927E−04 | −3.4474653E−04 | 7.1795626E−03 | −2.6877063E−03 |
| A6 = | −3.0283743E−05 | 1.7285493E−04 | 1.6621776E−03 | 3.6781457E−03 |
| A8 = | 1.1150235E−05 | −3.7429192E−05 | −6.1978303E−04 | −9.8614890E−04 |
| A10 = | −2.6980983E−06 | 5.3721282E−06 | 1.1990424E−04 | 1.7123288E−04 |
| A12 = | 1.2079387E−07 | −4.6240217E−07 | −1.5266267E−05 | −2.0609414E−05 |
| A14 = | 3.8008210E−09 | 2.3479398E−08 | 1.3336862E−06 | 1.7223834E−06 |
| A16 = | −3.5858877E−10 | −6.4955217E−10 | −7.9115181E−08 | −9.7264293E−08 |
| A18 = | 6.1520809E−12 | 7.7965740E−12 | 3.0457355E−09 | 3.5072133E−09 |
| A20 = | — | — | −6.8590350E−11 | −7.2292444E−11 |
| A22 = | — | — | 6.8647598E−13 | 6.4417866E−13 |
| Surface # | 14 | 15 | 16 | 17 |
| k = | −7.65326E+00 | 9.79235E+00 | −1.48235E−01 | −8.72159E−01 |
| A4 = | −1.0812648E−02 | −3.9800949E−03 | 6.7659573E−04 | 3.1216730E−03 |
| A6 = | 2.8094795E−03 | −1.2192120E−04 | −4.0068893E−03 | −4.6732925E−03 |
| A8 = | −6.2430356E−04 | 7.9343558E−05 | 7.4637496E−04 | 9.6588235E−04 |
| A10 = | 9.8622274E−05 | −4.8751753E−06 | −8.5619606E−05 | −1.1905502E−04 |
| A12 = | −1.0448195E−05 | −1.1269958E−06 | 9.2511485E−06 | 9.9176134E−06 |
| A14 = | 7.0764767E−07 | 2.9680405E−07 | −1.1604073E−06 | −5.7878879E−07 |
| A16 = | −2.6455475E−08 | −3.5377067E−08 | 1.3204192E−07 | 2.3752838E−08 |
| A18 = | 1.7792928E−10 | 2.6100151E−09 | −1.1043234E−08 | −6.7242585E−10 |
| A20 = | 2.7862438E−11 | −1.2486004E−10 | 6.3764692E−10 | 1.2503180E−11 |
| A22 = | −1.1197590E−12 | 3.7702467E−12 | −2.4749424E−11 | −1.3728272E−13 |
| A24 = | 1.4375279E−14 | −6.5294039E−14 | 6.1772825E−13 | 6.7295295E−16 |
| A26 = | — | 4.9442122E−16 | −8.9679672E−15 | — |

In the 6th embodiment, the equation of the aspheric surface profiles of the aforementioned optical elements is the same as the equation of the 1st embodiment. Also, the definitions of these parameters shown in Table 6D are the same as those stated in the 1st embodiment with corresponding values for the 6th embodiment, so an explanation in this regard will not be provided again.

TABLE 6D
Schematic Parameters

| | | | |
|---|---|---|---|
| TL/ImgH | 4.98 | (TL − CT1)/CT1 | 1.99 |
| TD/ImgH | 3.70 | CT2/T12 | 1.17 |
| f/f2 | 0.88 | CT2/CT3 | 1.10 |
| f/f4 | 2.14 | T34/CT4 | 0.28 |
| f/f234 | 1.36 | (CT2 + CT3 + CT4 + | 0.91 |
| | | CT5 + CT6 + CT7)/CT1 | |
| \|TLi − TLm\|/TLi | 0.00 | V2/V1 | 1.02 |
| R5/R3 | 0.65 | V6/V7 | 0.57 |
| \|R9/R3\| | 0.44 | CT2/SAG2R1 | 1.39 |
| (R7 + R8)/(R7 − R8) | 0.20 | SAG6R1/SAG3R2 | −0.19 |
| \|R13/R14\| | 1.31 | Y1R1/ImgH | 0.85 |
| R14/f | 0.18 | Yc71/Y7R1 | 0.55 |

### 7th Embodiment

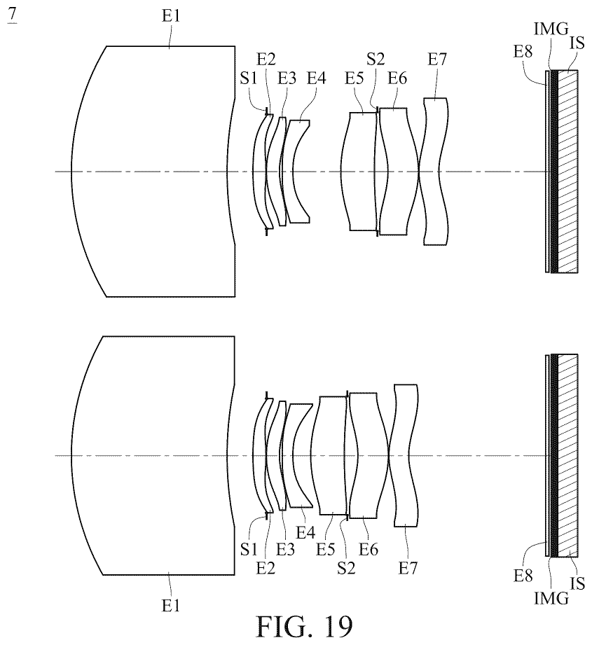

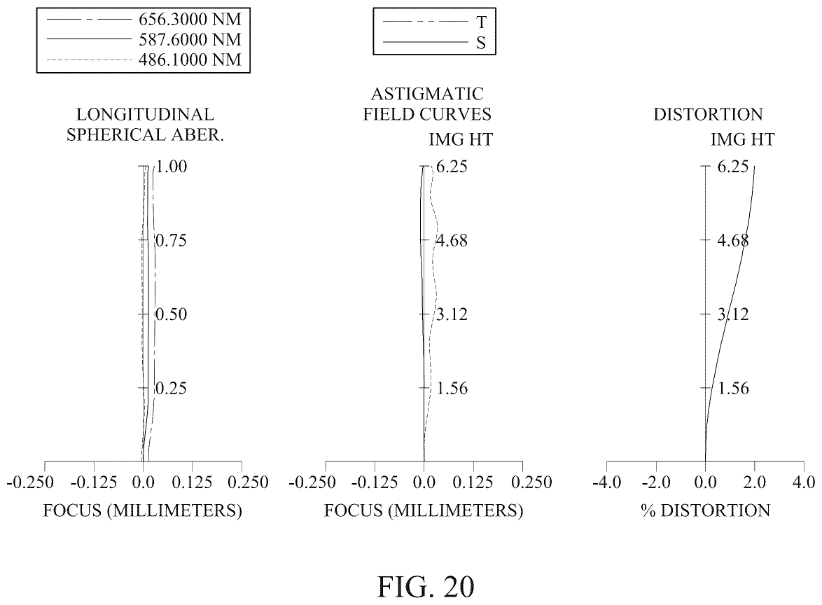

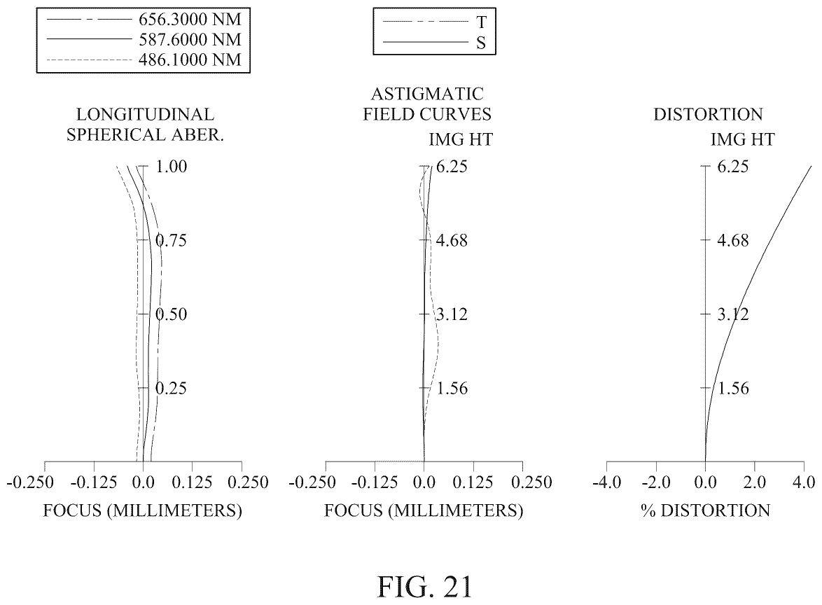

FIG. 19 is a schematic view of an image capturing unit at the first state (focusing on a long distance) and the second state (focusing on a short distance) according to the 7th embodiment of the present disclosure. FIG. 20 shows, in order from left to right, spherical aberration curves, astigmatic field curves and a distortion curve of the image capturing unit at the first state according to the 7th embodiment. FIG. 21 shows, in order from left to right, spherical aberration curves, astigmatic field curves and a distortion curve of the image capturing unit at the second state according to the 7th embodiment. The upper part of FIG. 19 shows the optical imaging lens system at the first state, and the lower part of FIG. 19 shows the optical imaging lens system at the second state. In FIG. 19, the image capturing unit 7 includes the optical imaging lens system (its reference numeral is omitted) of the present disclosure and an image sensor IS. The optical imaging lens system includes, in order from an object side to an image side along an optical path, a first optical element E1, a stop S1, a second optical element E2, a third optical element E3, a fourth optical element E4, a fifth optical element E5, a stop S2, a sixth optical element E6, a seventh optical element E7, a filter E8 and an image surface IMG. The optical imaging lens system includes seven optical elements (E1, E2, E3, E4, E5, E6 and E7) with no additional optical element disposed between each of the adjacent seven optical elements, wherein the first optical element E1 is a reflective element and each of the second optical element E2 to seventh optical element E7 is a lens element.

When an imaged object moves from the long distance to the short distance, the optical imaging lens system performs a focus tuning process and changes from the first state to the second state. In this embodiment, the long object distance corresponding to the optical imaging lens system at the first state is ∞ (infinity), and the short object distance corresponding to the optical imaging lens system at the second state is 250.000 millimeters. During the focus tuning process, the optical imaging lens system adjusts its focal length by moving the fifth optical element E5, the sixth optical element E6, and the seventh optical element E7 along the optical axis relative to the second optical element E2, the third optical element E3, and the fourth optical element E4. Furthermore, through the focus tuning process, the optical imaging lens system can have the first state as shown in the upper part of FIG. 19 and the second state as shown in the lower part of FIG. 19.

The first optical element E1 with positive refractive power has an object-side surface being convex in a paraxial region thereof and an image-side surface being concave in a paraxial region thereof. The first optical element E1 is made of glass material and has the object-side surface and the image-side surface being both spherical.

The second optical element E2 with positive refractive power has an object-side surface being convex in a paraxial region thereof and an image-side surface being convex in a paraxial region thereof. The second optical element E2 is made of plastic material and has the object-side surface and the image-side surface being both aspheric. The object-side surface of the second optical element E2 has one inflection point. The image-side surface of the second optical element E2 has two inflection points. The image-side surface of the second optical element E2 has one critical point in an off-axis region thereof.

The third optical element E3 with negative refractive power has an object-side surface being convex in a paraxial region thereof and an image-side surface being concave in a paraxial region thereof. The third optical element E3 is made of plastic material and has the object-side surface and the image-side surface being both aspheric. The object-side surface of the third optical element E3 has one inflection point. The image-side surface of the third optical element E3 has one inflection point. The image-side surface of the third optical element E3 has one critical point in an off-axis region thereof.

The fourth optical element E4 with negative refractive power has an object-side surface being convex in a paraxial region thereof and an image-side surface being concave in a paraxial region thereof. The fourth optical element E4 is made of plastic material and has the object-side surface and the image-side surface being both aspheric. The object-side surface of the fourth optical element E4 has one inflection point.

The fifth optical element E5 with positive refractive power has an object-side surface being convex in a paraxial region thereof and an image-side surface being concave in a paraxial region thereof. The fifth optical element E5 is made of plastic material and has the object-side surface and the image-side surface being both aspheric. The object-side surface of the fifth optical element E5 has one inflection point. The image-side surface of the fifth optical element E5 has one inflection point. The image-side surface of the fifth optical element E5 has one critical point in an off-axis region thereof.

The sixth optical element E6 with negative refractive power has an object-side surface being concave in a paraxial region thereof and an image-side surface being convex in a paraxial region thereof. The sixth optical element E6 is made of plastic material and has the object-side surface and the image-side surface being both aspheric. The object-side surface of the sixth optical element E6 has two inflection points. The image-side surface of the sixth optical element E6 has one inflection point. The object-side surface of the sixth optical element E6 has one critical point in an off-axis region thereof. The image-side surface of the sixth optical element E6 has one critical point in an off-axis region thereof.

The seventh optical element E7 with positive refractive power has an object-side surface being convex in a paraxial region thereof and an image-side surface being concave in a paraxial region thereof. The seventh optical element E7 is made of plastic material and has the object-side surface and the image-side surface being both aspheric. The object-side surface of the seventh optical element E7 has one inflection point. The image-side surface of the seventh optical element E7 has one inflection point. The object-side surface of the seventh optical element E7 has one critical point in an off-axis region thereof. The image-side surface of the seventh optical element E7 has one critical point in an off-axis region thereof.

The filter E8 is made of glass material and located between the seventh optical element E7 and the image surface IMG, and will not affect the focal length of the optical imaging lens system. The image sensor IS is disposed on or near the image surface IMG.

In this embodiment, an axial distance between the imaged object and the object-side surface of the first optical element E1 is defined as DO. An axial distance between the image-side surface of the fourth optical element E4 and the object-side surface of the fifth optical element E5 is defined as D1.

The detailed optical data of the 7th embodiment are shown in Table 7A and Table 7B, and the aspheric surface data are shown in Table 7C below.

TABLE 7A
7th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Optical element 1 | 14.8845 | (SPH) | 9.600 | Glass | 1.516 | 64.0 | 63.49 |
| 2 | | 21.3000 | (SPH) | 2.445 | | | | |
| 3 | Stop | Plano | | −0.845 | | | | |
| 4 | Optical element 2 | 15.7298 | (ASP) | 0.800 | Plastic | 1.545 | 56.1 | 10.74 |
| 5 | | −9.1546 | (ASP) | 0.030 | | | | |
| 6 | Optical element 3 | 5.6639 | (ASP) | 0.804 | Plastic | 1.545 | 56.1 | −36.43 |
| 7 | | 4.1859 | (ASP) | 0.173 | | | | |
| 8 | Optical element 4 | 40.5169 | (ASP) | 0.656 | Plastic | 1.614 | 25.6 | −12.25 |
| 9 | | 6.3035 | (ASP) | D1 | | | | |
| 10 | Optical element 5 | 7.9268 | (ASP) | 2.072 | Plastic | 1.545 | 56.1 | 18.33 |
| 11 | | 34.8506 | (ASP) | 0.181 | | | | |
| 12 | Stop | Plano | | 0.657 | | | | |
| 13 | Optical element 6 | −4.5974 | (ASP) | 1.876 | Plastic | 1.639 | 23.5 | −145.20 |
| 14 | | −5.6065 | (ASP) | 0.035 | | | | |
| 15 | Optical element 7 | 4.1729 | (ASP) | 1.225 | Plastic | 1.534 | 56.0 | 121.18 |
| 16 | | 4.0044 | (ASP) | D2 | | | | |

| | | | | | | | |
|---|---|---|---|---|---|---|---|
| 17 | Filter | Plano | 0.210 | Glass | 1.517 | 64.2 | — |
| 18 | | Plano | 0.135 | | | | |
| 19 | Image | Plano | — | | | | |

Note:
Reference wavelength is 587.6 nm (d-line).
An effective radius of the stop S1 (Surface 3) is 3.525 mm.
An effective radius of the stop S2 (Surface 12) is 3.660 mm.

TABLE 7B
Optical data for optical imaging lens system focusing on
the long distance and the short distance

| | Focusing | | Focusing |
|---|---|---|---|
| | on the long | | on the short |
| | distance | | distance |
| | (First state) | | (Second state) |
| fi [mm] | 19.87 | fm [mm] | 19.04 |
| Fnoi | 2.10 | Fnom | 2.24 |
| HFOVi [deg.] | 17.1 | HFOVm [deg.] | 15.8 |
| FOVi [deg.] | 34.2 | FOVm [deg.] | 31.6 |
| object | ∞ | object | 250.000 |
| distance [mm] | | distance [mm] | |
| D0 [mm] | ∞ | D0 [mm] | 250.000 |
| D1 [mm] | 2.956 | D1 [mm] | 1.100 |
| D2 [mm] | 6.586 | D2 [mm] | 8.442 |

Except for D0 and D1, in Table 7B, the optical data is the same as the data of the 1 st embodiment. Besides the first state and the second state, the optical imaging lens system of this embodiment can further have other focal lengths corresponding to the intermediate range of the first state and the second state in other focus tuning conditions for different object distances.

TABLE 7C
Aspheric Coefficients

| Surface # | 4 | 5 | 6 | 7 |
|---|---|---|---|---|
| k = | −2.70326E−01 | −9.43741E−01 | 1.05891E+00 | −2.01253E+00 |
| A4 = | 1.0351078E−03 | 1.5488457E−02 | −1.8335070E−03 | −1.3821491E−02 |
| A6 = | 5.7461168E−04 | −1.1023549E−03 | 1.1749646E−03 | 2.4831156E−03 |
| A8 = | 1.4183757E−05 | 2.2200719E−04 | −3.3059458E−04 | −8.3685961E−04 |
| A10 = | −2.1876030E−05 | −6.4436246E−05 | 4.2545998E−05 | 2.8993680E−04 |
| A12 = | 3.6369648E−06 | 1.0914790E−05 | −7.7087833E−06 | −6.8046090E−05 |
| A14 = | −2.9416525E−07 | −1.0619986E−06 | 1.6852949E−06 | 9.9842548E−06 |
| A16 = | 1.2326498E−08 | 5.9745820E−08 | −2.3674778E−07 | −9.1606641E−07 |
| A18 = | −2.2303332E−10 | −1.8541183E−09 | 1.8485752E−08 | 5.1379827E−08 |
| A20 = | — | 2.4998159E−11 | −7.4191873E−10 | −1.6126468E−09 |
| A22 = | — | — | 1.1939472E−11 | 2.1648871E−11 |
| Surface # | 8 | 9 | 10 | 11 |
| k = | 5.74156E+00 | 0.00000E+00 | 0.00000E+00 | −1.44674E+01 |
| A4 = | 1.8836653E−02 | 1.6009373E−02 | −2.0983688E−04 | 1.7926498E−03 |
| A6 = | −5.1013318E−03 | −3.3428969E−03 | −1.7035461E−04 | −5.9011254E−04 |
| A8 = | 8.2494547E−04 | 7.2456894E−04 | 2.6560104E−05 | 7.2125848E−05 |
| A10 = | −2.3440204E−05 | −1.2777916E−04 | −3.2858147E−06 | 3.9414894E−06 |
| A12 = | −1.7500668E−05 | 1.4511616E−05 | 1.4354145E−07 | −2.0717343E−06 |
| A14 = | 3.3837506E−06 | −1.0149996E−06 | 3.5858096E−10 | 2.2061118E−07 |
| A16 = | −2.8548935E−07 | 4.0115566E−08 | −1.2953554E−10 | −1.0282001E−08 |
| A18 = | 1.1891551E−08 | −6.8406947E−10 | — | 1.8229562E−10 |
| A20 = | −1.9969530E−10 | — | — | — |
| Surface # | 13 | 14 | 15 | 16 |
| k = | −6.74378E−01 | −6.07173E−02 | −1.00000E+00 | −3.75918E−01 |
| A4 = | 1.3284751E−02 | 2.3523155E−03 | −1.3618316E−02 | −1.3567165E−02 |
| A6 = | −2.7752340E−03 | −1.0532776E−05 | 9.5274589E−04 | 9.0071719E−04 |
| A8 = | 5.3843485E−04 | −1.0845543E−06 | 6.4113986E−07 | −5.6473452E−05 |
| A10 = | −6.1766777E−05 | 7.1482017E−06 | −1.9692495E−05 | 2.0296064E−06 |
| A12 = | 4.1445137E−06 | −1.4421343E−06 | 5.0365058E−06 | −3.4700726E−08 |
| A14 = | −1.5075042E−07 | 1.2683561E−07 | −7.9056329E−07 | 3.4200157E−11 |
| A16 = | 2.2686043E−09 | −5.2877834E−09 | 8.1453082E−08 | — |
| A18 = | — | 8.4507460E−11 | −5.4418962E−09 | — |
| A20 = | — | — | 2.2660361E−10 | — |
| A22 = | — | — | −5.3310344E−12 | — |
| A24 = | — | — | 5.2955668E−14 | — |
| A26 = | — | — | 4.4474011E−17 | — |

In the 7th embodiment, the equation of the aspheric surface profiles of the aforementioned optical elements is the same as the equation of the 1st embodiment. Also, the definitions of these parameters shown in Table 7D are the same as those stated in the 1st embodiment with corresponding values for the 7th embodiment, so an explanation in this regard will not be provided again.

TABLE 7D
Schematic Parameters

| | | | |
|---|---|---|---|
| TL/ImgH | 4.74 | (TL − CT1)/CT1 | 2.08 |
| TD/ImgH | 3.63 | CT2/T12 | 0.50 |
| f/f2 | 1.85 | CT2/CT3 | 1.00 |
| f/f4 | −1.62 | T34/CT4 | 0.26 |
| f/f234 | 0.09 | (CT2 + CT3 + CT4 + | 0.77 |
| | | CT5 + CT6 + CT7)/CT1 | |
| \|TLi − TLm\|/TLi | 0.00 | V2/V1 | 0.88 |
| R5/R3 | 0.36 | V6/V7 | 0.42 |
| \|R9/R3\| | 0.50 | CT2/SAG2R1 | 0.90 |
| (R7 + R8)/(R7 − R8) | 1.37 | SAG6R1/SAG3R2 | −1.38 |
| \|R13/R14\| | 1.04 | Y1R1/ImgH | 1.24 |
| R14/f | 0.20 | Yc71/Y7R1 | 0.77 |

### 8th Embodiment

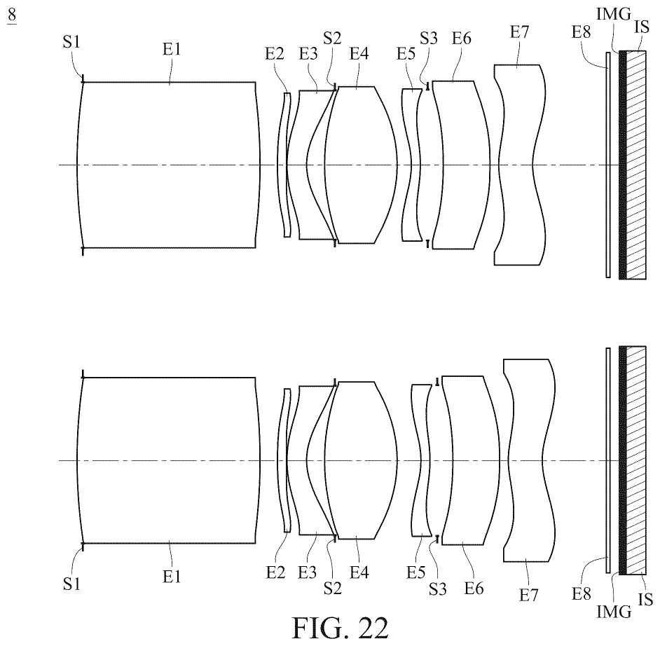

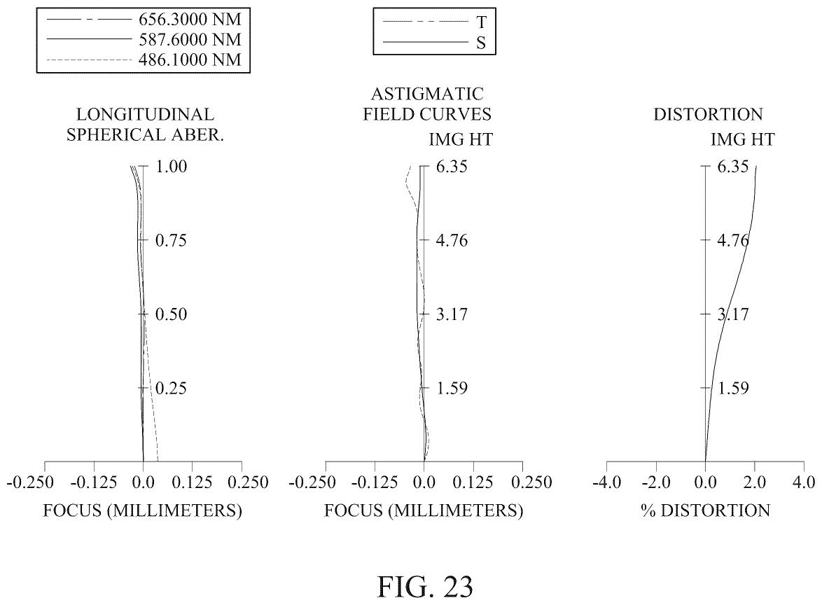

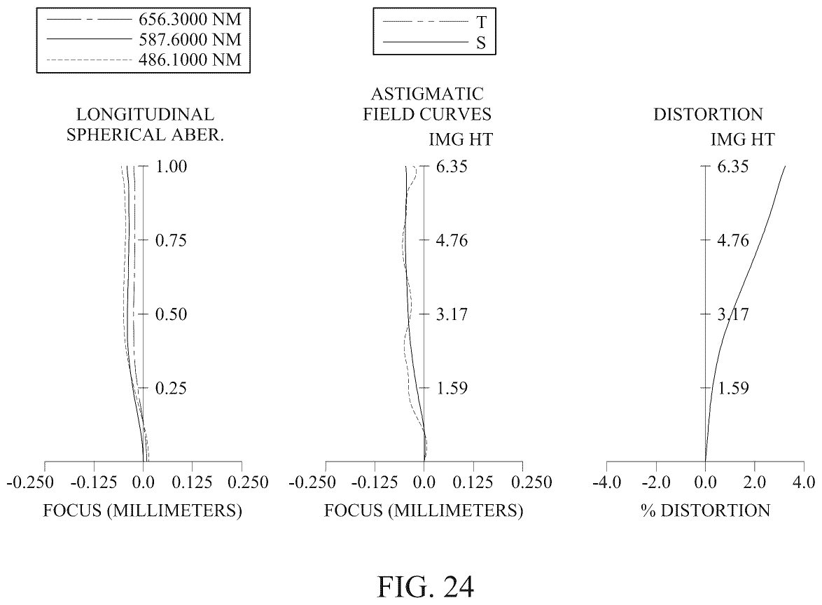

FIG. 22 is a schematic view of an image capturing unit at the first state (focusing on a long distance) and the second state (focusing on a short distance) according to the 8th embodiment of the present disclosure. FIG. 23 shows, in order from left to right, spherical aberration curves, astigmatic field curves and a distortion curve of the image capturing unit at the first state according to the 8th embodiment. FIG. 24 shows, in order from left to right, spherical aberration curves, astigmatic field curves and a distortion curve of the image capturing unit at the second state according to the 8th embodiment. The upper part of FIG. 22 shows the optical imaging lens system at the first state, and the lower part of FIG. 22 shows the optical imaging lens system at the second state. In FIG. 22, the image capturing unit 8 includes the optical imaging lens system (its reference numeral is omitted) of the present disclosure and an image sensor IS. The optical imaging lens system includes, in order from an object side to an image side along an optical path, a stop S1, a first optical element E1, a second optical element E2, a third optical element E3, a stop S2, a fourth optical element E4, a fifth optical element E5, a stop S3, a sixth optical element E6, a seventh optical element E7, a filter E8 and an image surface IMG. The optical imaging lens system includes seven optical elements (E1, E2, E3, E4, E5, E6 and E7) with no additional optical element disposed between each of the adjacent seven optical elements, wherein the first optical element E1 is a reflective element and each of the second optical element E2 to seventh optical element E7 is a lens element.

When an imaged object moves from the long distance to the short distance, the optical imaging lens system performs a focus tuning process and changes from the first state to the second state. In this embodiment, the long object distance corresponding to the optical imaging lens system at the first state is ∞ (infinity), and the short object distance corresponding to the optical imaging lens system at the second state is 449.675 millimeters. During the focus tuning process, the optical imaging lens system adjusts its focal length by moving the fifth optical element E5, the sixth optical element E6, and the seventh optical element E7 along the optical axis relative to the second optical element E2, the third optical element E3, and the fourth optical element E4. Furthermore, through the focus tuning process, the optical imaging lens system can have the first state as shown in the upper part of FIG. 22 and the second state as shown in the lower part of FIG. 22.

The first optical element E1 with positive refractive power has an object-side surface being convex in a paraxial region thereof and an image-side surface being convex in a paraxial region thereof. The first optical element E1 is made of glass material and has the object-side surface and the image-side surface being both spherical.

The second optical element E2 with positive refractive power has an object-side surface being convex in a paraxial region thereof and an image-side surface being convex in a paraxial region thereof. The second optical element E2 is made of plastic material and has the object-side surface and the image-side surface being both aspheric. The object-side surface of the second optical element E2 has one inflection point. The image-side surface of the second optical element E2 has two inflection points. The object-side surface of the second optical element E2 has one critical point in an off-axis region thereof. The image-side surface of the second optical element E2 has two critical points in an off-axis region thereof.

The third optical element E3 with negative refractive power has an object-side surface being convex in a paraxial region thereof and an image-side surface being concave in a paraxial region thereof. The third optical element E3 is made of plastic material and has the object-side surface and the image-side surface being both aspheric. The object-side surface of the third optical element E3 has one inflection point. The image-side surface of the third optical element E3 has one inflection point. The object-side surface of the third optical element E3 has one critical point in an off-axis region thereof.

The fourth optical element E4 with positive refractive power has an object-side surface being convex in a paraxial region thereof and an image-side surface being convex in a paraxial region thereof. The fourth optical element E4 is made of plastic material and has the object-side surface and the image-side surface being both aspheric. The image-side surface of the fourth optical element E4 has one inflection point.

The fifth optical element E5 with negative refractive power has an object-side surface being concave in a paraxial region thereof and an image-side surface being convex in a paraxial region thereof. The fifth optical element E5 is made of plastic material and has the object-side surface and the image-side surface being both aspheric. The object-side surface of the fifth optical element E5 has one inflection point. The image-side surface of the fifth optical element E5 has one inflection point. The object-side surface of the fifth optical element E5 has one critical point in an off-axis region thereof. The image-side surface of the fifth optical element E5 has one critical point in an off-axis region thereof.

The sixth optical element E6 with negative refractive power has an object-side surface being concave in a paraxial region thereof and an image-side surface being convex in a paraxial region thereof. The sixth optical element E6 is made of plastic material and has the object-side surface and the image-side surface being both aspheric. The object-side surface of the sixth optical element E6 has one inflection point. The image-side surface of the sixth optical element E6 has one inflection point.

The seventh optical element E7 with positive refractive power has an object-side surface being convex in a paraxial region thereof and an image-side surface being concave in a paraxial region thereof. The seventh optical element E7 is made of plastic material and has the object-side surface and the image-side surface being both aspheric. The object-side surface of the seventh optical element E7 has two inflection points. The image-side surface of the seventh optical element E7 has one inflection point. The object-side surface of the seventh optical element E7 has one critical point in an off-axis region thereof. The image-side surface of the seventh optical element E7 has one critical point in an off-axis region thereof.

The filter E8 is made of glass material and located between the seventh optical element E7 and the image surface IMG, and will not affect the focal length of the optical imaging lens system. The image sensor IS is disposed on or near the image surface IMG.

In this embodiment, an axial distance between the image-side surface of the fourth optical element E4 and the object-side surface of the fifth optical element E5 is defined as D1.

The detailed optical data of the 8th embodiment are shown in Table 8A and Table 81B, and the aspheric surface data are shown in Table 80 below.

TABLE 8A
8th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Stop | Plano | | −0.325 | | | | |
| 2 | Optical element 1 | 30.0708 | (SPH) | 10.186 | Plastic | 1.572 | 57.5 | 28.92 |
| 3 | | −32.3069 | (SPH) | 0.970 | | | | |
| 4 | Optical element 2 | 19.8724 | (ASP) | 0.501 | Plastic | 1.544 | 56.0 | 26.60 |
| 5 | | −52.7951 | (ASP) | 0.030 | | | | |
| 6 | Optical element 3 | 6.6296 | (ASP) | 1.090 | Plastic | 1.566 | 37.4 | −13.87 |
| 7 | | 3.3813 | (ASP) | 1.573 | | | | |
| 8 | Stop | Plano | | −0.571 | | | | |
| 9 | Optical element 4 | 12.5317 | (ASP) | 4.037 | Plastic | 1.511 | 56.8 | 9.80 |
| 10 | | −7.4352 | (ASP) | D1 | | | | |
| 11 | Optical element 5 | −4.6400 | (ASP) | 0.500 | Plastic | 1.642 | 22.5 | −18.28 |
| 12 | | −7.9997 | (ASP) | 0.408 | | | | |
| 13 | Stop | Plano | | 0.869 | | | | |
| 14 | Optical element 6 | −20.7461 | (ASP) | 2.599 | Plastic | 1.705 | 14.0 | −55.49 |
| 15 | | −46.4758 | (ASP) | 0.487 | | | | |
| 16 | Optical element 7 | 4.4499 | (ASP) | 1.889 | Plastic | 1.614 | 25.6 | 104.47 |
| 17 | | 4.0099 | (ASP) | D2 | | | | |

| | | | | | | | |
|---|---|---|---|---|---|---|---|
| 18 | Filter | Plano | 0.210 | Glass | 1.517 | 64.2 | — |
| 19 | | Plano | 0.524 | | | | |
| 20 | Image | Plano | — | | | | |

Note:
Reference wavelength is 587.6 nm (d-line).
An effective radius of the stop S1 (Surface 1) is 4.609 mm.
An effective radius of the stop S2 (Surface 8) is 4.160 mm.
An effective radius of the stop S3 (Surface 13) is 4.200 mm.

TABLE 8B
Optical data for optical imaging lens system focusing
on the long distance and the short distance

| | Focusing | | Focusing |
|---|---|---|---|
| | on the long | | on the short |
| | distance | | distance |
| | (First state) | | (Second state) |
| fi [mm] | 17.98 | fm [mm] | 16.95 |
| Fnoi | 1.95 | Fnom | 1.91 |
| HFOVi | 19.1 | HFOVm | 19.3 |
| [deg.] | | [deg.] | |
| FOVi [deg.] | 38.2 | FOVm [deg.] | 38.6 |
| object | ∞ | object | 449.675 |
| distance | | distance | |
| [mm] | | [mm] | |
| D0 [mm] | ∞ | D0 [mm] | 450.000 |
| D1 [mm] | 0.791 | D1 [mm] | 1.325 |
| D2 [mm] | 4.100 | D2 [mm] | 3.566 |

Except for D1, in Table 8B, the optical data is the same as the data of the 1st embodiment. Besides the first state and the second state, the optical imaging lens system of this embodiment can further have other focal lengths corresponding to the intermediate range of the first state and the second state in other focus tuning conditions for different object distances.

TABLE 8C
Aspheric Coefficients

| Surface # | 4 | 5 | 6 | 7 |
|---|---|---|---|---|
| k = | 3.05261E+00 | 9.00000E+01 | 1.04248E+00 | −2.09993E+00 |
| A4 = | −1.0711511E−03 | 5.4349771E−03 | 9.2062687E−04 | −3.8112023E−04 |
| A6 = | 9.3686935E−04 | −1.1170326E−04 | −1.0667150E−03 | −6.0480528E−04 |
| A8 = | −1.6514759E−04 | 1.9953852E−05 | 2.1281113E−04 | 1.7824183E−04 |
| A10 = | 1.3221721E−05 | −1.7517877E−05 | −3.3242091E−05 | −3.1058671E−05 |
| A12 = | −4.4618153E−07 | 3.1654247E−06 | 3.3624606E−06 | 3.3226075E−06 |
| A14 = | −6.1136449E−09 | −2.7545332E−07 | −2.0642216E−07 | −2.2194618E−07 |
| A16 = | 8.2498186E−10 | 1.2902301E−08 | 7.1587362E−09 | 9.0765656E−09 |
| A18 = | −1.5581981E−11 | −3.1210424E−10 | −1.2069190E−10 | −2.0817892E−10 |
| A20 = | — | 3.0621404E−12 | 6.1397102E−13 | 2.0482658E−12 |
| Surface # | 9 | 10 | 11 | 12 |
| k = | 5.18833E+00 | 0.00000E+00 | 0.00000E+00 | −7.52894E+00 |
| A4 = | 1.1322923E−03 | −4.7763994E−05 | 3.9509038E−03 | −1.9095253E−03 |
| A6 = | −3.6900041E−04 | 9.7103256E−05 | 2.7282116E−03 | 3.0980951E−03 |
| A8 = | 5.1736915E−05 | −1.7425276E−05 | −7.7489674E−04 | −7.5228876E−04 |
| A10 = | −4.6955373E−06 | 1.7733184E−06 | 1.2734647E−04 | 1.1238001E−04 |
| A12 = | 2.1830563E−07 | −1.0832627E−07 | −1.4393089E−05 | −1.2027559E−05 |
| A14 = | −3.0875832E−09 | 4.0911532E−09 | 1.1593954E−06 | 9.4695016E−07 |
| A16 = | −8.0851802E−11 | −8.6563906E−11 | −6.5196346E−08 | −5.2907904E−08 |
| A18 = | 2.1476566E−12 | 8.6717917E−13 | 2.4192898E−09 | 1.9534628E−09 |
| A20 = | — | — | −5.2966850E−11 | −4.2191022E−11 |
| A22 = | — | — | 5.1705861E−13 | 3.9982489E−13 |
| Surface # | 14 | 15 | 16 | 17 |
| k = | −6.83509E+01 | 2.54632E+01 | −3.05348E−01 | −7.66727E−01 |
| A4 = | −4.8184093E−03 | −1.6414172E−02 | −2.5173981E−02 | −1.2722874E−02 |
| A6 = | 1.3211151E−03 | 5.2514508E−03 | 5.1445891E−03 | 1.3253327E−03 |
| A8 = | −2.6459927E−04 | −1.2177265E−03 | −9.8121679E−04 | −1.3909466E−04 |
| A10 = | 3.7350982E−05 | 2.1236940E−04 | 1.4349355E−04 | 1.1113085E−05 |
| A12 = | −4.0363700E−06 | −2.7820853E−05 | −1.5625893E−05 | −6.4852406E−07 |
| A14 = | 3.2742248E−07 | 2.6968338E−06 | 1.2162280E−06 | 2.7036065E−08 |
| A16 = | −1.8657685E−08 | −1.9048717E−07 | −6.3572679E−08 | −7.8231375E−10 |
| A18 = | 7.0361188E−10 | 9.6266255E−09 | 1.9040661E−09 | 1.4925458E−11 |
| A20 = | −1.6576155E−11 | −3.3791901E−10 | −7.7248751E−12 | −1.7035199E−13 |
| A22 = | 2.2651979E−13 | 7.8059162E−12 | −1.8423867E−12 | 9.3185282E−16 |
| A24 = | −1.5094705E−15 | −1.0645079E−13 | 7.5792851E−14 | −9.4439168E−19 |
| A26 = | — | 6.4785454E−16 | −1.3398745E−15 | — |
| A28 = | — | — | 9.3884058E−18 | — |

In the 8th embodiment, the equation of the aspheric surface profiles of the aforementioned optical elements is the same as the equation of the 1st embodiment. Also, the definitions of these parameters shown in Table 8D are the same as those stated in the 1st embodiment with corresponding values for the 8th embodiment, so an explanation in this regard will not be provided again.

TABLE 8D
Schematic Parameters

| | | | |
|---|---|---|---|
| TL/ImgH | 4.75 | (TL − CT1)/CT1 | 1.96 |
| TD/ImgH | 3.99 | CT2/T12 | 0.52 |
| f/f2 | 0.68 | CT2/CT3 | 0.46 |
| f/f4 | 1.83 | T34/CT4 | 0.25 |
| f/f234 | 1.28 | (CT2 + CT3 + CT4 + | 1.04 |
| | | CT5 + CT6 + CT7)/CT1 | |
| \|TLi − TLm\|/TLi | 0.00 | V2/V1 | 0.97 |
| R5/R3 | 0.33 | V6/V7 | 0.55 |
| \|R9/R3\| | 0.23 | CT2/SAG2R1 | 1.62 |
| (R7 + R8)/(R7 − R8) | 0.26 | SAG6R1/SAG3R2 | −0.39 |
| \|R13/R14\| | 1.11 | Y1R1/ImgH | 0.73 |
| R14/f | 0.22 | Yc71/Y7R1 | 0.59 |

### 9th Embodiment

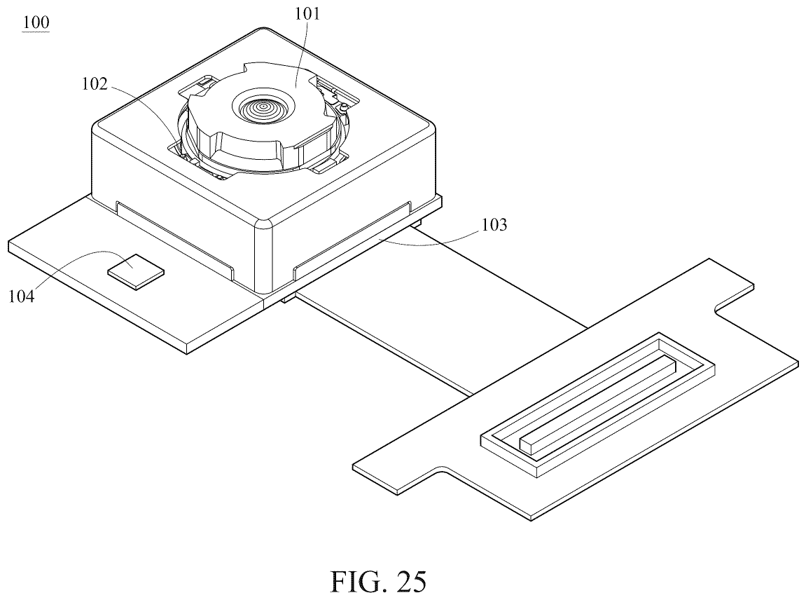

FIG. 25 is a perspective view of an image capturing unit according to the 9th embodiment of the present disclosure. In this embodiment, an image capturing unit 100 is a camera module including a lens unit 101, a driving device 102, an image sensor 103 and an image stabilizer 104. The lens unit 101 includes the optical imaging lens system disclosed in the 1st embodiment, a barrel and a holder member (their reference numerals are omitted) for holding the optical imaging lens system. However, the lens unit 101 may alternatively be provided with the optical imaging lens system disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have auto focusing functionality, and different driving configurations can be obtained through the usages of screw, voice coil motors (VCM), spring type, or ball type. The present disclosure is not limited to the abovementioned focusing manner. The driving device 102 is favorable for obtaining a better imaging position of the lens unit 101 or image sensor, so that a clear image of the imaged object can be captured by the lens unit 101 with different object distances. Moreover, movable elements in the image capturing unit 100 (for example, but not limited to, the first optical element to the seventh optical element in the lens assembly or image sensor) can also be driven by the driving device 102, such that the movable elements can have movement parallel with, angled to, or perpendicular to the optical axis. However, the present disclosure is not limited to the abovementioned driving manner. Moreover, the image sensor 103 (for example, CMOS or CCD), which can feature high photosensitivity and low noise, is disposed on the image surface of the optical imaging lens system to provide higher image quality.

The image stabilizer 104, such as an accelerometer, a gyro sensor and a Hall effect sensor, is configured to work with the driving device 102 to provide optical image stabilization (OIS). The driving device 102 working with the image stabilizer 104 is favorable for compensating for pan and tilt of the lens unit 101 or image sensor to reduce blurring associated with motion during exposure. In some cases, the compensation can be provided by electronic image stabilization (EIS) with image processing software, thereby improving image quality while in motion or low-light conditions. Moreover, several elements in the image capturing unit 100 can also be driven by the driving device 102 so as to timely compensate for image tilt, thereby also achieving OIS.

### 10th Embodiment

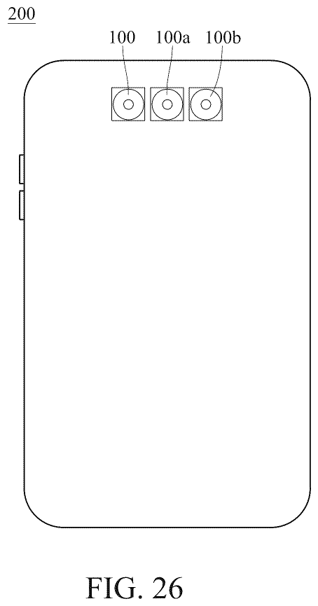

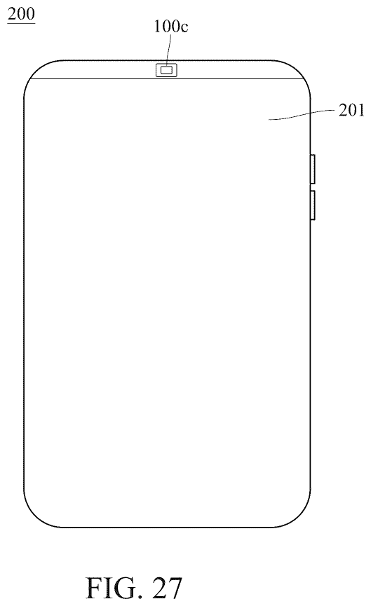

FIG. 26 is one perspective view of an electronic device according to the 10th embodiment of the present disclosure. FIG. 27 is another perspective view of the electronic device in FIG. 27.

In this embodiment, an electronic device 200 is a smartphone including the image capturing unit 100 disclosed in the 9th embodiment, an image capturing unit 100a, an image capturing unit 100b, an image capturing unit 100c and a display unit 201. As shown in FIG. 26, the image capturing unit 100, the image capturing unit 100a and the image capturing unit 100b are disposed on the same side of the electronic device 200 and face the same side, and each of the image capturing units 100, 100a and 100b has a single focal point. As shown in FIG. 27, the image capturing unit 100c and the display unit 201 are disposed on the opposite side of the electronic device 200, such that the image capturing unit 100c can be a front-facing camera of the electronic device 200 for taking selfies, but the present disclosure is not limited thereto. Furthermore, each of the image capturing units 100a, 100b and 100c can include the optical imaging lens system of the present disclosure and can have a configuration similar to that of the image capturing unit 100. In detail, each of the image capturing units 100a, 100b and 100c can include a lens unit, a driving device, an image sensor and an image stabilizer, and each of the lens unit can include an optical lens assembly such as the optical imaging lens system of the present disclosure, a barrel and a holder member for holding the optical imaging lens system.

The image capturing unit 100 is a telephoto image capturing unit, the image capturing unit 100a is a wide-angle image capturing unit, the image capturing unit 100b is an ultra-wide-angle image capturing unit, and the image capturing unit 100c is a wide-angle image capturing unit. In this embodiment, the image capturing units 100, 100a and 100b have different fields of view, such that the electronic device 200 can have various magnification ratios so as to meet the requirement of optical zoom functionality. Moreover, as shown in FIG. 27, the image capturing unit 100c can have a non-circular opening, and the lens barrel or the optical elements in the image capturing unit 100c can have one or more trimmed edges at outer diameter positions thereof for corresponding to the non-circular opening. Therefore, it is favorable for further reducing the length of the image capturing unit 100c along single axis, thereby reducing the overall size of the lens, increasing the area ratio of the display unit 201 with respect to the electronic device 200, reducing the thickness of the electronic device 200, and achieving miniaturization of the overall module. Moreover, the aperture stop inside the image capturing unit 100c can also be non-circular for corresponding to the non-circular opening. The detail can be referred to the description related to FIG. 34 and FIG. 35, which will not be repeated again. In this embodiment, the electronic device 200 includes multiple image capturing units 100, 100a, 100b and 100c, but the present disclosure is not limited to the number and arrangement of image capturing units.

### 11th Embodiment

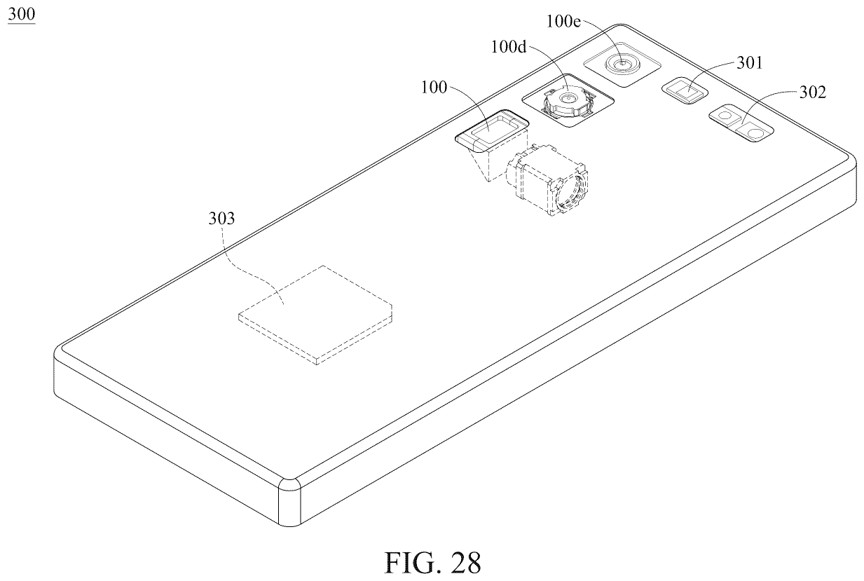

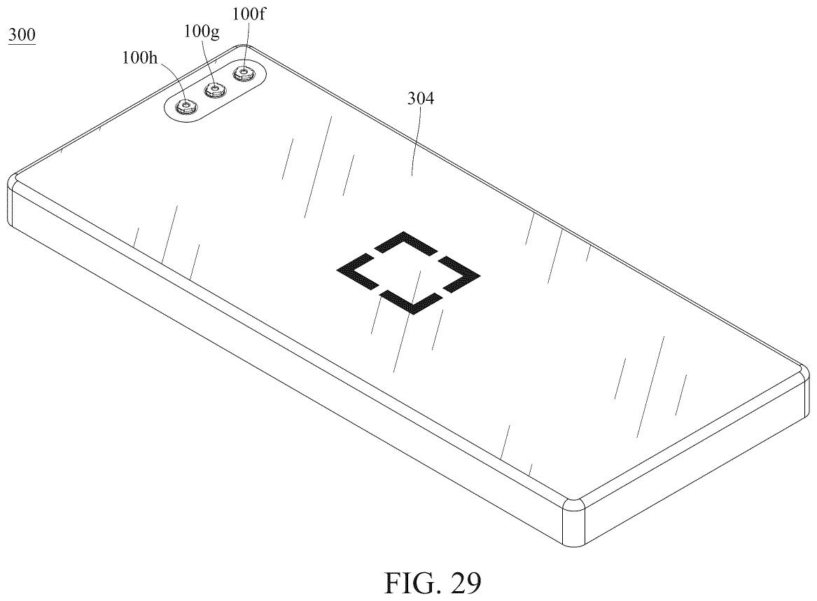

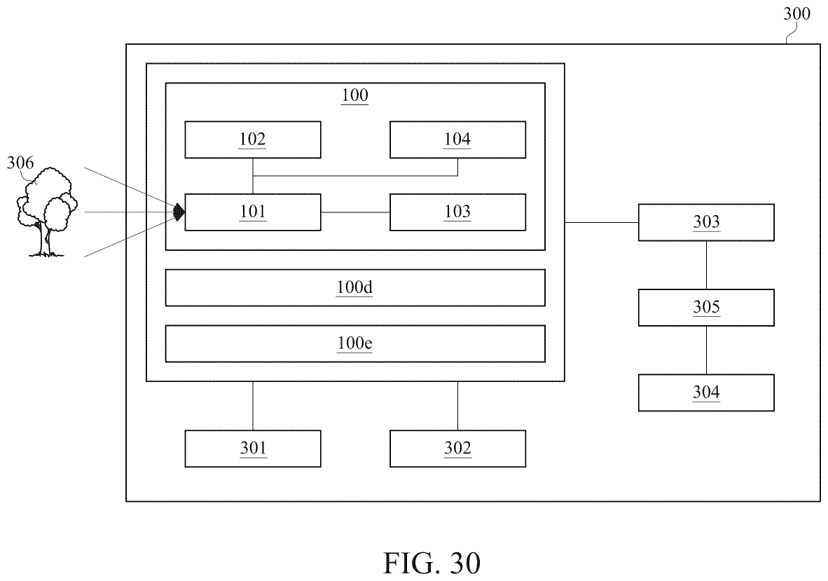

FIG. 28 is one perspective view of an electronic device according to the 11th embodiment of the present disclosure. FIG. 29 is another perspective view of the electronic device in FIG. 28. FIG. 30 is a block diagram of the electronic device in FIG. 28.

In this embodiment, an electronic device 300 is a smartphone including the image capturing unit 100 disclosed in the 9th embodiment, an image capturing unit 100d, an image capturing unit 100e, an image capturing unit 100f, an image capturing unit 100g, an image capturing unit 100h, a flash module 301, a focus assist module 302, an image signal processor 303, a display module 304 and an image software processor 305. The image capturing unit 100, the image capturing unit 100d and the image capturing unit 100e are disposed on the same side of the electronic device 300. The focus assist module 302 can be a laser rangefinder or a ToF (time of flight) module, but the present disclosure is not limited thereto. The image capturing unit 100f, the image capturing unit 100g, the image capturing unit 100h and the display module 304 are disposed on the opposite side of the electronic device 300, and the display module 304 can be a user interface, such that the image capturing units 100f, 100g, 100h can be front-facing cameras of the electronic device 300 for taking selfies, but the present disclosure is not limited thereto. Furthermore, each of the image capturing units 100d, 100e, 100f, 100g and 100h can include the optical imaging lens system of the present disclosure and can have a configuration similar to that of the image capturing unit 100. In detail, each of the image capturing units 100d, 100e, 100f, 100g and 100h can include a lens unit, a driving device, an image sensor and an image stabilizer, and each of the lens unit can include an optical lens assembly such as the optical imaging lens system of the present disclosure, a barrel and a holder member for holding the optical imaging lens system.

The image capturing unit 100 is a telephoto image capturing unit, the image capturing unit 100d is a wide-angle image capturing unit, the image capturing unit 100e is an ultra-wide-angle image capturing unit, the image capturing unit 100f is a wide-angle image capturing unit, the image capturing unit 100g is an ultra-wide-angle image capturing unit, and the image capturing unit 100h is a ToF image capturing unit. In this embodiment, the image capturing units 100, 100d and 100e have different fields of view, such that the electronic device 300 can have various magnification ratios so as to meet the requirement of optical zoom functionality. Moreover, the image capturing unit 100 can be a telephoto image capturing unit having an optical path folding element configuration such as a reflective element configuration, such that the total track length of the image capturing unit 100 is not limited by the thickness of the electronic device 300. In addition, the image capturing unit 100h can determine depth information of the imaged object. In this embodiment, the electronic device 300 includes multiple image capturing units 100, 100d, 100e, 100f, 100g and 100h, but the present disclosure is not limited to the number and arrangement of image capturing units.

When a user captures images of an object 306, the light rays converge in the image capturing unit 100, the image capturing unit 100d or the image capturing unit 100e to generate images, and the flash module 301 is activated for light supplement. The focus assist module 302 detects the object distance of the imaged object 306 to achieve fast auto focusing. The image signal processor 303 is configured to optimize the captured image to improve image quality. The light beam emitted from the focus assist module 302 can be either conventional infrared or laser. In addition, the light rays may converge in the image capturing unit 100f, 100g or 100h to generate images. The display module 304 can include a touch screen, and the user is able to interact with the display module 304 and the image software processor 305 having multiple functions to capture images and complete image processing. Alternatively, the user may capture images via a physical button. The image processed by the image software processor 305 can be displayed on the display module 304.

### 12th Embodiment

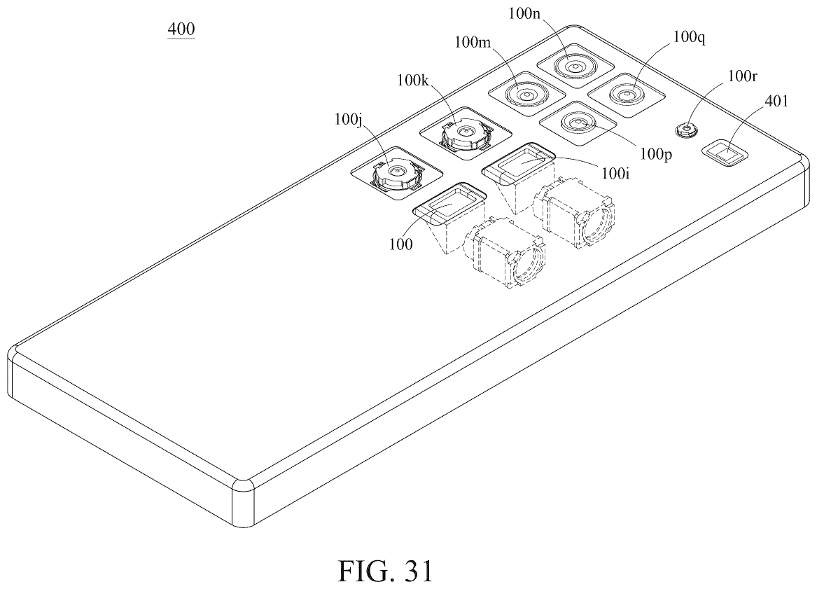

FIG. 31 is one perspective view of an electronic device according to the 12th embodiment of the present disclosure.

In this embodiment, an electronic device 400 is a smartphone including the image capturing unit 100 disclosed in the 9th embodiment, an image capturing unit 100i, an image capturing unit 100j, an image capturing unit 100k, an image capturing unit 100m, an image capturing unit 100n, an image capturing unit 100p, an image capturing unit 100q, an image capturing unit 100r, a flash module 401, a focus assist module, an image signal processor, a display module and an image software processor (not shown). The image capturing units 100, 100i, 100j, 100k, 100m, 100n, 100p, 100q and 100r are disposed on the same side of the electronic device 400, while the display module is disposed on the opposite side of the electronic device 400. Furthermore, each of the image capturing units 100i, 100j, 100k, 100m, 100n, 100p, 100q and 100r can include the optical imaging lens system of the present disclosure and can have a configuration similar to that of the image capturing unit 100, and the details in this regard will not be provided again.

The image capturing unit 100 is a telephoto image capturing unit, the image capturing unit 100i is a telephoto image capturing unit, the image capturing unit 100j is a wide-angle image capturing unit, the image capturing unit 100k is a wide-angle image capturing unit, the image capturing unit 100m is an ultra-wide-angle image capturing unit, the image capturing unit 100n is an ultra-wide-angle image capturing unit, the image capturing unit 100p is a telephoto image capturing unit, the image capturing unit 100q is a telephoto image capturing unit, and the image capturing unit 100r is a ToF image capturing unit. In this embodiment, the image capturing units 100, 100i, 100j, 100k, 100m, 100n, 100p, and 100q have different fields of view, such that the electronic device 400 can have various magnification ratios so as to meet the requirement of optical zoom functionality. Moreover, each of the image capturing units 100 and 100i can be a telephoto image capturing unit having an optical path folding element configuration such as a reflective element configuration. In addition, the image capturing unit 100r can determine depth information of the imaged object. In this embodiment, the electronic device 400 includes multiple image capturing units 100, 100i, 100j, 100k, 100m, 100n, 100p, 100q and 100r, but the present disclosure is not limited to the number and arrangement of image capturing units. When a user captures images of an object, the light rays converge in the image capturing unit 100, 100i, 100j, 100k, 100m, 100n, 100p, 100q or 100r to generate images, and the flash module 401 is activated for light supplement. Further, the subsequent processes are performed in a manner similar to the abovementioned embodiments, and the details in this regard will not be provided again.

The electronic device disclosed above is only exemplary for showing a practical application of the present disclosure and is not intended to the scope of application of the image capturing unit disclosed herein.

The foregoing description, for the purpose of explanation, has been described with reference to specific embodiments. It is to be noted that TABLES 1A-8D show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An optical imaging lens system comprising seven optical elements, the seven optical elements being, in order from an object side to an image side along an optical path, a first optical element, a second optical element, a third optical element, a fourth optical element, a fifth optical element, a sixth optical element and a seventh optical element, and each of the seven optical elements having an object-side surface facing toward the object side and an image-side surface facing toward the image side;
wherein the first optical element is a reflective element, the first optical element further has a reflective surface located between the object-side surface and the image-side surface of the first optical element, and each of the second optical element to the seventh optical element is a lens element;
wherein the first optical element has positive refractive power, the object-side surface of the first optical element is convex in a paraxial region thereof, the third optical element has negative refractive power, the object-side surface of the seventh optical element is convex in a paraxial region thereof, and at least one of the object-side surface and the image-side surface of the seventh optical element has at least one inflection point;
wherein an axial distance between the object-side surface of the first optical element and an image surface is TL, a central thickness of the first optical element is CT1, a central thickness of the second optical element is CT2, a curvature radius of the object-side surface of the seventh optical element is R13, a curvature radius of the image-side surface of the seventh optical element is R14, an axial distance between the first optical element and the second optical element is T12, a focal length of the optical imaging lens system is f, a focal length of the second optical element is f2, and the following conditions are satisfied:
1.30<(TL−CT1)/CT1<3.00;
0.60<|R13/R14|<3.00;
0.05<CT2/T12<3.00; and
−0.80<f/f2<2.80.

2. The optical imaging lens system of claim 1, wherein the object-side surface of the third optical element is convex in a paraxial region thereof, the image-side surface of the third optical element is concave in a paraxial region thereof, the object-side surface of the fourth optical element is convex in a paraxial region thereof, the image-side surface of the seventh optical element is concave in a paraxial region thereof, and at least one of the object-side surface and the image-side surface of the seventh optical element has at least one critical point in an off-axis region thereof.

3. The optical imaging lens system of claim 1, wherein the reflective element is a prism;
wherein the axial distance between the object-side surface of the first optical element and the image surface is TL, the central thickness of the first optical element is CT1, and the following condition is satisfied:
1.40<(TL−CT1)/CT1<2.60.

4. The optical imaging lens system of claim 1, wherein an f-number of the optical imaging lens system is Fno, the curvature radius of the object-side surface of the seventh optical element is R13, the curvature radius of the image-side surface of the seventh optical element is R14, and the following conditions are satisfied:
1.30<Fno<2.80; and
0.90<|R13/R14|<2.50.

5. The optical imaging lens system of claim 1, wherein the focal length of the optical imaging lens system is f, a composite focal length of the second optical element, the third optical element and the fourth optical element is f234, the central thickness of the second optical element is CT2, a central thickness of the third optical element is CT3, and the following conditions are satisfied:
−0.30<f/f234<2.50; and
0.25<CT2/CT3<1.60.

6. The optical imaging lens system of claim 1, wherein the focal length of the optical imaging lens system is f, the focal length of the second optical element is f2, an axial distance between the object-side surface of the first optical element and the image-side surface of the seventh optical element is TD, a maximum image height of the optical imaging lens system is ImgH, and the following conditions are satisfied:
−0.30<f/f2<2.50; and
3.00<TD/ImgH<4.50.

7. The optical imaging lens system of claim 1, wherein the central thickness of the second optical element is CT2, the axial distance between the first optical element and the second optical element is T12, a maximum field of view of the optical imaging lens system is FOV, and the following conditions are satisfied:
0.15<CT2/T12<2.50; and
18.0 degrees<FOV<50.0 degrees.

8. The optical imaging lens system of claim 1, wherein an axial distance between the object-side surface of the first optical element and the image surface of the optical imaging lens system focusing on a long distance is TLi, an axial distance between the object-side surface of the first optical element and the image surface of the optical imaging lens system focusing on a short distance is TLm, and the following condition is satisfied:
0≤|TLi−TLm|/TLi<2.0E−3.

9. The optical imaging lens system of claim 1, wherein the focal length of the optical imaging lens system is f, a focal length of the fourth optical element is f4, and the following condition is satisfied:
0.70<f/f4<3.10.

10. The optical imaging lens system of claim 1, wherein the central thickness of the first optical element is CT1, the central thickness of the second optical element is CT2, a central thickness of the third optical element is CT3, a central thickness of the fourth optical element is CT4, a central thickness of the fifth optical element is CT5, a central thickness of the sixth optical element is CT6, a central thickness of the seventh optical element is CT7, an Abbe number of the first optical element is V1, an Abbe number of the second optical element is V2, and the following conditions are satisfied:
0.50<(CT2+CT3+CT4+CT5+CT6+CT7)/CT1<1.40; and
0.20<V2/V1<1.60.

11. The optical imaging lens system of claim 1, wherein a curvature radius of the object-side surface of the second optical element is R3, a curvature radius of the object-side surface of the fifth optical element is R9, and the following condition is satisfied:
0.05<|R9/R3|<2.00.

12. The optical imaging lens system of claim 1, wherein a displacement in parallel with an optical axis from an axial vertex of the image-side surface of the third optical element to a maximum effective radius position of the image-side surface of the third optical element is SAG3R2, a displacement in parallel with the optical axis from an axial vertex of the object-side surface of the sixth optical element to a maximum effective radius position of the object-side surface of the sixth optical element is SAG6R1, a maximum effective radius of the object-side surface of the first optical element is Y1R1, a maximum image height of the optical imaging lens system is ImgH, and the following conditions are satisfied:
−2.00<SAG6R1/SAG3R2<0.60; and
0.45<Y1R1/ImgH<1.60.

13. An image capturing unit comprising:
the optical imaging lens system of claim 1; and
an image sensor disposed on the image surface of the optical imaging lens system.

14. An optical imaging lens system comprising seven optical elements, the seven optical elements being, in order from an object side to an image side along an optical path, a first optical element, a second optical element, a third optical element, a fourth optical element, a fifth optical element, a sixth optical element and a seventh optical element, and each of the seven optical elements having an object-side surface facing toward the object side and an image-side surface facing toward the image side;
wherein the first optical element is a reflective element, the first optical element further has a reflective surface located between the object-side surface and the image-side surface of the first optical element, and each of the second optical element to the seventh optical element is a lens element;
wherein the first optical element has positive refractive power, the object-side surface of the first optical element is convex in a paraxial region thereof, the third optical element has negative refractive power, the object-side surface of the seventh optical element is convex in a paraxial region thereof, the image-side surface of the seventh optical element is concave in a paraxial region thereof, and the image-side surface of the seventh optical element has at least one critical point in an off-axis region thereof;
wherein an axial distance between the object-side surface of the first optical element and an image surface is TL, a central thickness of the first optical element is CT1, a central thickness of the fourth optical element is CT4, a curvature radius of the object-side surface of the fourth optical element is R7, a curvature radius of the image-side surface of the fourth optical element is R8, an Abbe number of the sixth optical element is V6, an Abbe number of the seventh optical element is V7, an axial distance between the third optical element and the fourth optical element is T34, and the following conditions are satisfied:
1.30<(TL−CT1)/CT1<3.00;
−0.60<(R7+R8)/(R7−R8)<2.50;
0.10<V6/V7<1.40; and
0<T34/CT4<0.90.

15. The optical imaging lens system of claim 14, wherein the object-side surface of the third optical element is convex in a paraxial region thereof, the image-side surface of the third optical element is concave in a paraxial region thereof, and the object-side surface of the fourth optical element is convex in a paraxial region thereof;
wherein the axial distance between the object-side surface of the first optical element and the image surface is TL, the central thickness of the first optical element is CT1, and the following condition is satisfied:
1.50<(TL−CT1)/CT1<2.40.

16. The optical imaging lens system of claim 14, wherein a central thickness of the second optical element is CT2, an axial distance between the first optical element and the second optical element is T12, the curvature radius of the object-side surface of the fourth optical element is R7, the curvature radius of the image-side surface of the fourth optical element is R8, and the following conditions are satisfied:
0.10<CT2/T12<2.80; and
−0.30<(R7+R8)/(R7−R8)<1.70.

17. The optical imaging lens system of claim 14, wherein the axial distance between the third optical element and the fourth optical element is T34, the central thickness of the fourth optical element is CT4, and the following condition is satisfied:
0.05<T34/CT4<0.80.

18. The optical imaging lens system of claim 14, wherein at least two lens elements of the optical imaging lens system move along an optical axis to perform a focus tuning process so as to correspond to different object distances, and the optical imaging lens system performing the focus tuning process captures an image of an object with an object distance of 5000 mm or more or with the object distance of 1000 mm or less.

19. The optical imaging lens system of claim 18, wherein one of the at least two lens elements is the seventh optical element.

20. The optical imaging lens system of claim 14, wherein a curvature radius of the object-side surface of the second optical element is R3, a curvature radius of the object-side surface of the third optical element is R5, the Abbe number of the sixth optical element is V6, the Abbe number of the seventh optical element is V7, and the following conditions are satisfied:
−0.55<R5/R3<0.95; and
0.15<V6/V7<0.90.

21. The optical imaging lens system of claim 14, wherein the axial distance between the object-side surface of the first optical element and the image surface is TL, a maximum image height of the optical imaging lens system is ImgH, and the following condition is satisfied:
4.30<TL/ImgH<5.10.

22. The optical imaging lens system of claim 14, wherein a central thickness of the second optical element is CT2, a central thickness of the third optical element is CT3, a curvature radius of the image-side surface of the seventh optical element is R14, a focal length of the optical imaging lens system is f, and the following conditions are satisfied:
0.15<CT2/CT3<1.80; and
0.08<R14/f<0.48.

23. The optical imaging lens system of claim 14, wherein a central thickness of the second optical element is CT2, a displacement in parallel with an optical axis from an axial vertex of the object-side surface of the second optical element to a maximum effective radius position of the object-side surface of the second optical element is SAG2R1, and the following condition is satisfied:
−3.50<CT2/SAG2R1<1.80.

24. The optical imaging lens system of claim 14, wherein the sixth optical element has positive refractive power;
wherein a vertical distance between a critical point on the object-side surface of the seventh optical element and an optical axis is Yc71, a maximum effective radius of the object-side surface of the seventh optical element is Y7R1, and the following condition is satisfied:
0.30<Yc71/Y7R1<0.90.

25. The optical imaging lens system of claim 14, wherein the axial distance between the object-side surface of the first optical element and the image surface is TL, the central thickness of the first optical element is CT1, a central thickness of the second optical element is CT2, the central thickness of the fourth optical element is CT4, the curvature radius of the object-side surface of the fourth optical element is R7, the curvature radius of the image-side surface of the fourth optical element is R8, a curvature radius of the object-side surface of the seventh optical element is R13, a curvature radius of the image-side surface of the seventh optical element is R14, an axial distance between the first optical element and the second optical element is T12, the axial distance between the third optical element and the fourth optical element is T34, a focal length of the optical imaging lens system is f, a focal length of the second optical element is f2, the Abbe number of the sixth optical element is V6, the Abbe number of the seventh optical element is V7, a maximum field of view of the optical imaging lens system is FOV, an f-number of the optical imaging lens system is Fno, a maximum image height of the optical imaging lens system is ImgH, an axial distance between the object-side surface of the first optical element and the image-side surface of the seventh optical element is TD, and at least one of the following conditions is satisfied:
1.70≤(TL−CT1)/CT1≤2.08;
1.04≤|R13/R14|≤1.83;
0.37≤CT2/T12≤1.17;
−0.07≤f/f2≤1.85;
0.12≤(R7+R8)/(R7−R8)≤1.37;
0.36≤V6/V7≤0.57;
0.22≤T34/CT4≤0.36;
30.0 degrees≤FOV≤39.80 degrees;
1.68≤Fno≤2.36;
4.73≤TL/ImgH≤4.98; and
3.63≤TD/ImgH≤4.13.

26. An electronic device comprising:
an image capturing unit comprising:
the optical imaging lens system of claim 14; and
an image sensor disposed on the image surface of the optical imaging lens system.
